(19) United States
(12) Patent Application Publication
(10) Pub. No.: US 2025/0216863 A1
(43) Pub. Date: Jul. 3, 2025

(54) Autonomous Advertising Cart

(71) Applicants: Daniel Paul Armbrust, Mequon, WI (US); Robert James Grabon, Cedarburg, WI (US); Radoslaw Adam Jarema, Krakow (PL)

(72) Inventors: Daniel Paul Armbrust, Mequon, WI (US); Robert James Grabon, Cedarburg, WI (US); Radoslaw Adam Jarema, Krakow (PL)

(21) Appl. No.: 19/066,015

(22) Filed: Feb. 27, 2025

Related U.S. Application Data
(63) Continuation-in-part of application No. 18/113,758, filed on Feb. 24, 2023.
Application No. 18/113,758 is a continuation-in-part of application No. 16/807,032, filed on Mar. 2, 2020, now Pat. No. 11,592,815.
(60) Provisional application No. 63/630,758, filed on Feb. 29, 2024.
(60) Provisional application No. 63/474,480, filed on Aug. 22, 2022.
(60) Provisional application No. 62/921,504, filed on Jun. 24, 2019.

(51) Int. Cl. G05D 1/646; G05D 1/246; G05D 1/667; G05D 105/20; G05D 105/70; G05D 109/10; G05D 111/10; G05D 111/30; G06T 7/70; G06V 40/16; G09F 21/04

(52) U.S. Cl. CPC G05D 1/646; G05D 1/246; G05D 1/667; G06T 7/70; G06V 40/174; G09F 21/048; G05D 2105/20; G05D 2105/70; G05D 2109/10; G05D 2111/17; G05D 2111/32; G06T 2207/30201

(57) ABSTRACT

An autonomous advertising cart with display panels and speakers integrated into its navigation, movement and location tracking system. The cart displays advertising containing text, picture and video images, and speakers play sounds, music or other recordings. The cart selectively provides advertising communications depending on the items on the cart, where the cart is in the building, the time of day, the presence of people, etc., as the autonomous cart travels through its work environment. The advertisements are stored on-board the cart or received real-time via wireless communication. The cart preferably has microphones and customer observation cameras to collect real-time information about the working environment and customers to enhance the advertising experience and provide feedback about the advertising experience.

### TECHNICAL FIELD OF THE INVENTION

This invention relates to an autonomous advertising cart having a movement control system and source of electric power to autonomously control its self-propelled movement along a path of travel through open areas of a building, the cart having electronic display panels with screens to display visual advertising communications containing text, picture and video advertising, preferably when the cart detects a person in its vicinity, and turns off the panels when the cart does not detect a person to conserve its battery power.

### BACKGROUND OF THE INVENTION

A wide variety of businesses rely on utility carts to move items around inside their buildings. The carts hold and transport tools, equipment, component parts and completed products, many of which are heavy, bulky or awkward to carry, and often include associated paperwork that needs to be kept with an item as it moves from station to station or room to room. The carts come in a wide variety of shapes, sizes and styles. The corners of the carts typically include vertical risers and multiple horizontal trays. The carts are typically made of plastic or metal, and their front and rear corners are typically supported by caster wheels. Plastic carts often have trays and risers made of molded foam plastic. Metal carts frequently have metal tubes for risers and meshed wire baskets for trays. Some carts have metal tube risers and reinforced plastic trays. The utility carts are often rated for 200 to 500 lbs (90 to 225 kg) load capacities. Examples of these utility carts are made by Rubbermaid Commercial Products, LLC of Winchester, VA and sold as Uline Model Nos. H-1053, H-2470, H-2471, H-2475 and H-2505, AMSA, Inc. of Boulder, CO and sold as Uline Model Nos. H2505 and H7435, and Suncast Technologies, LLC of Palm Beach Gardens, FL and sold as Model No. PUCPN1937. These and other utility carts are shown and described in U.S. Pat. Nos. D618,418 and D618,419 to Cotron, U.S. Pat. Nos. D798,018 and D855,275 to Walter and U.S. Pat. No. 10,377,403 to Lee, the contents of which are incorporated by reference.

Autonomous mobile robots for manufacturing, warehouse and distribution applications are well known. Examples include 6 River Systems' CHUCK robot and U.S. Pat. Nos. 10,294,028 and D826,508, Amazon Robotics' MARTI robot and U.S. Pat. Nos. 7,920,962, 8,280,547, 8,265,873 and 10,317,893, Aethon's TUG robot and U.S. Pat. Nos. 7,100,725, 7,431,115, 8,204,624, 9,223,313, 9,563,206 and 9,679,270, GreyOrange's BUTLER robot and U.S. Pat. Nos. 10,216,193 and 10,481,612, Clearpath Robotic's manipulatable mobile robot and U.S. Pat. No. D812,663, Fetch Robotic's mobile warehouse robot and U.S. Pat. No. 10,423,150, In Via Robotics' autonomous warehouse robots and U.S. Pat. No. 9,731,896, Locus Robotics' warehouse robot and U.S. Pat. No. 10,019,015, Canvas Technology's robots, and MiR's mobile industrial robots.

One problem with conventional autonomous mobile robots is their integral design. Many components form the autonomous navigation structures, such as environmental mapping and proximity sensors, a power supply, control and drive systems, warning systems and a wireless system. These components and their associated wiring are built into the overall robot design. Even when the robot takes the form of a cart, the components that form the autonomous navigation structures are built into the overall cart design. Determining the locations of the various sensors and their wiring so they can perform their intended function while keeping them safe from inadvertent damage and out of the way from interfering with the normal operation of the cart can be particularly challenging. Businesses must either buy manual carts or dramatically more expensive autonomous robotic carts. Due to their complexity, there is no presently known way to convert a manual cart into an autonomous cart. Existing navigation structures are not intended to convert an off-the-shelf, manually pushed cart into an autonomous mobile robotic cart.

Another problem with conventional autonomous vehicles is their dependency on wireless communication with an independent operating system. The robots do not operate independently. They require wireless communication with an off-board database or control system. The operator must interact with the operating system and database via a wireless communication system such as WiFi to control the movements of the robotic vehicle. The cost of installing a wireless communication system such as WiFi can be prohibitively expensive for many organizations. Moreover, even when a wireless communication system is installed, the system may include dead zones that can sever communication with an autonomous vehicle, or cause the vehicle to receive redundant signals when multiple communication cells or transceivers are transmitting a given signal. When the autonomous vehicle stops in a dead zone, the robot must be manual pushed out of the dead zone and reset to advise it of its current location.

A further problem with conventional robotic carts is they are not compatible with manual operation. First, many conventional robotic carts do not allow for manual movement. If a user attempts to push a robotic cart, the wheels drag or turn with a high amount of resistance. Second, robotic carts become disoriented when they are manually pushed to a different location than the location to which the cart last autonomously moved. They cannot determine their location when the robotic cart is turned off and manually moved. When power to the robot microprocessor and drive motor are turned off, the robot loses its ability to track its movements and determine its location. When the robotic vehicle is turned off, its motor encoder does not monitor drive shaft and wheel rotation. As a result, the robotic vehicle loses track of its location when it is turned off and manually pushed. When the robotic vehicle is turned back on, the new location coordinates for the robot must be entered or other means must be used to allow the robot to determine its current location.

A still further problem with conventional robotic vehicles is that unsafe loading conditions go undetected. There is no mechanism to determine the weight of the vehicle or the items placed on it. Similarly, there is no mechanism to determine if the load is unbalanced, which could cause the vehicle to tip over when making a turn. There is also no mechanism to determine if an object is extending outwardly from the vehicle to a point where that item could hit other objects when the vehicle is moving.

A still further problem with conventional robotic vehicles is their inability to determine the types and thicknesses of materials in their field of view (FOV), distance from the radar input device, stationary or moving relative to the radar input device, and angle of movement if the material is moving in relation to the cart.

A still further problem with conventional robotic vehicles is they have difficulty sensing information about the payload on platform carts. This is due to the limited locations for sensor placement that would allow for line of sight viewing of the payload. Available locations include the platform and the handle area. Sensors located on the platform are obstructed by the payload. Sensors mounted on the rear handle are obstructed from viewing the front of the payload by the payload itself. Without being able to view the payload, the cart does not know if the payload extends beyond the platform. If the payload does extend beyond the platform, the payload will collide with obstacles as the cart autonomously moves.

A still further problem with conventional robotic vehicles is that their inability to see through or around objects. They rely on-line-of-sight sensors that provide little or no time to adjust for collisions when passing through or by a doorway or around or by a corner. For example, when a cart travels around a corner, its view of a person or object moving in the opposite direction around that corner is optically obstructed, which greatly lessens the time and distance for the cart to sense and avoid collisions.

The present invention is intended to solve these and other problems.

### BRIEF DESCRIPTION OF THE INVENTION

This invention pertains to a robotic cart platform (RCP) with a navigation and movement system that integrates into a conventional utility cart to provide both manual and autonomous modes of operation. The platform includes a housing with a processor and memory and external motorized drive wheels with encoders that replace the front wheels of the cart. The system has work environment mapping sensor and a cabled array of depth cameras, proximity or radar sensors, weight sensors, lights, control panel, battery and on/off and emergency stop buttons secured throughout the cart. The encoders obtain drive shaft rotation data and an IMU obtains three axes of angular rate and acceleration data that a microcontroller periodically sends to the processor. When in autonomous mode, the system provides navigation, movement and location tracking with or without wireless connection to a server. Stored destinations are set using its location tracking to autonomously navigate the cart. When in manual mode, battery power is off, and back-up power is supplied to the encoders, IMU and microcontroller, which continue to obtain shaft rotation data and angular rate and acceleration data. When in autonomous mode, the shaft rotation, angular rate and acceleration data obtained during manual mode is used to determine the present cart location.

An advantage of the present robotic cart platform is its ability to integrate into conventional, manually moved, utility cart designs. The components forming the robotic cart platform (RCP) includes motorized drive wheels, an RCP housing and an autonomous mapping and navigation system, environmental mapping and obstacle avoidance sensor, input components and structures that are readily installed on a conventional cart. The housing is designed to fit under the cart, which is an area not utilized for payload transport. This area also offers a substantially unobstructed 360 degree view of the surrounding environment, which makes it desirable for mounting a LIDAR sensor. Proximity or radar sensors are positioned near the corners or ends and sides of the cart to give them an optimal view of where the cart is moving. The front caster wheels are removed and replaced by the drive wheels. A pre-fabricated array of electric cables that are harnessed together at one end near their terminal ports is plugged into the RCP housing. The individual cables for the proximity or radar sensors and input devices are routed through existing channels and openings in the conventional cart. Existing openings or areas in the risers and trays are also used to mount proximity or radar sensors and lights to convert the conventional utility cart into an autonomous robotic cart. Minimal modifications to the cart are required. Businesses that use conventional, off-the-shelf, manually pushed utility carts can inexpensively convert them into autonomous mobile robotic carts.

Another advantage of the present robotic cart platform is its independent operating system. The present cart platform design has an on-board operating system and database capable of operating independently, and does not require support from an off-board operating system or server. Workers interact directly with the robotic cart to control the movements of the cart. The cost of installing an off-board server and wireless support system is avoided, allowing the benefits of robotic carts to many companies that cannot practically install a WiFi system or otherwise cannot afford a more expensive robotic cart system. In addition, the independent operation of the autonomous cart avoids the problems associated with dead zones that occur in many robotic cart systems.

A further advantage of the present robotic cart platform its compatibility with both autonomous and manual movement of the cart. First, a cart installed with the robotic platform can be manually pushed or pulled. When the drive motors are not powered, the motors allow substantially free rotation of their drive shafts, so the wheels do not drag or turn with a high amount of resistance. Workers can finely move the cart to a precise position, or move the cart when it does not have power. Second, carts installed with the robotic cart platform keep track of their location when manually pushed to a new location. Both the manual mode and the autonomous mode allow the robotic cart to independently determine its location. When power to the robot drive motors and main processor are turned off, a separate power source is activated to run its motor encoder, IMU and microcontroller, which continue to track wheel rotations and the angular rotation and acceleration of the cart to determine the location of the robotic cart. When the robotic vehicle is turned back on, the microcontroller transmits wheel and shaft rotation data to the main onboard processor to determine the current location of the robotic cart. The robotic vehicle does not lose track of its location when it is manually moved. A worker does not need to enter the new location of the cart, or otherwise require the cart to determine its new location, such as through the use of RFID tags or an off-board WiFi type operating system.

A still further advantage of the robotic cart platform is its harnessed array of cabled sensors, safety/status lights and input devices, such as the control panel, battery and on/off and emergency stop buttons. While the drive unit is located under the cart, these components are not. Cabled sensors and lights that need to be substantially unobstructed or highly visible are located in optimal locations on the cart. Input devices that would be awkward to reach and use if placed under the cart, are located at appropriate and easily accessed locations on the cart. Components such as the battery that might need to be periodically recharged or replaced are located at more easily accessible locations. The RCP drive unit circuitry has multiple power supply input terminals, so battery packs can be hot swapped while the RCP processor continues to run. There is no need to power off the RCP processor to charge the batteries. Once the particular off-the-shelf cart is selected, the appropriate harnessed array of cabled sensors is selected so that the necessary number of individual cables and cable lengths is available to hook up the appropriate components for that make and model of utility cart. The cabled sensors and input devices conform to the unique configuration of a particular cart, instead of the cart conforming to the sensors and input devices. Cable lengths are easily changed for varying carts without changing the size, configuration, mounting structures and internal components of the RCP platform.

A still further advantage of the robotic cart platform is serviceability. The cables and each of these components are replaced or upgraded without needing to replace or modify the main robotic cart platform. Each cable has ports at both its ends. To remove and replace an external component, such as a sensor, light, control panel, battery, etc., the appropriate cable simply has to be disconnected from the port of that particular external component. To replace the harnessed cable array, the ports at both ends of the cables are disconnected.

As still further advantage of the robotic cart platform is its ease of integration into a conventional cart. The cables are routed through existing channels and openings in conventional carts. The sensors and safety lights are mounted in or via existing openings in the carts. Speakers and WiFi unit are mounted inside compartments in the trays. Four external single board computers (SBCs) and two external universal serial bus (USB) hubs increase the ease of integrating the RCP into a conventional cart to produce an autonomous cart. One SBC is located in near each proximity or radar sensor and its accompanying set of LED lights to convert the communication protocols of the sensors and lights to a USB protocol. The external SBCs and USB hubs allow for easier cabling installation, reduces costs by replacing more expensive custom-made cables with USB cabling, and buffers data to reduce the real time processing burden on the internal SBC and digital board inside the RCP housing. The external SBC and USB hubs also improve manufacturability because the cabling in each post is assembled and tested as a sub-assembly, with the final assembly of the cart being performed later. Since the cart posts are the same for the larger sized and smaller sized carts, the cabling for each post can be manufactured independently of cart size. The external SBCs and USB hubs also improve reliability in that if the components in one post fail (i.e., sensors, lights, external SBC, or USB cabling), that failure will not cause the components in the other posts to fail. The external SBC and USB hubs also provide enhanced flexibility in that sensors and lights in one cart post are readily changed to other items (e.g., radar sensors) without needing to make other changes in the cart provided the software or programming of the RCP processors is capable of supporting the change.

A still further advantage of the robotic cart platform is the scanning area of its proximity. Each corner riser of the autonomous cart has four proximity sensors. Two sensors point sideward, and two sensors point forward or rearward. Two sensors are located higher up on the cart frame, and two sensors are located lower on the frame. The higher sensors are angled downwardly and the lower sensors are angled upwardly, so that the scanning cones of paired sensors intersect at about half of the cart height. Should one of the paired sensor fail, the other paired sensor will still cover the area where their scanning cones intersect. The upward angling sensors detect instances where an item placed on a cart extends out from the edge of the cart a significant distance, and a worker is alerted as this can lead to a collision of that overhanging item or an unbalanced payload. The downward angled proximity sensors more reliably detect lower height obstacles and drop offs such as stairwells, which help prevent the cart from falling into a stairwell or out of a shipping dock.

A still further advantage of the robotic cart platform is the location and scanning area of its LIDAR sensor. The sensor is located at a protected location between the drive unit and the lower tray. The LIDAR sensor peers out from between the drive unit and lower tray to scan in almost a full 360 degrees. Only the tops of the drive wheels, drive unit mounting posts and the front caster wheel assemblies obstruct the full 360 degree of view.

A still further advantage of the RCP is its weight sensors. Two weight sensors are located just above the rear caster wheel assemblies, and two sensors are located just above the RCP mounting assembly. These sensors measure the weight of the cart (not including the caster wheels or RCP). The weight measurements are used multiple ways. The cart uses the measurements to determine if an object has been placed onto or taken off of the cart. The cart also uses the weight measurements when the cart is planning its movements (e.g. will need more power for heavier payloads). The cart can also determine if the payload is exceeding a threshold and causing a safety issue, or if the payload is balanced or unbalanced. The cart will then warn a worker and use the weight information to take appropriate action, such as turn at a slow rate or stop altogether. Weight measurements and safety determinations can be performed when the cart is stationary or when it is moving. If there is a change from balanced to unbalanced while moving, the cart can act upon that to prevent the loss of the payload or to inform the user of the imbalance. Lastly, the cart detects when a person presses on the cart (like pressing a button), which is recognized as user input, such as an indication that the cart is empty.

A still further advantage of the RCP is the ability of the radar sensors to determine the type and thickness of materials in its field of view (FOV). By directing its radar devices towards the ground or floor, the RCP is not only able to better sense changes in elevation, but is also able to sense the material composition of the floor, layers of items or material on the floor surface and the ground or materials beneath the floor surface. Observing and knowing the composition of the floor surface provides information to the RCP that aids in its ability to provide better traction control. For example, when the cart moves from one surface to another, the RCP observes the change in surface, such as moving from an unfinished concrete surface to a laminated concrete surface, a tile surface or carpeting, which allows the RCP to adjust its speed and acceleration for better traction. In addition, the RCP detects liquids or discarded paper laying on the floor surface, which allows the RCP to adjust its speed and acceleration for better traction or to avoid the liquid or paper altogether.

A still further advantage of the RCP is that its radar sensors give the autonomous cart the ability to navigate through open areas that are void of obstacles by which it would otherwise triangulate its position. Moving autonomously requires the cart to be localized and to navigate the environment. Both requirements are aided by sensing obstacles in the environment from which to triangulate and determine its location. However, when the cart is in areas void of obstacles, the ability of the cart to successfully reach the destination could be hindered. The RCP uses its radar sensing devices to determine and map material patterns beneath the floor surface. The composition of the ground or materials beneath the floor surface provides landmarks and distinctive characteristics by which the cart can triangulate to determine its current location and better navigate through an allowed environment. For example, metal bolts driven into concrete flooring, embedded metal pipes or embedded metal rebarring commonly used to strengthen concrete floor slabs provide an excellent means to map the ground. Rebarring in concrete flooring is often constructed in a grid pattern. This grid pattern provides a very distinctive and regular pattern that can aid in the orientation and localization of the cart in respect to the environment. Localization enables the cart to determine its location in its internal map of the surrounding environment, and thus the ability to recognize its physical location in the actual surrounding environment. Underground wiring, conduits, piping, tunnels, and other subsurface items are also identified in the RCP map of the allowed or surrounding environment. The RCP uses its radar input device aimed downwards to sense ground and subsurface composition. The varying nature of the ground and subsurface are recorded to provide a map for the cart to localize with and then to navigate to destinations. The cart and RCP can either be manually pushed over or autonomously driven over a surface to create a map of the composition of the surface and subsurface materials. Rebarring, wiring, conduits, piping, tunnels, and other subsurface items are identified on the map.

A still further advantage of the RCP of the autonomous cart is its ability to determine the position of the payload in its trays. The radar input devices are orientated towards the trays or shelving areas where the cart's payload is placed. This allows the RCP to determine the type of material and thickness of the payload. This information is used to calculate the mass and center of gravity of the payload along with the positioning of the payload on the cart. With this information, the cart is better able to determine how to move to avoid unwanted shifting of the payload or tipping of the cart. In addition, this information is recorded or communicated with other systems or to the user. Furthermore, calculations are done to count the number of objects as they are placed onto or removed from the cart. Radar input devices located underneath the tray or platform sense the entire payload, and allow the RCP to determine if any portion of the payload extends beyond the platform. Furthermore, when the radar input devices are aimed outward and upward from the edges of the platform, the radar input devices sense the areas of the payload which extend beyond the platform. When moving autonomously, the RCP cart can consider not only the boundaries of the cart but also the overhanging payload areas to ensure neither collide with any obstacles.

A still further advantage of the RCP of the autonomous cart is its ability to detect dynamic obstacles along with calculating their distance, direction, velocity and acceleration. While the LIDAR sensor and cameras gather and send data to the RCP processors and for calculating the velocity of moving people and objects, because the radar sensor send velocity data to the processors natively, the processors require less processing time to detect moving people and objects and the navigation and control system and autonomous cart are able to detect and respond to moving people and objects more quickly. The radar sensors calculate these measurements using what is commonly referred to as Doppler radar. The computing device or programmed processor of the RCP calculates the intersection of dynamic obstacles in relation to the cart. The RCP processors use the radar sensors to determine the distance between the cart and the stationary or moving obstacle, the angle of movement when the obstacle is moving in relation to the cart, and the speed of the cart relative to the obstacle. When an intersection is projected to occur, the cart makes navigational adjustments to avoid a collision such as altering its path, altering its speed, or applying its brakes.

A still further advantage of the RCP of the autonomous cart is its ability to sense objects that are obstructed from view. The penetrating radar of the RCP senses materials and objects behind other materials and objects. This radar allows for sensing of both static and dynamic obstacles that are hidden optically from the cart. For example, when the cart travels around a corner of a building, the radar devices sense objects moving around or past that corner, which greatly lessens the time and distance for the RCP to sense the object and avoid a collision. The penetrating radar senses through optical obstructions to detect moving objects or people near a corner or doorway to allow additional time and distance for the RCP to avoid a collision.

A still further advantage of the RCP of the autonomous cart is its ability to determine objects through which the cart can pass or go over. For example, the user can instruct the cart to travel through plastic strips hanging in a doorway, or drive over debris such as paper or liquid on the floor. By determining the material composition and thickness of obstacles, the RCP of the cart can calculate when it is expected to avoid an obstacle, or go through or over an obstacle.

A still further advantage of the RCP of the autonomous cart is its ability to classify human objects, such as a human body or body part, as different from non-human objects. The position and motion of a human body part is interpreted by the RCP as direct input by the human to the cart. This human input data is used to control the cart or to input data to the cart. For example, waving a hand signals the cart to start moving, holding up a hand signals the cart to stop moving, or holding up two fingers signals the cart to enter the number “2”, such as to start heading to the second set destination. Similarly, non-human objects can also be interpreted by the RCP computing device.

A still further advantage of the RCP of the autonomous cart is it detects when and how a worker is gripping the cart handle. Radar devices placed in the handle and orientated towards the natural grip positions detect when a person is gripping the handle. When the cart is moving autonomously and the RCP detects a worker has just gripped the handle, the RCP aborts autonomous motion. The RCP also detects the placement of the hand, fingers and thumb on the handle to allow for additional data input. For example, when a hand grips the handle, the placement of the thumb near the handle is interpreted to control the speed and direction of a drive wheel. Moving the thumb towards the front will reverse the direction of the drive wheel, while moving the thumb towards the rear causes the drive wheel move in a forward direction. The RCP interprets the placement of the thumb further away from a center point on the handle as direction to increase the speed of the drive wheel.

A still further advantage of the RCP of the autonomous cart is it allows human data input and control without direct contact with the cart. This contactless control greatly reduces the opportunity for an electrostatic discharge (ESD) event to occur. When carts travel, electrical charge can be built up on the cart. When the charge level becomes too high, an ESD will occur. When an ESD occurs, it can result in disruption of the electrical operation of the cart, which can result in permanent damage to the cart. The ESD event can also provide an unwanted shock to the human.

A still further advantage of the RCP of the autonomous cart is the location of its radar input devices. The radar input devices are installed inside or behind cart components, such as shelving, posts or handles. Depending upon the frequency, power output and receiver strength of the radar input device, proper selection of the material the device and the environment is critical. For example, 60 GHz radar passes through high-density polyethylene (HDPE) plastic with minimal signal loss and minimal degradation in signal quality. The RCP allows its radar input devices to be installed behind or inside of cart components made of HDPE plastic, so the sensing ability of the radar input devices are not significantly affected. Furthermore, the installation of the radar devices does not require the cart to be cut or modified. The non-visible interior placement of the radar input devices maintains the aesthetics of the cart. The placement of the radar sensors behind or inside of the cart components also facilitates the ease of sealing the RCP circuitry external to its housing so that these components remain water and dust proof.

Other aspects and advantages of the invention will become apparent upon making reference to the specification, claims and drawings.

### BRIEF DESCRIPTION OF THE DRAWINGS

FIG. 1A is an elevated perspective view of a conventional plastic utility cart with a handle for pushing the cart, four caster wheel assemblies, horizontal upper and lower trays, and four vertical risers supporting the trays in stacked, spaced alignment.

FIG. 1B is an underside perspective view of the utility cart shown in FIG. 1A showing the structural webbing of the upper and lower trays and risers, and showing one caster wheel assembly in an exploded view.

FIG. 2 is a view showing the robotic cart platform components, including an autonomous drive unit with its adjustable mounting assembly, a top mounted LIDAR scanner, six button control panel, battery pack, sixteen proximity sensors, eight safety lights, a “GO” button, an emergency stop buttons, weight sensors, audio speaker, optional WiFi communication unit, and an array of electric cables to connect these components to the circuitry input ports of the autonomous drive unit.

FIG. 3 is an exploded view of the autonomous cart and robotic cart platform showing the orientation of its components relative to the conventional plastic utility cart of FIG. 1A, and showing the conventional rear caster wheel and weight sensor assemblies, adjustable front mounting and weight sensor assemblies and battery pack and mounting bracket assembly.

FIG. 4 is an exploded view of the autonomous drive unit showing its housing, adjustable mounting track, LIIDAR sensor, drive motors, drive wheels, motor controller and circuit boards.

FIG. 5A is a bottom perspective view of the autonomous drive unit with the lower half of its housing removed to show the drive motors, drive wheels, encoders, motor controller, circuit boards and circuitry, contacts for the LIDAR scanner and encoders, and the input ports for the externally mounted proximity sensors, safety lights, on/off switch, “GO” and emergency stop buttons, control panel and battery.

FIG. 5B is an electrical schematic showing various components and the circuitry of the autonomous drive unit, including a back-up power circuit with a super capacitor supplying back-up power to the encoders, microcontroller (MCU) and dynamic rapid access memory (DRAM).

FIG. 6 is a perspective view showing the robotic cart platform integrated into the conventional plastic utility cart of FIG. 1A to form an autonomous cart with its drive unit replacing the front caster wheels, and showing its six button control panel, battery pack and array of cabled proximity sensors, safety lights and “GO” button.

FIG. 7 is a lower perspective view of the autonomous cart of FIG. 6 showing the wheeled autonomous drive unit and an emergency stop button at the front of the cart, a riser cover panel, and an audio speaker secured under the upper tray with a portion of a underside cover panel cut away to show the optional WiFi communication unit.

FIG. 8 is a side view of the autonomous utility cart of FIG. 6 equipped with the robotic cart platform and showing the scanning cones of the proximity sensors.

FIG. 9 is a front view of the autonomous utility cart of FIG. 6 equipped with the robotic cart platform and showing the scanning cones of the proximity sensors.

FIG. 10 is a top view showing the scanning area of the LIDAR scanner and the scanning cones of the proximity sensors.

FIG. 11A is an enlarged side view of the weight sensor assembly of FIG. 3 showing the weight sensor support tab secured between the caster wheel mounting bracket and a spacer plate, with an upwardly facing central raised crown formed into the central areas of the caster wheel mounting bracket and a gap between the perimeter portions of the mounting bracket and sensor plate.

FIG. 11B is an enlarged side view of the weight sensor assembly of FIG. 3 showing the weight sensor support tab secured between a mounting bracket and a spacer plate, with a downwardly facing central crown formed into the central focal area of the support tab of the sensor plate and a gap between the perimeter portions of the mounting bracket and sensor plate.

FIG. 11C is a side view of the weight sensor assembly of FIG. 11B showing the sensor support tab flexing when a load is placed on the cart, the tab and crown moving into the central opening of the spacer plate, the gap reducing between the perimeter portions of the mounting bracket and sensor plate and a gap forming between the heads of the fasteners and the bottom surface of the mounting plate, and showing a programmed visual display (in lieu of RCP) for mounting on the cart.

FIG. 12 is a perspective view of the robotic cart platform integrated into a conventional metal utility cart with wire upper, lower and middle trays, tubular risers and a tubular handle, with its front caster wheels replaced by the wheeled autonomous base unit, and showing its on/off switch, control panel with an LED light and GO button, battery pack, proximity sensors and WiFi unit secured to the cart, and showing an exploded view of a rear caster wheel assembly.

FIG. 13 is an overhead view of a building showing the working environment inside a building with open areas and fixed structures, workers and a computer work station for monitoring and remotely controlling multiple autonomous RCP carts located at or moving between multiple desired destinations throughout the building, including a battery recharging station.

FIG. 14 is a view of a computer screen on an off-board computer showing a map of the working environment of a building obtained by the LIDAR sensor including a triangular symbol designating the current location of the autonomous cart and arrows designating destination locations for the autonomous cart, a chart displaying four destination coordinates and “Move to point” buttons, a joy stick to remotely control the autonomous cart, a GO button to send the cart to its next destination, a joy stick on/off button to turn the joy stick controls on and off, and a cart looping on/off button to turn a cart looping function on and off.

FIG. 15A shows a view of the 6-key control panel with five keys displaying destination icons and a sixth key displaying a battery charge level icon.

FIG. 15B shows a view of the 6-key control panel with four keys displaying arrow icons, a fifth key displaying the battery charge level icon and the sixth key blank.

FIG. 16A is an exploded perspective view showing an alternate mounting assembly and mounting bracket for securing the drive unit a conventional cart, with FIG. 16B showing the underside of one of alternate mounting brackets.

FIG. 17 is a side view showing a second embodiment of the robotic cart platform (RCP) integrated into the conventional plastic utility cart of FIG. 1A to form an autonomous cart with the RCP housing and mounting assembly under the lower cart tray, front drive wheel assemblies replacing the front caster wheels, and showing its control panel, battery pack, LIDAR sensor and array of cabled proximity sensors, safety lights and cameras.

FIG. 18 is a rear end view of the second embodiment of the autonomous cart showing its RCP housing and mounting assembly, rear caster wheel assemblies, fifteen-button control panel, on-off power button, batter pack, LIDAR sensor and array of cabled proximity sensors, safety lights and rear camera.

FIG. 19 is a sectional view taken along line 19-19 of FIG. 18 showing a rear caster wheel assembly, the RCP mounting assembly, a rear weight sensor and the cart frame.

FIG. 20 is a side, sectional view of a front drive wheel assembly of the second embodiment showing its motor windings, the RCP mounting assembly, a front weight sensor and the cart frame, with FIG. 20A showing its inwardly extending wiring and connector.

FIG. 21 is an exploded view of the RCP housing showing the motor controller, single board computer, power board, digital board, IMU, circuitry, LIDAR scanner, mounting assembly slide rails and input ports for externally mounted components.

FIG. 22 is a lower exploded view of the RCP housing and its electrical components.

FIG. 23 is an electrical schematic of the second embodiment of the RCP for the autonomous cart showing its various components and the circuitry, including an internal IMU and external drive wheels, front and rear cameras and EZ Go Navigation control panel with a separate On/Off switch.

FIG. 24 shows the electric cabling of the second embodiment connecting its components to the circuitry input ports of the RCP for the autonomous cart.

FIG. 25 is a perspective view of the second embodiment of the autonomous cart with the addition of a radar input device mounted inside a compartment of the cart handle.

FIG. 26 is a lower perspective view of the second embodiment of the autonomous cart and showing the addition of a USB hub mounted in the structural webbing under the upper cart tray, the addition of radar input devices mounted centrally in the webbing under both cart trays and the addition of radar input devices mounted on the sides of both cart trays.

FIG. 27 is a bottom view of the upper cart tray of the second embodiment showing the addition of a USB hub mounted in the structural webbing under the upper cart tray, the addition of radar input device mounted centrally in the webbing under the upper cart tray and the addition of radar input devices mounted on the sides of upper cart tray.

FIG. 28 is a bottom view of the lower cart tray of the second embodiment showing RCP mounting assembly mounted under the lower cart tray, front drive wheel assemblies and rear caster wheel assemblies secured to the mounting assembly and the lower cart tray, and showing the addition of a radar input device mounted centrally in the webbing under the lower cart tray and the addition of radar input devices mounted on the sides of lower cart tray.

FIG. 29 shows side and top views of the autonomous utility cart showing the scanning cones of the cameras.

FIG. 30A shows a view of the 15-key control panel with eleven keys displaying destination icons, and additional keys displaying Looping, Save Map and battery charge level icons, and with the Home icon displayed as blank.

FIG. 30B shows a view of the 15-key control panel with two keys displaying destination icons, four keys displaying arrow icons, one key displaying the battery charge level icon, one key displaying a boomerang icon, one key displaying a check engine icon and additional keys displayed as blank.

FIG. 30C shows a view of the 15-key control panel with eleven keys displaying destination icons, and additional keys displaying Home. Looping, Save Map and battery charge level icons.

FIG. 31 is an electrical schematic of an alternate version of the second embodiment that includes an external SBC for each cart post and two external USB hubs.

FIG. 32 shows the electrical cabling for the alternate version of the second embodiment showing the locations of the SBCs and USB hubs.

FIG. 33 shows side, rear and top views of a radar version of the second embodiment the autonomous utility cart showing the scanning cones of radar scanners with the cart traveling on a concrete slab having an embedded pipe and rebar.

FIG. 34 is an electrical schematic of a radar version of the second embodiment that includes an external SBC for each cart post and two external USB hubs, and replaced the proximity sensors in each post with a radar input device.

FIG. 35 shows the electrical cabling for the radar version of the second embodiment showing the locations of the SBCs, USB hubs and radar input devices.

FIG. 36 is an overhead view of a building showing the working environment inside a building with open areas and fixed structures, workers and a computer work station for monitoring and remotely controlling multiple autonomous RCP carts located at or moving between multiple desired destinations throughout the building, including a battery recharging station, and showing the route of a cart passing through hanging strips in a doorway, and the radar input device of a cart detecting a person behind a corner wall and walking toward the cart.

FIG. 37 is a view of the computer screen on an off-board computer showing a map of the working environment of a building obtained by the LIDAR sensor, cameras and radar sensors including a triangular symbol designating the current location of the autonomous cart, arrows designating destination locations for the autonomous cart, a chart displaying four destination coordinates and “Move to point” buttons, joy stick controls to remotely control the autonomous cart, and the first set of icons for the 15-key control panel including the looping button, active/fixed map button, and battery status button.

FIG. 38 is a front view of a third embodiment of the robotic cart platform (RCP) integrated into the conventional plastic utility cart of FIG. 1A to form an autonomous advertising cart with the RCP housing and mounting assembly under the lower cart tray, front drive wheel assemblies replacing the front caster wheels, an array of cabled proximity sensors and safety lights, a front video display panel that communicates advertising images and text, and speakers for communicating audio advertising messages, an additional camera for interacting with customer and a microphone for listening to and recording customers.

FIG. 39 is a left side view of the autonomous advertising cart with a left side video display panel showing the cart interacting with a customer through audio and visual communications via its display and speakers about the type, quantity and aisle location of items on the cart, and obtaining audio and visual feedback information from the customer via its microphone and customer observing camera so that it can guide the customer to the store aisle for the product.

FIG. 40 is a right side view of the autonomous advertising cart with a right side video display panel showing the cart interacting with a customer through audio and visual communications via its display and speakers.

FIG. 41 is a rear view of the autonomous advertising cart with a rear video display panel activated to provide a video communication.

FIG. 42 is the left side view of the autonomous advertising cart with the left side video display panel activated to display a text communication about the kind and price of the items on the cart.

FIG. 43 is an electrical schematic of the for the autonomous advertising cart.

FIG. 44 shows the electrical cabling for the autonomous advertising cart.

FIG. 45 is an electrical schematic of the radar version of the autonomous advertising cart.

### DESCRIPTION OF THE PREFERRED EMBODIMENTS

While this invention is susceptible of embodiments in many different forms, the drawings show and the specification describes in detail preferred embodiments of the invention. It should be understood that the drawings and specification are to be considered an exemplification of the principles of the invention. They are not intended to limit the broad aspects of the invention to the embodiments illustrated.

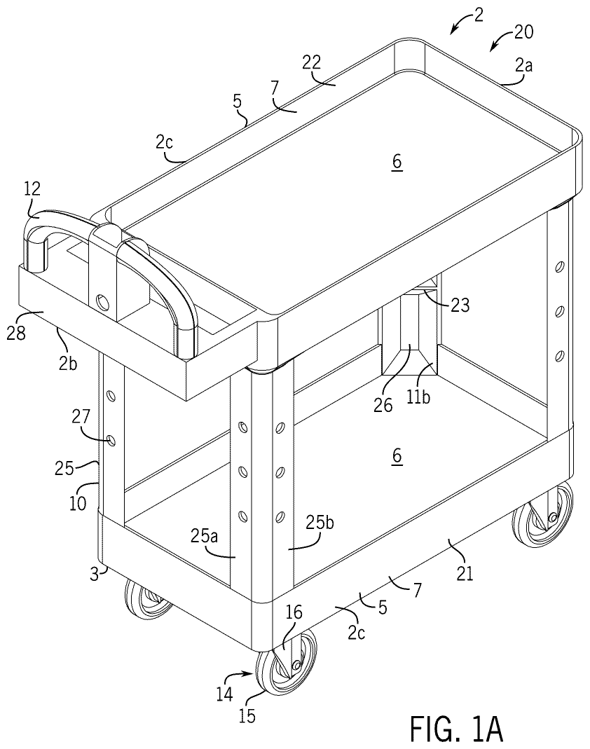

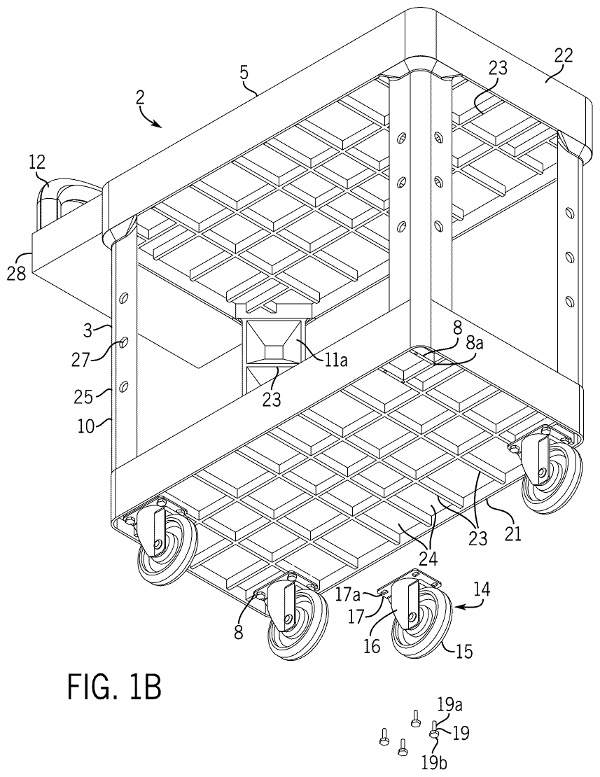

Conventional manually pushed utility carts are widely used to move tools, equipment, component parts, partially or fully assembled products and associated paperwork from one room or work station to another throughout a building. An example of a conventional utility cart 2 is shown in FIGS. 1A and 1B. The conventional plastic cart 2 has a front end 2a, rear end 2b and sides 2c. The cart or vehicle 2 has a structure or frame 3 that includes a number of stacked trays 5 and vertical risers 10. Each tray 5 has a generally flat and horizontal surface 6 upon which items are placed and an upwardly extending lip 7 around its perimeter to keep items from sliding or rolling off the tray. Each riser 10 has a generally linear shape with top 11a and bottom 11b ends. Two risers 10 are located at the front 2a of the cart 2, and two risers 10 are located at the rear 2b. The vertical risers 10 join and space apart the horizontal trays 5. The trays 5 are secured proximal the upper 11a and lower 11b ends of the risers 10. A handle 12 is secured proximal the upper ends 11a of the rear risers 10, and extends rearwardly from the rear risers to provide walking space behind the cart 2. Workers grip and hold the handle 12 to push or pull the cart. The underside or bottom of the cart structure 3 or lower tray 5 includes caster wheel mounting structures 8 to firmly and securely mount a number of caster wheel assemblies 14. One caster wheel mounting structure 8 is typically located proximal each lower corner 4 of the cart structure 3 or lower tray 5. The mounting structure 8 includes a number of vertical fastener openings 8a, which are relatively deep to ensure the caster wheels are securely attached to the cart frame or structure 3.

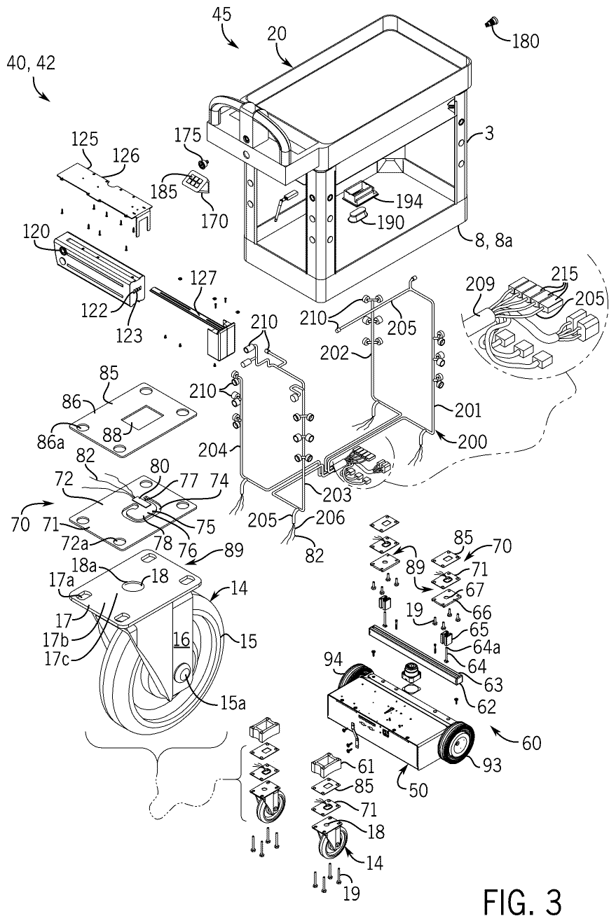

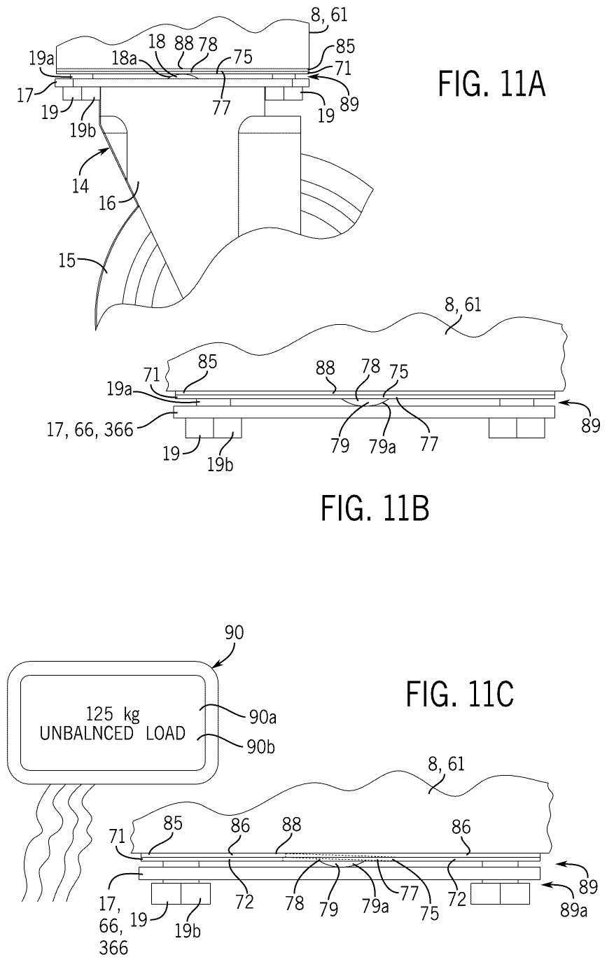

Conventional utility carts 2 typically have four caster wheel assemblies 14. Each caster wheel assembly 14 has a wheel 15 and a swiveling hub 16. Each hub 16 supports an axel 15a that rotatably holds its wheel 15 to allow the wheel to rotate and roll along the floor of the building. Each hub 16 also has a caster mounting structure 17 that swivelingly secures the wheel 15 and hub 16 to the cart mounting structure 8. The upper surface of the caster mounting structure 17 frequently has a central area 17c having a rounded crown 18 with an upwardly facing curved surface 18a as in FIGS. 3 and 11A. The caster mounting structure 17 has fastener openings 17a formed around its perimeter portion 17b, and is secured to the cart mounting structure 8 by fasteners 19 so that each hub 16 is free to rotate or swivel about a hub mounting axis which allows the wheel to turn to the right or left through 360 degrees (360°) and allows the cart 2 to move in any direction. Each hub 16 is free to directionally swivel or rotate independently of the other caster wheel hubs to allow the cart 2 to be pushed or pulled in any direction through 360 degrees, so the cart can turn, move sideways or back up. Two caster wheel assemblies 14 are located proximal the corners 4 of the front end 2a of the cart 2, and two caster wheel assemblies 14 are located proximal the corners of the rear end 2b of the cart. While the cart 2 is shown to have a certain shape and height, with two trays 5, four risers 10 and four caster wheel assemblies 14, it should be readily understood that the cart can have a variety of shapes and heights, one or more trays, and three or more caster wheel assemblies.

A plastic embodiment 20 of the conventional utility cart 2 is shown in FIGS. 1A, 1B and 6-9. Although the size and shape of the plastic utility cart 20 can vary, the cart 20 shown has a length of about 39 inches (1 meter), width of about 17 inches (43 cm), height of about 33 inches (84 cm) and weight of about 31 pounds (14 kg), and four caster wheel assemblies 14 with five inch (13 cm) diameter wheels. The cart 20 has two robustly designed plastic trays 21 and 22. The stacked trays 21 and 22 have a rectangular shape and a depth of about 2½ inches (6 cm). Each tray 21 and 22 has structural webbing 23 supporting its upper surface 6. The webbing 23 forms compartments or openings 24 under the surface 6 of the tray. The solid upper wall or surface 6 of each tray uniformly spans the length and width of the rectangular tray 21 and 22. The cart 20 has four robustly designed plastic risers 25. Each riser 25 has an L-shaped cross-sectional shape with perpendicular sides 25a and 25b that form an inner channel 26 along its vertical length. Each riser 25 has a forwardly or rearwardly facing side 25a and a sidewardly facing side 25b. Openings 27 are formed at spaced locations along the vertical height of both sides 25a and 25b of each riser 25. Each riser 25 has three forwardly or rearwardly facing openings 27, and three sidewardly facing openings 27. The upper tray 22 includes an integrally formed rearwardly cantilevered tray 28. The handle 14 extends upwardly from the rear end 2b of the cantilevered tray 28. Each of the caster wheel mounting structure takes the form of a plate or bracket 17 that is secured by four fasteners 19, such as screw-type fasteners. The fasteners 19 extend through bracket holes 17a in bracket perimeter portions 17b and into the four aligned holes 8a of the mounting structure 8 to firmly secure a caster wheel assembly 14 to the cart structure 3 or lower tray 21.

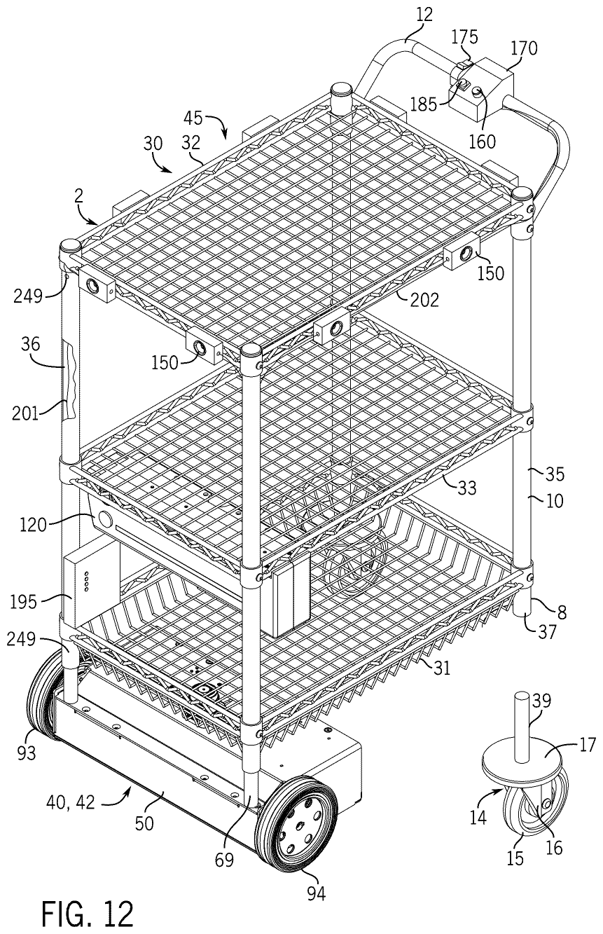

A metal embodiment 30 of the conventional cart 2 with its two front caster wheel assemblies 14 removed is shown in FIG. 12. This cart 30 has three robustly designed lower 31, upper 32 and middle 33 wire mesh trays or baskets. The stacked trays 31-33 have a rectangular shape. The corners of the trays 31-33 are joined together by four metal, vertical, tubular risers 35. Each tubular riser 35 has an open interior 36 and an open bottom end 37. The mounting structure of each caster wheel assembly 14 takes the form of a mounting bracket or plate 17 with an upwardly extending mounting post 39. Each mounting post 39 is secured to the cart mounting structure 8, which takes the form of the open bottom end 37 of the tubular risers 35 that receives the post 39 in an in-line manner.

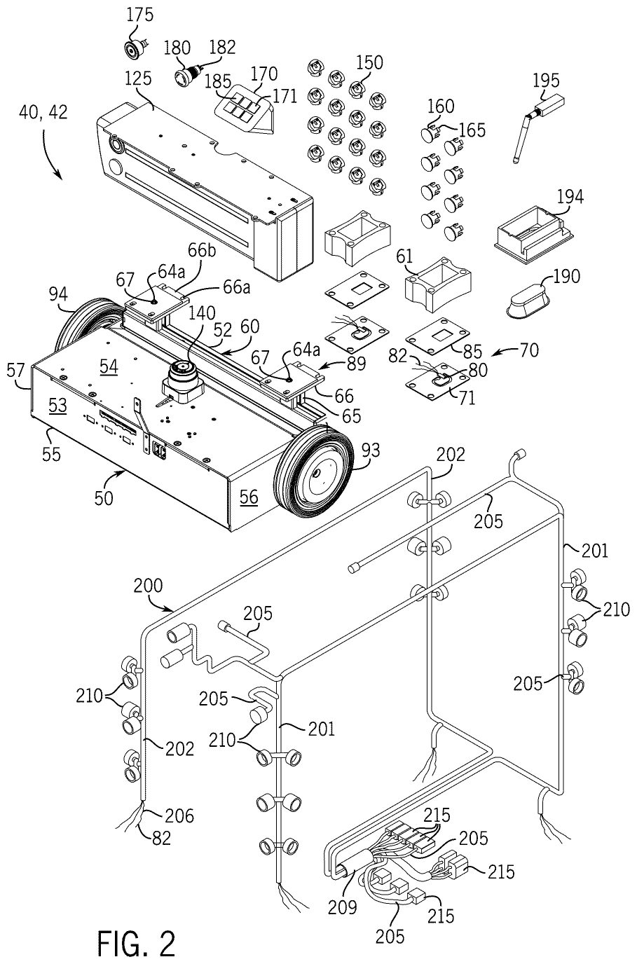

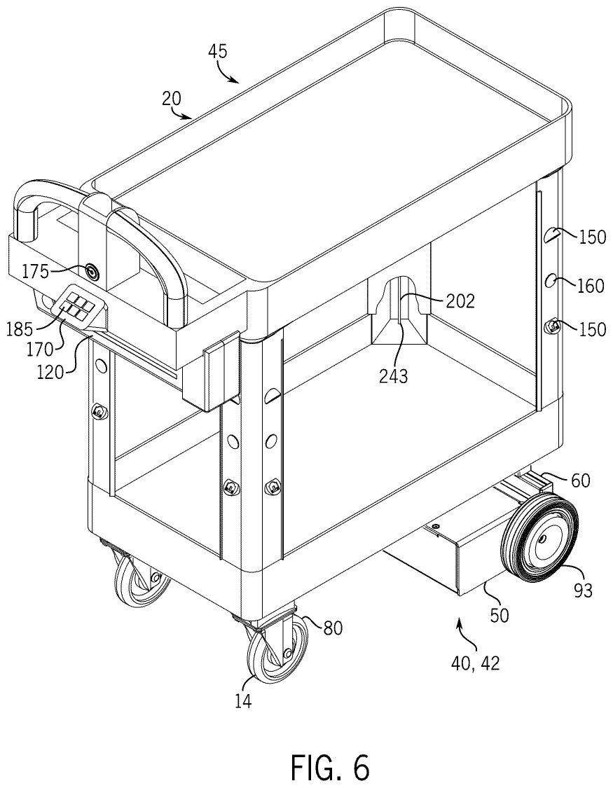

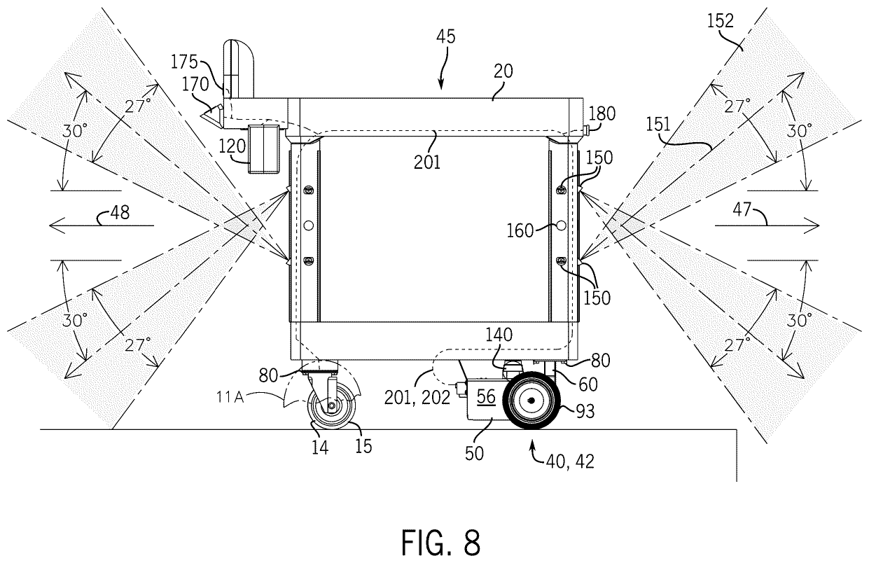

The present invention pertains to a robotic cart platform system integrated into a conventional cart 2, 20, 30 to form an autonomous robotic cart or vehicle generally indicated by reference numbers 40 and 45 as shown in FIGS. 2-12. The components forming the robotic cart platform 40 and its navigation and movement system 42 are shown in FIG. 2-5B. The integration of these components into a conventional plastic 20 or metal 30 cart to form an autonomous cart 45 with the navigation and movement system 42 is shown in FIGS. 6-12. The robotic cart platform 40 has a drive unit 50 that propels itself and the autonomous cart 45 in a forward 47 or rearward 48 direction of travel, and can readily turn by moving in arcuate directions 49 of travel as shown in FIGS. 8, 10 and 13.

The robotic cart platform or RCP 40 has a motor driven autonomous drive unit 50 shown in FIGS. 2-5B. The RCP 40 and its navigation and movement system 42 use the wheeled drive unit 50 to autonomously propel the cart 20, 30. The drive or base unit 50 is compact and has a low profile to fit under the cart structure 3 or lower tray 21, 31. The drive unit 50 has a weight of about 20 kilograms, width of about 45 centimeters, height of about 11 centimeters, length of about 23 centimeters and a top speed of about 2 meters per second. The drive unit 50 has a generally rectangular block shaped housing 51 with a front, rear, top, bottom and right and left sides 52-57. The front 52 of the drive unit is located even with or proximal the front 2a of the cart structure 3 or lower tray 21, 31. The front 52 and rear 53 sides are generally parallel, as are the top 54 and bottom 55 sides, and the right 56 and left 57 sides, respectively.

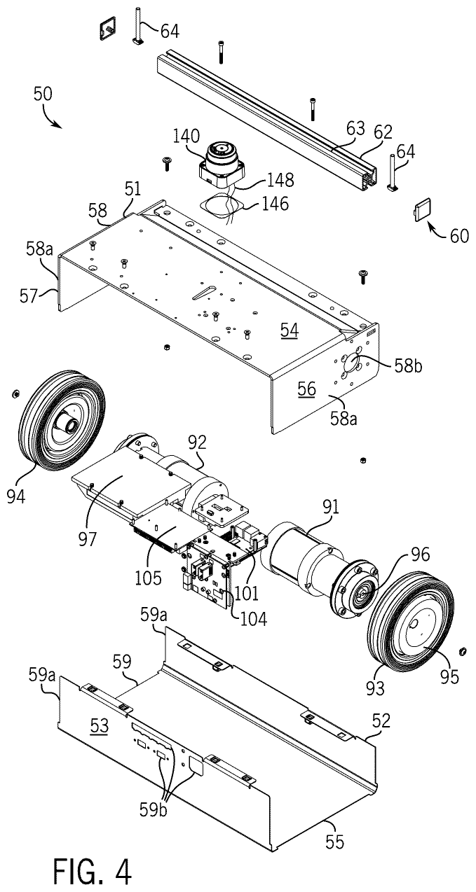

The housing 51 is robustly designed to maintain its shape during use, and is formed by upper 58 and lower 59 metal portions best shown in FIG. 4. The load-bearing upper portion 58 is made of ¼ inch (6 mm) plate steel, and has side flaps 58a that form the right and left housing side surfaces 56 and 57. The lower portion 59 is made of 18 gauge sheet metal, and has flaps 59a that form the front and rear housing surfaces 52 and 53. The thick metal construction of the housing 51 acts as a heat sink to dissipated heat from internal electrical components. The top surface 54 of the upper portion 58 has a central LIDAR scanner opening. The side flaps 58a have wheel holes 58b aligned to form a linear wheel axis parallel to the front and rear housing surfaces 52 and 53. The rear flap 59a includes a series of punch-outs or openings 59b for the input/output terminals or connections of various external input and communication devices, such as sensors, lights, power supply, control panel and optional WiFi unit.

An adjustable mounting assembly 60 secures the autonomous drive unit 50 to the conventional utility cart 20, 30 as shown in FIG. 3. To adjust for the height of the RCP 40 and its mounting assembly 60, spacers 61 are inserted above each of the rear caster wheel assemblies 14. The adjustable mounting assembly 60 includes a mounting bracket or bar 62 rigidly secured to the top 54 of the housing 51 along the front end 52 or edge of the housing 51. The bracket 62 has a cross-sectional shape forming a generally upside-down T-shaped opening along its length. The bracket 62 and T-shaped opening form an adjustable mounting track 63 along the length of the bracket. The adjustable assembly 60 and bracket 62 accommodate both a cart 20 with a caster wheel mounting structure 8 formed with fasteners holes 8a, and a cart 30 with a caster wheel mounting structure formed by a mounting bracket 17 with a mounting post 39 that is received by the open bottom ends 37 of the tubular cart risers 35. For a cart 20 with a caster wheel mounting structure that takes the form of mounting brackets 17 and fasteners 19 (FIGS. 3, 4 and 7), headed fasteners 64 are slidingly received by the track 63 and matingly held by the bracket 62. The wider head of each headed fastener 64 is received inside the broader portion of the T-shaped track opening with the narrower elongated shaft of the fastener 64 extending upwardly through and out of the narrower portion of the T-shaped track 63. A spacer 65 is placed over each of the two fasteners 64 to adjust the height of the drive unit 50 and mounting assembly 60. A mounting plate 66 with fastener openings 66a formed around its perimeter portion 66b is secured to the upper protruding end of the fastener 64. The mounting plate 66 has a threaded hole 67 for receiving the threaded shaft of the fastener 64 to securely fix and set the height of the mounting plate 66. When assembled, the top or tip 64a of the threaded fastener 64 protrudes through hole 67 a predetermined amount to form a raised abutment above the upper surface of the mounting plate 66. As discussed below, the focusing area 78 of the sensor plate 71 rests on the tip 64a of the fastener 64 as shown in FIGS. 3 and 4, which forms a gap 89 as in FIG. 11A between the mounting and sensor plates 66 and 71. For a cart 2, 30 with a caster wheel mounting structure that takes the form of a mounting bracket 17 with mounting post 39, headed mounting posts 69 are used as shown in FIG. 12. The height of the drive unit 50 and mounting assembly 60 generally equals the height of the rear caster wheel assemblies 14 and spacers 61 so that the cart 2, 20, 30 and their trays 5, 21-22, 31-33 are level.

The cart has four weight sensor assemblies 70. Two weight sensor assemblies 70 are located directly above the mounting plates 66 of the mounting assembly 60 as shown in FIGS. 2 and 3, and two weight sensor assemblies are located directly above the mounting structure or bracket 17 of the rear caster wheel assemblies 14 as shown in FIG. 3 (bottom left), 11A and 11B. Each sensor assembly 70 includes a sensing plate 71 and a spacer plate 85. The sensor plate 71 has a perimeter portion 72 with fastener openings 72a. The plate 71 has a generally U-shaped slot or opening 74 cut out of the plate around and proximal its center to form an inwardly extending weight supporting tab 75. The support tab 75 extends from one side of the perimeter portion 72 toward and into the center of the plate 71. The support tab 75 has an upper surface 76, a semi-flexible neck 77 and a weight supporting central area 78. When needed, the central area 78 has a downwardly facing crown, dimple or depression 79 with a curved surface 79a as in FIGS. 11B and 11C. The neck 77 is semi-flexible in that it elastically bends a slight amount (less than about an eighth of an inch (3 mm) depending on the weight or force applied, but continues to support the weight of the cart 45 and items or payload 29 placed on the cart. A weight sensor 80 such as a piezoelectric sensor is secured to the upper surface 76 of the semi-flexible neck 77. The threaded fasteners 19 are non weight-bearing and move down to form a gap 89 between the fastener heads 19b and the mounting plates 66 when an item is placed on the cart. When the weight sensor assemblies 70 are used without the RCP 40, a visual display 90 (FIG. 11C) having a programmed processor 90a and memory 90b is secured to the cart 2. The processor 90a is in electrical communication with the visual display 90, and each sensor 80 sends weight data to the processor via wires 90c. When used with the RCP 40, each sensor 80 is in electrical communication with the RCP circuitry via wires 82, or a visual display 90 with a programmed processor 90a secured to the cart structure.

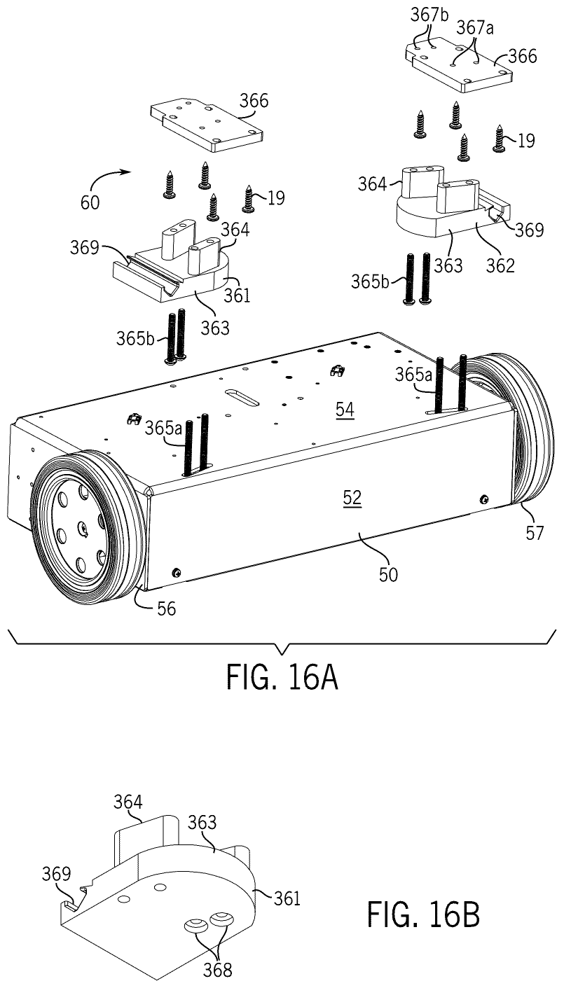

The spacer plate 85 is located above the weight sensing plate 71. The spacer plate 85 has a perimeter portion 86 with fastener openings 86a, and a hollowed out center opening 88. The central opening 88 accommodates the upward flexing of the support tab 75, and provides a pathway for routing the sensor wires 82. The central weight focusing area 78 of the sensing plate 71 rides on top of and is in weight supporting engagement with mounting plate 17 (FIG. 11A-11C) or fastener tip 64a of mounting plate 66. (FIG. 2-4). In some situations, such as for the two rear weight sensor assemblies 70, the upwardly extending central crown 18 of the caster wheel mounting plate 17 supportingly engages the bottom surface of the central focusing area 78 as shown in FIG. 11A. In other situations, such as for the drive unit mounting assembly 60, the downwardly facing crown, dimple or depression 79 (FIG. 11B) of the focusing area 78 rides on and engages the upper surface of the mounting bracket 66 or 366. (FIGS. 3 and 16A). The sensing and spacer plates 71 and 85 above the rear caster wheel assemblies 14 are located between the caster mounting bracket 17 and lower surface of the cart mounting structure 8. The sensing and spacer plates 71 and 85 above the drive unit mounting assembly 60 are located between the upper surface of each mounting plate 66 or 366 and the lower surface of the cart mounting structure 8.

The weight of the cart 20, 30 is supported by the central focusing areas 78 of the support tabs 75 of the four sensor plates 71. The sensor 80 is firmly secured to the semi-flexible portion or neck 77 of the sensor plate 71. The deformation of the support tab 75 by the weight of the cart 2, 20, 30 and its load causes a change in resistance in the sensors 80. The sensor 80 changes resistance when force is applied to the focal area 78 or dimple point 79 of plate 71. This change in resistance data or weight level data is sent to the visual display processor 90a or RCP processor 102 and automatically used by the processor to determine a digital weight measurement of the amount of weight carried by each sensing plate 71. The weight measurement data is then used by the higher-level functions of the visual display or RCP processor. For example, to compare the weight measurement data with a weight threshold value stored in the memory 90b, 103 to determine if the payload 29 is beyond a threshold or maximum supportable weight, or to determine if the load is balanced or unbalanced. For a balanced load, each sensor plate 71 carries a quarter of the load weight. For unbalanced loads, one or two sensors carry significantly more of the load weight than the other sensor plates. The processor then sends a digital warning message to the visual display 90 or control panel 170 (discussed below) to display a warning message via an icon on a key (such as “load capacity exceeded,” “unbalanced load” and lighting the key “red”). Although the weight sensor 80 is shown and described as being a strain gauge sensor, such as a piezoelectric sensor, it should be understood that other embodiments such as a force resistor may also be used.

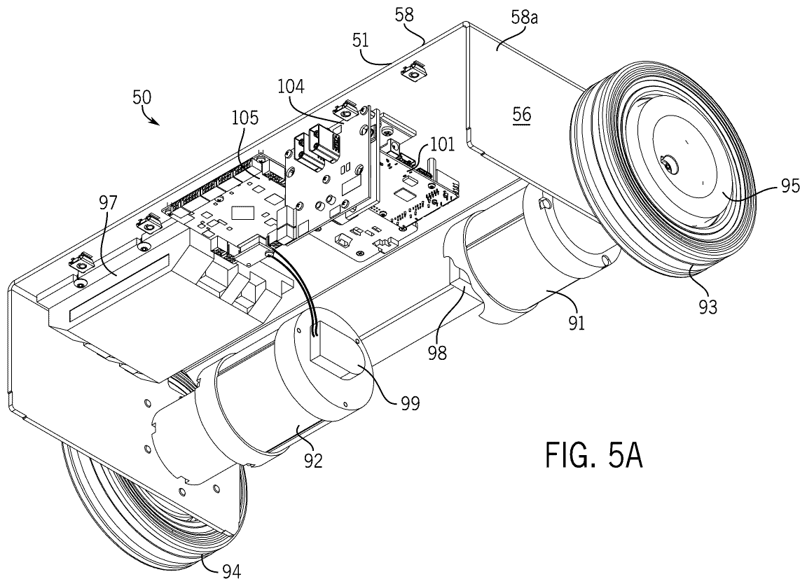

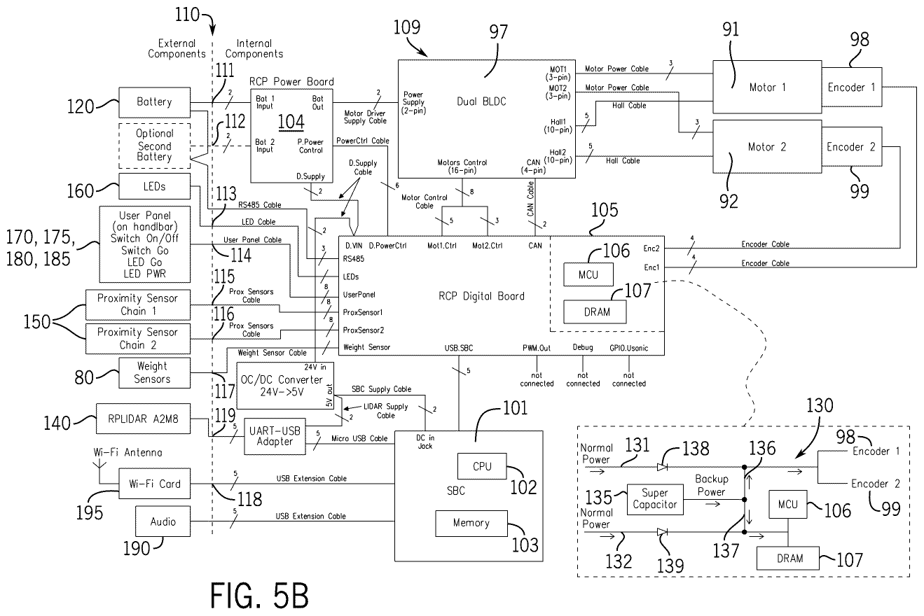

The drive unit 50 has two drive motors 91 and 92 and two drive wheels 93 and 94 as shown in FIGS. 4, 5A and 5B. Each wheel 93, 94 has a hub 95 that securely receives the drive shaft or wheel axel 96 of its associated motor 91 or 92. The motor 91 on the right side 56 of the base unit 50 drives the right wheel 93, and the motor 92 of the left side 57 of the base unit drives the left wheel 94. Each motor 91 and 92 independently drives or turns its associate drive shaft 96 and wheel 93 or 94. Each motor 91 and 92 can turn its drive shaft 96 and wheel 93 or 94 either in a clockwise direction or a counterclockwise direction. The independent operation of the drive motors 91 and 92 allows the RCP drive unit 50 to rotate in place, and allows the autonomous cart 20, 30 to make turns with a minimal distance of travel.

The right and left motors 91 and 92 are mounted to the inside surface of the right and left sides 56 and 57 of the housing 51, respectively. The motors 91 and 92 are securely mounted by screw fasteners, so that their drive shaft or wheel axel 96 extends through the housing wheel openings 58b in side flaps 58a. The wheel axels 96 are colinear, and the drive wheels 93 and 94 are parallel to the sides 2c of the cart 2. The wheels 93 and 94 do not swivel to the right or left as do the rear caster wheels 15. Turns are taken by differing the rate of rotation or direction of rotation of the right and left drive wheels 93 and 94. The wheels 93 and 94 have a diameter of about six inches (15 cm) and are sized and positioned outside of housing 51 with their outer perimeters riding along the ground. There is preferably about 1.1 inch (2.8 cm) of clearance between the bottom 55 of the housing 51 and level ground so that the RCP 40 can traverse deviation in the ground surface. The drive wheels 93 and 94 are also sized in combination with the height of the base unit 50 and its mounting assembly 60 to ensure the cart 20, 30 is level.

When the RCP 40 is turned on or activated, the cart 20, 30, 45 is in its autonomous mode. Electric power is supplied to the motors 91 and 92, which turn their respective wheels 93 and 94 to propel the cart from one location to another along straight 47, 48 or curved 49 paths of travel. When the RCP 40 is turned off or deactivated, the cart 20, 30, 45 is in a manual mode, and power to the motors 91 and 92 is cut off. The deactivated motors 91 and 92 do not inhibit the free rotation of the drive wheels 93 and 94 so that workers can readily push or pull the cart 20, 30 from one location to another. The drive motors 91 and 92 are preferably brushless direct current (BLDC) motors with both clockwise and counterclockwise rotation connected to a planetary reduction gearbox. Each high torque electric motor 91, 92 has a length of about 6 inches (15 cm), diameter of about 3 inches (7.5 cm), rated voltage of about 24 volts, no-load speed of about 600 rotations per minute, rated torque of about 1.5 kilograms-centimeters, a reduction ratio of about 1/10 and output shaft diameter of about ¼ inch (6 mm). The output shaft 96 extends from the motor housing about 0.6 inch (15 mm), and the end of the shaft is notched to facilitate the rotationally locked securement of its associated wheel 93 or 94.

The motors 91 and 92 are interfaced to an associated dual motor controller 97. The rotational speed and direction (clockwise or counterclockwise) of each output shaft 96 is controlled by the controller 97, which is in electrical communication with motor 91 or 92 and controls the electric power supplied to each motor. The controlled power supply to each motor 91 or 92 via the motor controller 97 controls the speed of drive shaft 96 of each motor, and thus the rotational speed of the drive wheels 93 and 94. The controller 97 is preferably a brushless direct current (BLDC) motor controller with a 6.5 to 50 volt input, 350 watt brushless DC motor speed regulator control module, a 12 volt, 24 volt, 36 volt and 48 volt high power BLDC speed motor controller driver board with heat sinks and 0 to 5 volt PWM duty ratio control with an FG pulse signal and 9 pulse/round.

Each motor 91 and 92 is interfaced to an associated “always-on” encoder 98 and 99. Each encoder 98 and 99 has a rotary disk and output cable. Each rotary disk is mounted to its respective motor 91 or 92 to optically view the rotational movements of its associated motor drive shaft 96, and thus the rotational movements of its associated wheel 93 or 94. The rotary disk transmits this shaft rotational movement data or information via its output cable to the microcontroller 106 and its memory 107, which is then periodically transmitted to the RCP processer 102 and its memory 103. This shaft rotation or wheel movement data is used by the RCP processor 102 to determine the distance of travel and path of travel taken by the RCP 40 and autonomous cart 45 from its start location or start location coordinates, and to determine the coordinates or coordinate data associated with the current physical location 100 of the RCP 40 and cart 45. The high impact resistance encoders 98 and 99 preferably have a power supply of about 5 volts DC, resolution of about 400 pulses per rotation, speed of about 2400 rotations per minute, optical disk with a thickness of about 0.05 inches (1 mm), diameter of about one inch (2.5 cm) and hole diameter of about 0.47 inches (12 mm), AB 2 phase output, and line driver with ABZA-B-Z channels.

The RCP navigation and movement system 42 and drive unit 50 have circuit boards including a single board computer 101, power board 104 and digital board 105 as shown in FIGS. 5A and 5B. The single board computer 101 includes the main processor or CPU 102 with associated long-term hard drive memory 103. The digital board 102 includes a microcontroller 106 with associated short-term dynamic rapid access memory or (DRAM) 107. Circuitry 109 interconnects the boards 101-103, processor 102, microcontroller 106 and their associated memories 103 and 107, motor controller 97, drive motors 91, 92 and encoders 98, 99, as well as components external to the housing 51, such as weight sensors 80, power supply, LIDAR scanner 140, proximity sensors 150, safety lights 160, control panel 170, etc., as discussed below. Components mounted inside the drive unit housing 51, such as motors 91 and 92, motor controller 97 and encoders 98 and 99, are wired for power and communication with the processor 102 and microcontroller 106 directly to connections in the drive unit circuitry 109. Devices mounted on the cart structure 3 external to the drive unit 50 are electrically connected for power and communication to the drive unit circuitry 109 and circuit boards 101, 104 and 105 via a number of input/output terminals or ports 110, including two battery ports 111 and 112, LED lights port 113, control panel port 114, two proximity sensor line ports 115 and 116, weight sensor port 117, WiFi port 118 and an audio port. The LIDAR scanner mounted atop the drive unit 50 is wired directly to LIDAR connections in the circuitry 109 or to a LIDAR port 119. The control panel port 114 is equipped to power and communicate with switches, such as an On/Off switch, and “GO” and emergency stop buttons, discussed below.

Data processing by the navigation and movement system 42 is handled by the programmed RCP processor 102 and microcontroller 106. The microcontroller 106 runs low level firmware that provides very fast, real time processing. The RCP processor 102 provides higher level functionality such as planning a route 149 and motor movement instructions for the RCP 40 and communicating with workers via the safety lights, control panel, audio speakers and WiFi unit, as discussed below. RCP mapping data obtained by the LIDAR sensor 140 flows from the microcontroller 106 to the main RCP processor 102. The microcontroller 106 saves mapping data in its short-term memory or DRAM 107, and then periodically conveys that data to the RCP processor 102 for storage in its long-term hard drive memory 103. Both the processor 102 and microcontroller 106 do some processing of data. For example, the microcontroller 106 use the proximity sensors 150 to scan or detect an obstacle that is present for several seconds then goes away (someone walking by). As the microcontroller 106 passes this data to the RCP processor 102, the RCP processor filters out the temporary or passing obstacle data from long term storage 103 since the obstacle 262a was more momentary and not long term like a wall, pillar or the edge of a loading dock 262. The RCP processor 102 has both associated dynamic memory, such as DRAM that is deleted from storage when power is removed, and long term hard drive memory 103 that remains stored even when power is removed.

The RCP 40 includes a portable power supply or battery pack 120 mounted to the autonomous cart 45. The battery 120 has power and communication ports 122 and 123, and supplies electric power to all the internal and external components and devices of the RCP 40 via its drive unit circuitry 109 and terminals 110. The battery pack 120 is secured to the cart 45 at a location that avoids interfering with loading and unloading the cart or impairs other activities of the workers using the cart, and allows easy access for swapping out a first battery pack with a second replacement battery pack when the first battery pack needs recharging. The power source 120 is designed to provide sufficient power to the RCP 40 for a four hour work shift and propel the cart for 500 to 1,500 meters carrying a 50 to 100 kilogram payload at a walking speed of about one meter per second. The main power source 120 is preferably a multi-cell battery pack with multiple lithium ion batteries (about 50 cells) to produce about 129.5 Wh, with each cell having a rechargeable capacity of about 4.1 volt/2500 mAh, a 24 volt output port and an RS-485 (two wire) communication port. The battery pack 120 is secured to the cart 20, 45 via a mounting bracket assembly 125 that includes a support bracket 126 with a slide bar 127. The slide bar 127 allows the battery pack 120 to be quickly removed for recharging and allows a fully charged battery pack to be quickly secured.

The RCP circuitry 109 includes a backup power circuit 130 on the digital board 105 as shown in FIG. 5B. When the RCP 40 is turned on, power from the battery 120 is supplied to the encoders 98 and 99 via a normal encoder power line 131, and is supplied to the microcontroller or MCU 106 and its memory or DRAM 107 via a normal microcontroller power line 132. When battery 120 power is turned off or otherwise disrupted, the backup circuit 130 supplies electric backup power to the encoders 98 and 99, MCU 106 and DRAM 107. The backup power circuit 130 has a backup power source 135, such as a super capacitor. Electric power from the super capacitor 135 is supplied to the encoders 98 and 99 via an encoder backup line 136, and is supplied to the microcontroller 106 via an microcontroller backup line 137. The backup power lines 136 and 137 are electrically connected to the super capacitor and the normal power lines 131 and 132, respectively. Diodes 138 and 139 in the normal power lines 131 and 132 prevent power from the super capacitor 135 from flowing to the battery 120. Then, when the battery 120 power to the RCP 40 is turned back on, power from the battery 120 flows through the diodes 138 and 139 and backup lines 136 and 137 to recharge the super capacitor 135. The super capacitor 135 holds sufficient power to operate the encoders 98 and 99, MCU 106 and DRAM 107 for about one week. The super capacitor 135 is preferably an SCCY83B507SLBLE by AVX corporation.

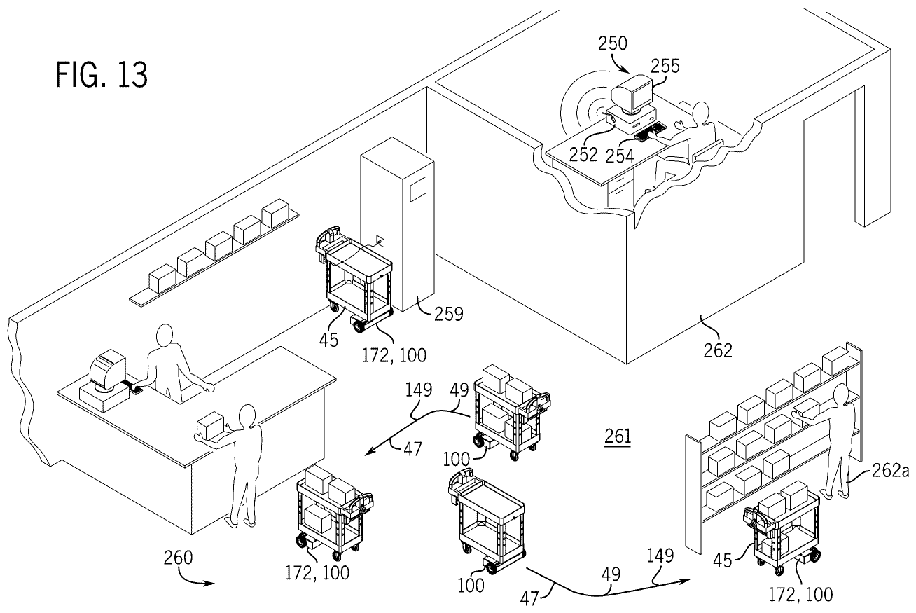

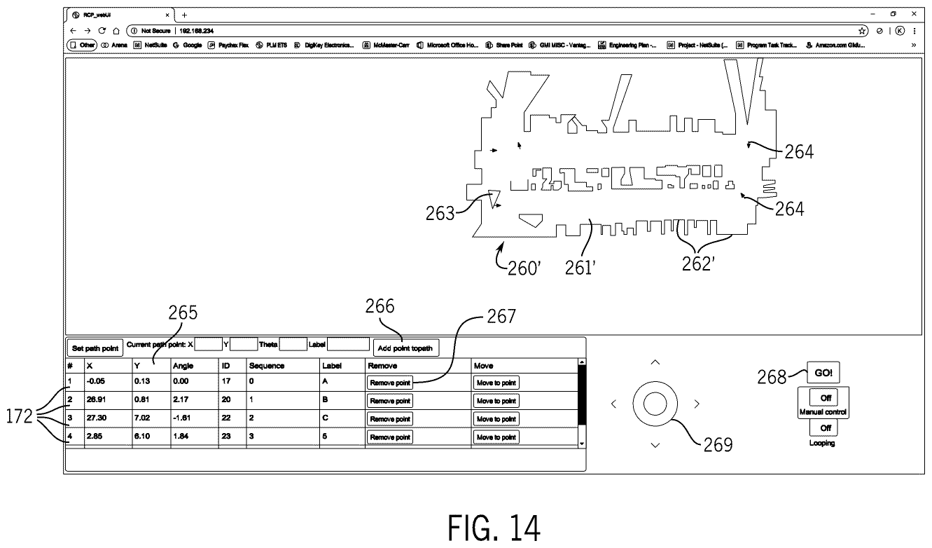

The autonomous cart 45 includes a time-of-flight laser scanner 140 as shown in FIGS. 2-4, 8-9 and 12. As discussed below, the laser scanner 140 creates constantly updated mapping data that is used by the processors 102 and 106 to create [or] a high-resolution image map 260′ (FIG. 14) of the surrounding work environment 260 (FIG. 13) for navigation and avoidance of fixed structures (such as walls, posts, support columns and staircases) and more permanent obstacles (such as furniture, workbenches and shelving units). Although the scanner 140 also detects temporary obstacles (such as workers walking by or packages temporarily placed on the floor), the processor 102 deletes these temporary obstacles 262a from its environmental mapping data stored in its long-term memory 103.

The laser scanner 140 is preferably a triangulation type laser scanner such as a LIDAR (light detection and ranging) sensor with 2D imaging, three hundred and sixty degree (360°) omnidirectional laser range, scanning range of about 12 meters, power input of about 5 volts, sample rate of about 8,000, configurable scan rate from about 2 to 10 hertz, breakout of about 940 nm and is plug-and-play, such as an RPLIDAR A2 by Slamtec. The RCP 40 uses the LIDAR scanner 140 to obtain environmental mapping data that is stored in its memory 103. The RCP 40 uses this mapping data to identify open areas 261 in the building through which the RCP 40 and cart 45 can travel, and to identify fixed structures 262 in the building through which it cannot travel. The RCP 40 uses the mapping data and current location 100 data to determine a route 149 along which the cart 45 can travel to a selected destination 172 as discussed below. (FIGS. 13 and 14). The RCP 40 also uses the LIDAR scanner 140 to detect obstacles as it is en route to a destination.

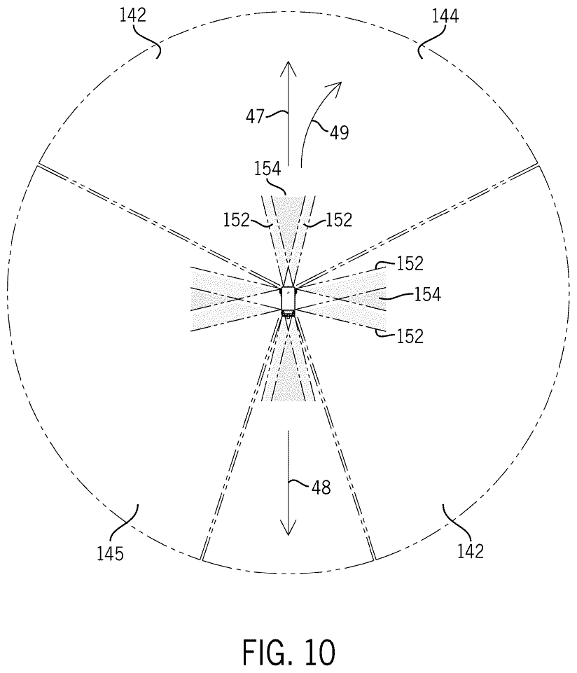

The LIDAR scanner 140 is preferably mounted on the RCP drive unit 50 below the cart structure 3 and lower tray 21, 31. The scanner 140 is secured to the autonomous cart 45 at a location providing a substantially unobstructed 360° view or substantially circumferential sensing range of the environment 260 around the cart, is protected from inadvertent contact by workers and objects, and does not interfere with the operation of the cart or workers. A particularly good location for the 360° scanner 140 is in the middle of the top surface 54 of the drive unit housing 51, although other locations on the RCP drive unit 50 or cart 45 are possible. The rotating scanner (not shown) of the LIDAR scanner 140 is located above the drive unit mounting bracket 62, so the bracket does not obstruct the view of the scanner. Only the drive unit mounts 65 and a small portion of the rear caster wheel assemblies 14 obstruct the 360° scanning area or plane 142 of the LIDAR scanner 140 as shown in FIG. 10. In this mounting location, the LIDAR scanner 140 views a circumferential sensing or working range of greater than about 340° of the surrounding environment. The forward viewing area 144 in front of the cart 45 is virtually unobstructed through about 180° and is completely open and unobstructed through about 90°. The rearward viewing area 145 to the rear of the cart 45 is virtually unobstructed through about 180° and is completely open and unobstructed through about 35°. As the LIDAR scanner 140 is mounted directly to the drive unit housing 51 via a mounting bracket 146, its electrical power and communication wires 148 pass through an opening in the top 54 of the housing 51 (FIG. 4), and are directly connected to designated LIDAR connections in drive unit circuitry 109 as discussed above.

Proximity sensors 150 are mounted on the autonomous cart 45 shown in FIGS. 2-3, 6-10 and 12. These sensors 150 allow the autonomous cart 45 to detect, and when necessary navigate around, fixed 262 and temporary 262a obstacles. The proximity sensors 150 are a type of time-of-flight distance sensor or ranging system integrated into a compact module. The sensors 150 are preferably a laser ranging system with a maximum sensing range of about four meters, working voltage of about 2.6 volts to 5.5 volts, supply current of about 15 milliamps, eye-safe 940 nm invisible emitter, programmable region of interest (ROI), field or view (FoV) or scanning cone of 27 degrees, configurable detection interrupts and dimensions of about 0.5×0.7×0.1 inches (2.5 mm). As shown in FIG. 8-10, each sensor 150 is pointed in a particular aimed direction 151 and has a 27° sensing cone 152 extending from the sensor for a range of about four meters. Each sensor 150 independently detects the presence of objects within its range and scanning cone 152. Each sensor 150 has a terminal for receiving electric power and sending or receiving communication signals from the microprocessor 106 or drive unit circuitry 109, and is secured inside the riser opening 27 by a mounting clip.

Multiple proximity sensors 150 are mounted to the autonomous cart 45 as shown in FIG. 6-10. Together these sensors 150 provide a substantially unobstructed view of the environment around the cart, particularly in the forward 47 and rearward 48 directions of travel, as well as outward from the sides 2c of the cart 45. The RCP 40 uses the proximity sensors 150 to detect obstacles when it is en route to a destination, and the microcontroller 106 can determine which of the sensors 150 was triggered by an obstacle. The sensors 150 are placed at locations that protect them from inadvertent contact by workers and objects and do not interfere with the operation of the cart or workers. For the plastic autonomous cart 20, 45 the proximity sensors 150 are mounted inside the riser channel 26, with each sensor peering from or out of riser openings 27. Four proximity sensors 150 are mounted in each L-shaped riser 25. One sensor 150 is mounted to peer from the top opening on each side 25a and 25b of each of the four risers 25, and one sensor 150 is mounted to peer from the bottom opening on each side of the risers, as best shown in FIGS. 8-10. Each riser 25 has two proximity sensors 150 pointing sideward 2c, and two proximity sensors pointing forward 2a or rearward 2b. The top sensors 150 are aimed 151 downward at an angle of about thirty degrees (30°), and the bottom sensors are aimed upward at an angle of about thirty degrees (30°), so that their scanning cones 152 start to overlap 154 about half way up the height of the cart 45.

For the metal autonomous cart 30, 45 (FIG. 12), the proximity sensors 150 are mounted to the outside of the lip 7 of the upper tray 32. Two proximity sensors 150 are mounted along each side of the tray 32. Two sensors are directed outwardly or forwardly from the front side 2a of the cart 30. Two sensors are directed rearwardly from the rear side 2b of the cart 30, and two sensors are directed sidewardly from each side 2c of the cart. No matter which direction the autonomous cart 20, 30, 45 is traveling, forward 47, rearward 48 or turning to the right or left 49, the cart has two proximity sensor 150 facing in that general direction.

Warning or safety lights 160 are mounted to and around the autonomous cart 45. For the plastic autonomous cart 20, 45 the lights 160 are mounted inside the riser channel 26, with each light peering from or out of a riser opening 27. Two safety lights 160 are mounted in each L-shaped riser 25. One light 160 is mounted to peer from the middle opening 27 on each side 25a and 25b of each of the four risers 25. Each riser 25 has one light 160 facing sideward 2c, and one light facing forward 2a or rearward 2b. The lights 160 are preferably LED lights that consume a minimal amount of electric power. The LED lights 160 slowly blink on and off when the cart is moving, and change color (orange) and do not blink when and obstruction is detected. Different colors can flag different situations such as purple-proximity sensor not working, white-cart is moving in that direction (headlights), red-cart is moving away (taillights) and green-all actions completed and cart is ready for another command. Each light 160 has a connection terminal for receiving electric power, and is secured inside the riser openings 27 by a mounting clip 165.

A control panel 170 or suitable device to allow a worker to communicate with the navigation and movement system 42 is mounted on the autonomous cart 45 as shown in FIGS. 3, 6, 15A and 15B. The panel 170 is mounted at a location that provides easy access by a worker, such as on or near the cart handle 12. The communication device 170 is preferably a 6-key input device with customizable LCD keys 171 and a microprocessor with nonpermanent rapid access memory, and is capable of displaying custom icons and animated gifs, such as the Eltato Stream Deck Mini pad by Corsair. Each key 171 has a surface that is touched or pressed to operate the key, although other activation mechanisms to physically operate the key are possible. Each key also has a tap-to-switch scene to launch various custom programmed capabilities.

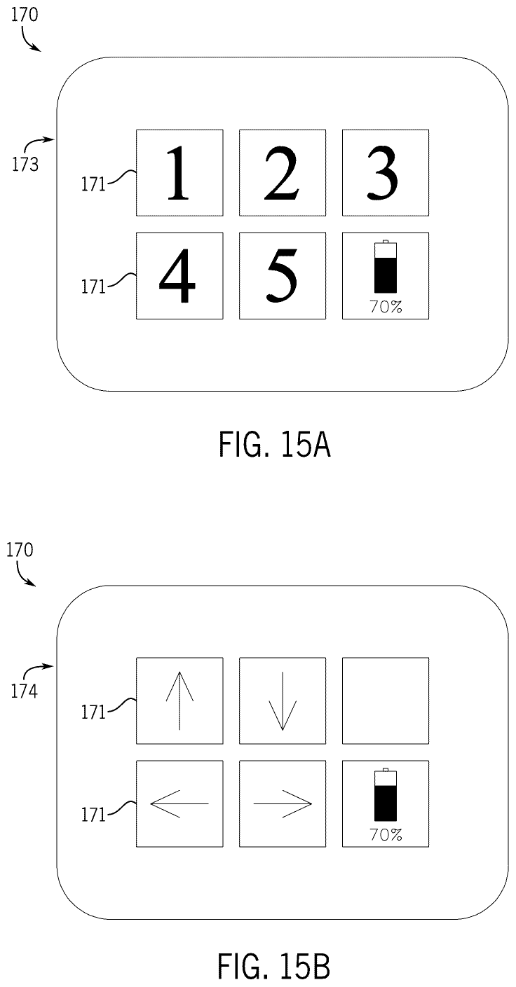

The communication device or control panel 170 is preferably secured to the rear side 2b of the utility tray 28 by a mounting bracket and fasteners. The panel 170 has a connection that receives a USB cable to provide electric power from the battery as well as send and receive signals, or otherwise communicate with the navigation and movement system 42, processor 102 and memory 103. The RCP memory 103 is loaded with sets 173 and 174 of icon images to selectively display on the six control keys 171. One set of icons 173 or 174 is displayed at a time on the keys. (FIGS. 15A and 15B). By pressing, touching or otherwise physically engaging or activating a designated key, such as the bottom right key displaying battery charge level information and a “battery charge level” icon, the control pad 170 switches between displaying the first 173 and second 174 set of icon images. One set of icon images 173 or 174 is displayed at a time. When a key 171 is pressed displaying a particular icon image, the control panel 170 sends a recognized instruction signal or command associated with that icon image to the RCP processor 102, which then uses the navigation and control system 42 to perform the particular navigation and movement operations necessary to complete that command.

The 6-key control panel 170 allows the navigation and movement system 42 to perform a wide range of functions. When the RCP 40 is turned on, the RCP processor 102 displays the set 173 of destination icons on the keys 171 as shown in FIG. 15A. The workers use this set 173 of destination icons (e.g. icon “1,” “2,” “3,” etc.) to enter multiple distinct desired destination locations 172 into the RCP memory 103. Once the cart 45 is positioned at a desired destination 172 as in FIG. 13, the worker presses and holds one of the keys 171 displaying a destination icon (e.g., icon “1”) for more than a predetermined threshold period of time, such as more than three seconds. The RCP processor 102 then uses RCP movement data such as drive shaft rotation data obtained from encoders 98 and 99 to determine the current physical location 100 and associated coordinates or coordinate data of the cart 45, and saves the coordinate data 265 for this location in the RCP memory 103 as the desired or selected destination 172 associated with that particular key 171 and its associated icon image (“1” icon). The background color of the destination key 171 will change from an unset color (gray) to a set color (green). This provides a visual indication to the workers that the desired destination 172 has been successfully set and stored in the RCP memory 103. Now, when the key 171 with this destination icon (“1” icon) is subsequently pressed for less the threshold period of time (less than three seconds), the cart 45 will go to that previously set and stored destination location 172. Each key 171 with a particular destination icon (“1-5”) is used to set and then later select a particular desired destination 172 associated with that icon.

The autonomous cart or vehicle 45 is programmable to stop when it gets to a desired destination 172 and wait for a worker to enter further control panel instructions, or move in a looped manner from one predetermined destination location 172 to another. For the later, once the cart 45 reaches a first desired destination 172 (“1” icon) and waits a predetermined period of time, the cart 45 goes to the next numerical predetermined destination 172 (“2” icon). Workers can change the order of the loop by resetting the particular destination 172 associated with each destination icon. Workers can delete a predetermined destination 172, and if desired replace it with another destination location 172 as noted above.

The set of arrow or movement icons 174 (FIG. 15B) allows workers to use the RCP drive motors 91 and 92 to move the cart or vehicle 45 in a self propelled manner as they walk behind the cart. When a key 171 with an arrow icon (e.g., “1” icon) is pressed, the cart 45 moves under its own power in the direction of the arrow until the worker stops pressing the key with that arrow icon. Destinations can be set by manually pushing the cart 45 or by using the keys 171 with the arrow icons to move the cart to a desired destination. Given backup circuit 130 and “always on encoders” 98 and 99, the cart 45 can be turned off and manually pushed to a location to be set as a destination. The RCP 40 uses its encoders 98 and 99 and drive shaft rotation data to determine the current, real-time location 100 of the cart 45 when a key 171 displaying a destination icon (e.g., “1” icon) is pressed. To set a desired destination 172, the autonomous cart 45 and communication device 170 needs to be powered on. The 6-key control pad 170 does not function when the cart 45 is not powered on.

A large visible on/off switch 175 is provided on or near the control panel 170. This switch or depressible button 175 is used to turn on or activate the RCP drive unit 50 by allowing electric power from the battery 120 to energize the internal and external RCP drive unit 50 components and devices that form the RCP 40, and place the RCP 40, navigation and movement system 42 and cart 45 in an autonomous mode of operation. The switch 175 is also used to turn off or deactivate the RCP 40 by disconnecting the flow of electric power from the battery 120 to the RCP, and place it and cart 45 in a manual mode of operation. The switch 175 is mounted through a hole drilled into the cart 20 and secured by a nut on the back side. Two wires on the back of the button 175 provide its electrical connection with the system circuitry 109. An emergency stop button 180 is located at the front 2a of the cart 45. This button 180 can also be used by a worker to turn off or deactivate the RCP 40, and place it and the cart 45 in a manual mode of operation. The button 180 has a rear connection 182 for receiving a USB cable to send and receive communication signals.

The control panel 170 has a “GO” button 185. For the plastic cart 20, 45 (FIG. 6), the 6-key control panel 170 is programmed to have one of its keys serve as the GO button. For the metal cart 30, 45 (FIG. 12), the GO button 185 is located on the control panel 170. The “GO” button is a momentary switch that is pressed to signal to the RCP processor 102 that it should instruct the RCP drive unit 50 to move. When the “GO” button 185 is pressed, the cart 45 will autonomously move to the next predetermined destination 172 selected by the worker or on the organized list of destination 264 coordinates 265 stored in the RCP memory 103, as discussed below. (FIG. 14). The cart 45 autonomously moves to the list of predetermined destinations in a loop, and then repeats that movement cycle. When the “GO” button 185 is pressed, the RCP 40 uses its navigation and movement system 42 to plan a route 149 to the selected destination or next destination on its list of destinations, and then moves along that route to the designation. When more than one destination is entered, set or otherwise downloaded into the RCP memory 103, the RCP 40 will move from destination to destination in a round loop each time the “GO” button is pressed. The RCP drive unit 50 and cart 45 stop once the RCP drive unit reaches the next destination. The control panel 170, switch 175, and emergency stop and GO buttons 180 and 185 are used by workers standing next to the cart 45, but can be remotely controlled by an optional server and wireless communication system as discussed below.

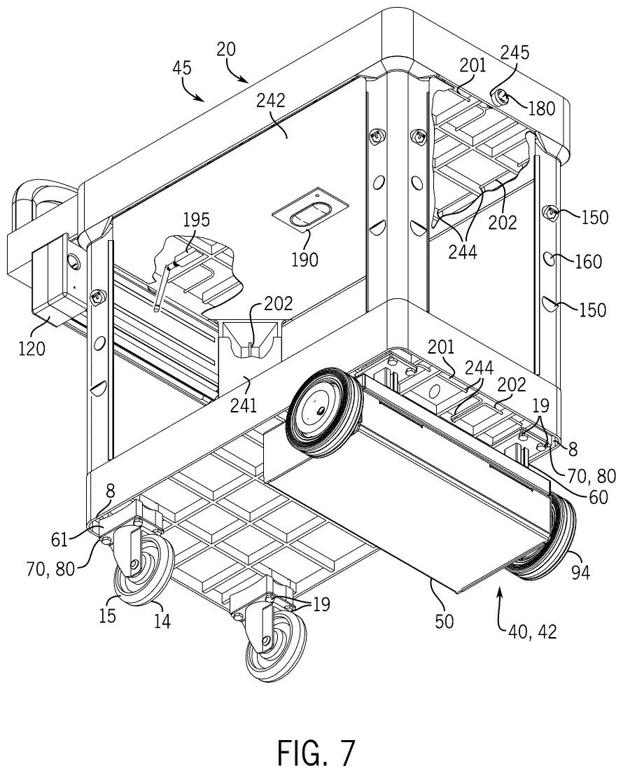

The RCP 40 is equipped with an audio speaker 190 for communicating with workers. For a plastic cart 20, 45, the speaker 190 is secured in a webbing compartment 24 on the underside of the upper tray 22 (FIG. 7), but can be mounted inside of the RCP housing. A speaker mount 194 is provided to secure the speaker in place. The speaker 190 is electrically connected by a USB cable for power and communication to the RCP 40 and its processor 102 via the circuitry 109 and an input/output terminal of the RCP drive unit 51. The processor 102 is programmed to send one of several audio messages stored in its memory 103 to the speaker 190 for a variety of reasons. For example, these reasons include when the proximity sensors 150 detect a moving object 262a (such as a person) in the vicinity, the weight sensors 80 detect a load in excess of the capacity of the cart 45, the weight sensors 80 detect an unbalanced load, the battery pack 120 is running low or needs recharging or a worker enters invalid destination coordinates into the key pad 170. The audible message can be a simple beeping, buzzing or siren sound, or a verbal message (such as “warning load capacity exceeded,” “warning unbalanced load,” “battery low,” “recharge battery” or “invalid destination coordinates”). The message is repeated until a corrective action is detected by the processor 102, the identified moving object (person) moves away or a worker acknowledges the receipt of the message via the key pad 170. The audio speaker 190 has a rear connection terminal for receiving electric power and sending and receiving communication signals. Although not shown, the external speaker 190 can be mounted inside of the RCP housing 51.

The RCP 40, navigation and movement system 42 and autonomous cart 45 are optionally equipped with a WiFi unit 195. The WiFi unit 195 is mounted inside a webbing compartment 24 on the upper tray 22 as shown in FIG. 7, and is in electrically connected via a USB cable for power and communication to the RCP 40 and its processor 102 via the circuitry 109 and input/output terminal 118 of the RCP drive unit 51. The WiFi unit 195 preferably has input power of 5 volts, an operating wavelength of about 2.4 to 5.8 gigahertz, and a transmission range of about 10 meters, such as an B07J65G9DD by Techkey.

A cable array 200 shown in FIG. 2 connects the exterior components of the RCP 40 and navigation and movement system 42 to the input/output terminals 110 of the RCP drive unit 50 circuitry 109. The cabled components include the weight sensors 80, battery 120, proximity sensors 150, safety lights 160, control panel 170, On/Off switch 175, emergency stop 180 button, “GO” button 185, audio speakers 190 and Wi Fi unit 195. As noted above, the LIDAR sensor 140 mounted atop the drive unit 50 can be directly wired to the drive unit circuitry 109 as in FIG. 3 or cabled through an input terminal 119 as in FIG. 5B. The cabled array 200 includes two lines 201 and 202 routed through the cart 20 as shown in FIGS. 2, 8 and 9 to connect the external components with their associated input/output terminals 111-119. One line 201 is routed along the rights side of the cart 20, and one line 202 is routed along the left side of the cart.

The right 201 and left 202 lines each include multiple and separate wire lines 205 for powering and communicating with two weight sensors 80, eight proximity sensors 150 and four safety lights 160. The right line 201 also includes separate wiring lines 205 for powering and communicating with the control panel 170, On/Off switch 175, emergency stop 180 button, “GO” button 185, audio speakers 190 and WiFi unit 195. The individual wires 206 at one end of each power and communication wiring line 205 for a specific external component are connected to a component-specific connection 210 that electrically connect its wires 206 to the terminal for that external component. The individual wires 206 at the other end of each wiring line 205 are connected to an input/output connector 215 that plugs into and electrically connects the wiring line with its appropriate input/output port 111-119 of the drive unit 50. The wiring lines 205 for the proximity sensors 150 in one line 201 or 202 share a common input/output connector 215. The individual wires 205 in the two lines 201 and 202 of the cabled array 200 are harnessed 209 together near the input/output ports 111-119 and joined to their appropriate terminal 215. The appropriate terminals 215 are then plugged into their appropriate input/output port 111-119. It should be understood that the lines of the cabled array 200 can be divided into four lines 201-204 as shown in FIG. 3, with one line being routed through the internal channel 26 of each of the four risers 25.

When the RCP 40 is turned on via switch 175, electric power from the battery 120 is supplied to the RCP 40 and navigation and movement system 42, which includes circuit boards and internal components 91, 92, 97-99, 101-109 and 135 as well as external components 80, 140, 150, 160, 170, 175, 180, 185, 190 and 195 via cabled array 200. When the RCP 40 is turned off, electric power from the battery 120 to the RCP 40 and its navigation and movement system 42 are turned off, except for the encoders 91 and 92, MCU 106 and DRAM 107 which remain powered by the backup circuit 130 as discussed above. When the RCP processor 102 detects that the power or charge remaining in the battery 120 is running low or meets a predetermined charge threshold value, the processor plans a route to a recharging station 259 (FIG. 13) and navigates the cart 45 to the recharging station. A worker then connects the battery 120 to a power outlet at recharging station 259 to recharge the battery, or swaps out the battery with an already charged battery at the work station.

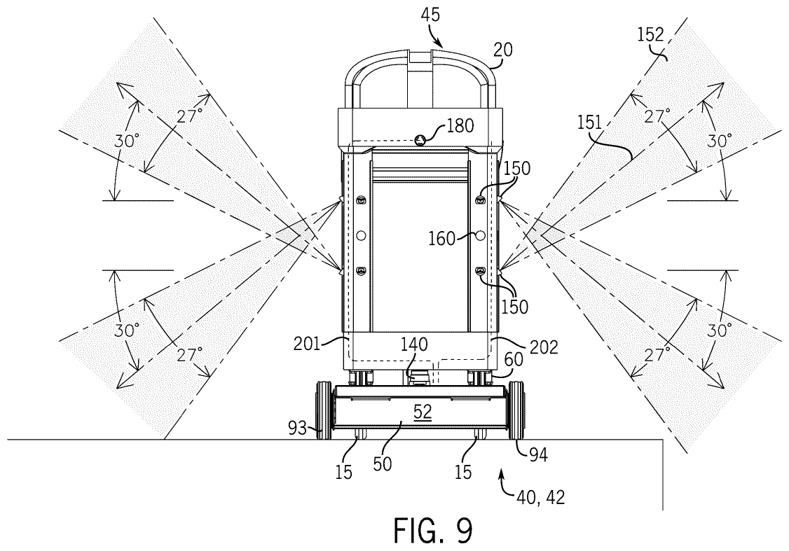

Modifications are made to the conventional carts 20, 30 to integrate the RCP 40 and form the autonomous cart 45. The front caster wheel assemblies 14 are removed and replaced with the RCP drive unit 50. For the conventional plastic cart 20, four riser channel cover plates 241 are secured inside each riser 25 to enclose the inner channel 26 and house and protect the proximity sensors 150, lights 160 and cable lines 201 and 202 inside these channels. A tray cover plate 242 is secured to the bottom of the upper tray 22 to house and protect the audio speaker 190, WiFi device 195 inside the webbing chambers 24 of the upper tray, as well as the cable lines 201 and 202 extending through the walls forming it matrix of webbing chambers. Cabling holes 243 are formed in the corners of the flat tray surface 6 of the lower tray 21. A first line of web holes 244 is formed in the structural webbing 23 of the lower tray 21 to route the cables 201 and 202 in a supported manner from the rear of the RCP drive unit 50 to the front of the lower tray, as best shown in FIGS. 8 and 9.

The right and left lines 201 and 202 diverge and passes through a second line of web holes 244 along the front 2a of the lower tray 21 to the front corners 4 of the tray. The lines 201 and 202 pass through their respective holes 243 in the lower tray 21 and extend up their respective riser channel 26. Third and fourth lines of web holes 244 are formed along the sides 2c of the in the upper tray 22 to allow the right and left lines 201 and 202 to extend in a supported manner along the right and left tray sides to the rear 2b of the tray just above the rear riser channels 26. The lines 201 and 202 extend downward through these channels and pass through the tray holes to reach the two weight sensors 80 at the rear of the cart. Web holes 244 are also formed along the front of the of the upper tray 22 to allow one cable 201 to reach the emergency stop button 180 mounted in an emergency stop button opening 245 formed in the center of the front of the upper tray. Web holes 244 are also formed along the rear of the upper tray 22 to allow a cable line 201 to reach the battery 120, control panel 170, On/Off switch 175 and “Go” button 185, mounted in a GO button opening 249 formed in the center of the utility tray 28. For the conventional metal cart 30 with wire baskets 31-33, riser holes 249 are formed proximal the top and bottom ends of the tubular risers 35 to allow cable wiring to extend from the lower tray to the upper tray in a protected manner.

The RCP 40 uses its WiFi unit 195 to communicate with a separate work station 250 shown in FIG. 13. The conventional work station 250 has a computer processor 252, keyboard input device 254 and monitor 255. The work station processor 252 acts as a server or SRCP for the cart 45. The RCP 40 transmits a variety of data or information to the workstation SRCP 250. For example, environment map data, current or real-time RCP/cart location data and selected desired destination data in the RCP memory 103 is transmitted via the WiFi device 195 to the SRCP 250. The SRCP 250 processes this data for visual display on its monitor 255 as shown in FIG. 14. The monitor 255 visually displays a screen showing an environment map 260′ derived from the environmental map data in the RCP 40. The map 260′ shows open areas 261′ of the building through which the cart 45 can travel, fixed structures 262′ in the building, a real-time RCP location marker (triangle) 263 (the marker being the visual representation of current location data) identifying the current physical location 100 of the RCP 40 and listed destination markers (arrows) 264 presently stored in the RCP memory 103.

The computer screen of the monitor 255 also shows a list of the coordinates 265 for each listed destination. The screen provides touch screen buttons 266 and 267 to add destinations to or delete destinations from the RCP memory 103. New destination coordinates are entered via the keyboard 254. The SRCP 250 and its touch screen buttons are operable to remotely select a specific destination for the cart 45 to travel next. Then a visually displayed “GO” button 268 on the screen of the SRCP monitor 255 is pressed to remotely control the RCP 40 and send the cart 45 to that selected destination. The SRCP monitor 255 screen also visually displays a touchable joystick 269 to remotely control the operation of the RCP 40 and movement of the cart 45.

When multiple autonomous carts 45 are used, the SRCP 250 communicates with each of them. Mapping data from various carts 45 is combined to form a global map 260′ of the working environment 260 in the SRCP memories 103, which is displayed on the SRCP monitor 255 along with the current locations 100 of each cart. Data containing the master or global map of the SRCP 250 is transmitted to the memory 103 of each RCP cart 45, so that each cart learns from the other carts.

An alternate embodiment of the mounting assembly 60 is shown in FIGS. 16A and 16B. In this embodiment, the mounting assembly 60 takes the form of two mounting blocks 361 and 362 secured to the top 54 of the drive unit housing 50. Each block 361 and 362 has a base portion 363 and two spaced columns 364. The right block 361 is located near the front 52 right 56 corner of the drive unit 50. The left block 362 is located near the front 52 left 57 corner of the drive unit 50. The bottom surface of each block 361 and 362 is flush with the top 54 of the drive unit 50. Each block 361 and 362 is secured to the drive unit 50 by two threaded forward fasteners 365a. These forward fasteners 365a pass through an opening in the top 54 of the housing 51 as well as holes in the base portions 363 and front columns 364 of the blocks 361 and 362, and are received by and secured to threaded holes 367a in its mounting plate 366. The columns 364 open up as much space as possible for the LIDAR scanner so as not to obstruct the LIDAR scanning plane. The rear spacers 61 can also take the form of blocks 361 and 362 with columns 364. As the rear spacers are a further distance from the LIDAR scanner 140, the effect on the scanning plane is less significant.

Each block 361 and 362 also has two rearward fasteners 365b to help secure the mounting plate 366 to its mounting block 361 or 362. The heads of these rearward fasteners 365b are received in recesses 368 in the bottom surface of the blocks 361 and 362. These rearward fasteners 365b also pass through holes in the base portions 363 and rear columns 364 of the blocks 361 and 362, and are received by and secured to threaded holes 367b in its mounting plate 366 to help secure the mounting plates to the drive unit 50. As with mounting assembly 60, threaded fasteners 19 are used to secure the mounting plates 366 to the support structure 8, 8a of the cart 20. The shafts 19a of these fasteners 19 pass through holes or fastener openings around the perimeter portion of the mounting plates 366, which are aligned with the fastener holes 8a of the cart mounting structure 8. Again, as with mounting assembly 60 shown in FIGS. 2-4, weight sensor assemblies 70 are held between the mounting plates 366 and the cart mounting structure 8. Each of the inverted crowns 79 of the four sensor plates 71 ride on the central area of their associate mounting plate 366 with a gap 89 between the perimeter portions 72 and 366 of the plates 71 and 366. The weight of the cart 45 above the mounting brackets 366 is supported by the four crowns 79 riding on the centers 366c of the mounting plates 366. The threaded fasteners 19 are non weight load-bearing so that the necks 77 of the sensor plates 71 flex when an item or load is placed on the cart 45, with the fasteners 19 moving down to form gaps 89a between the fastener heads 19b and the mounting plates 366. The base portions 363 have a V-shaped groove 369 to secure the right and left cable lines 201 and 202 and keep them from obstructing the view of the LIDAR scanner 140.

### Second Embodiment of Robotic Cart Platform 440, Navigation and Movement System 442 and Autonomous Cart 445

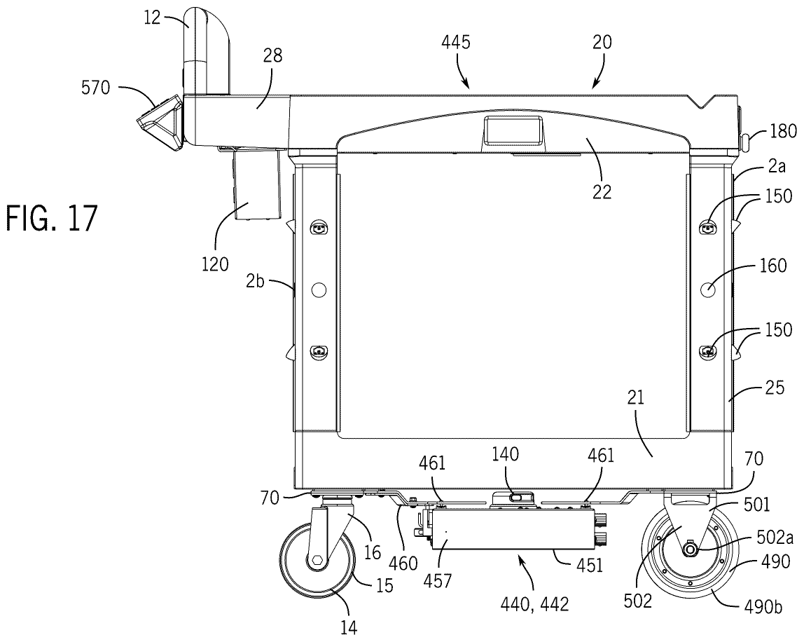

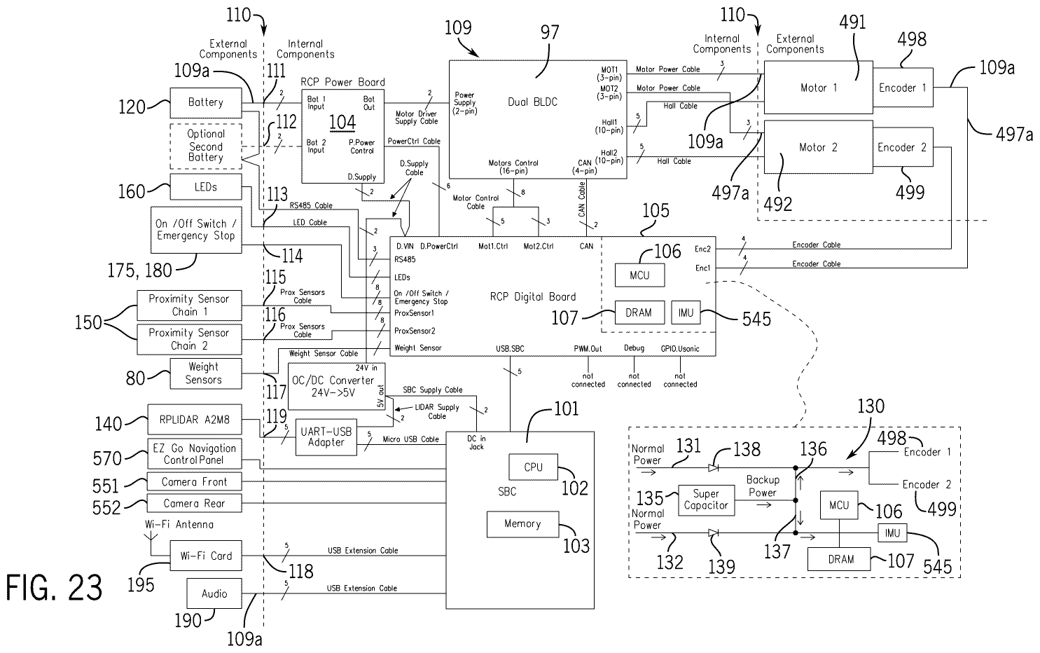

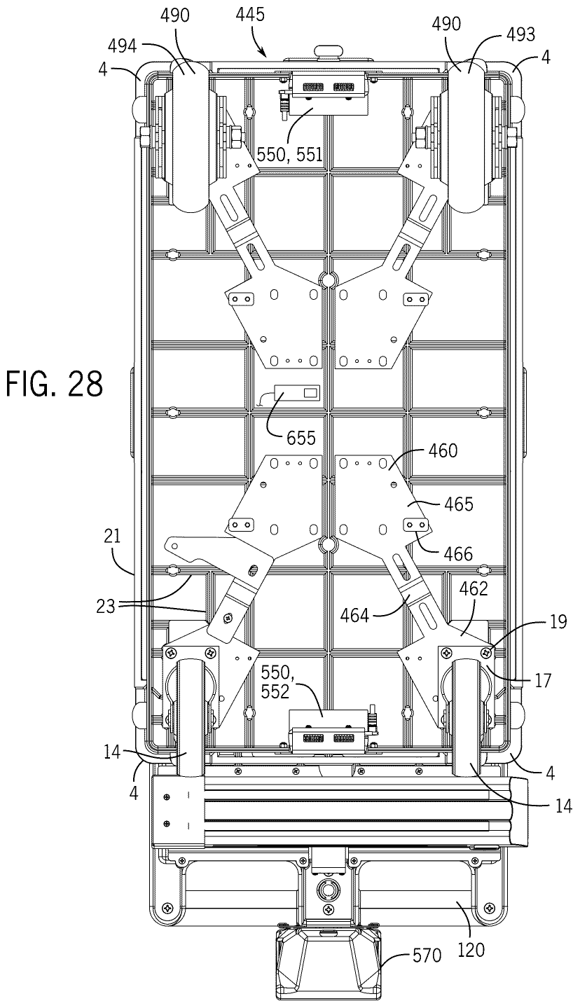

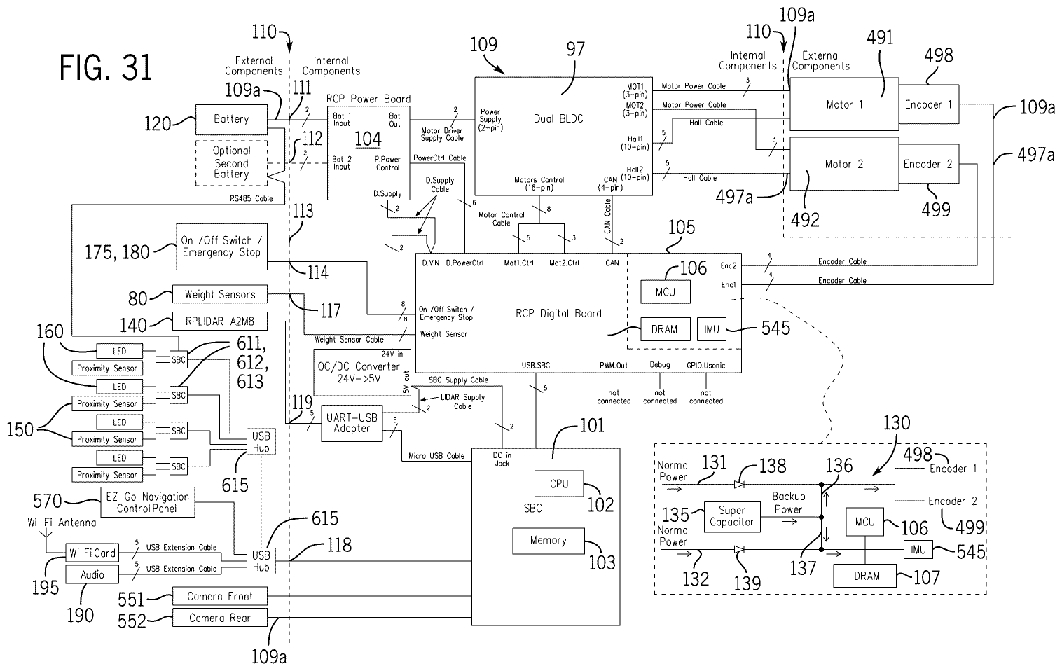

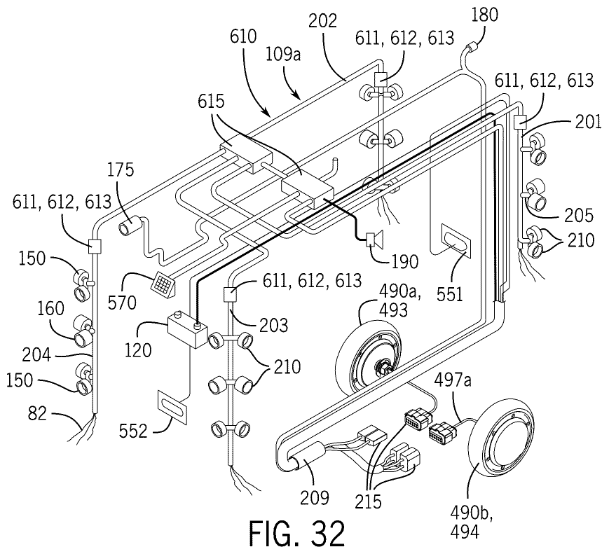

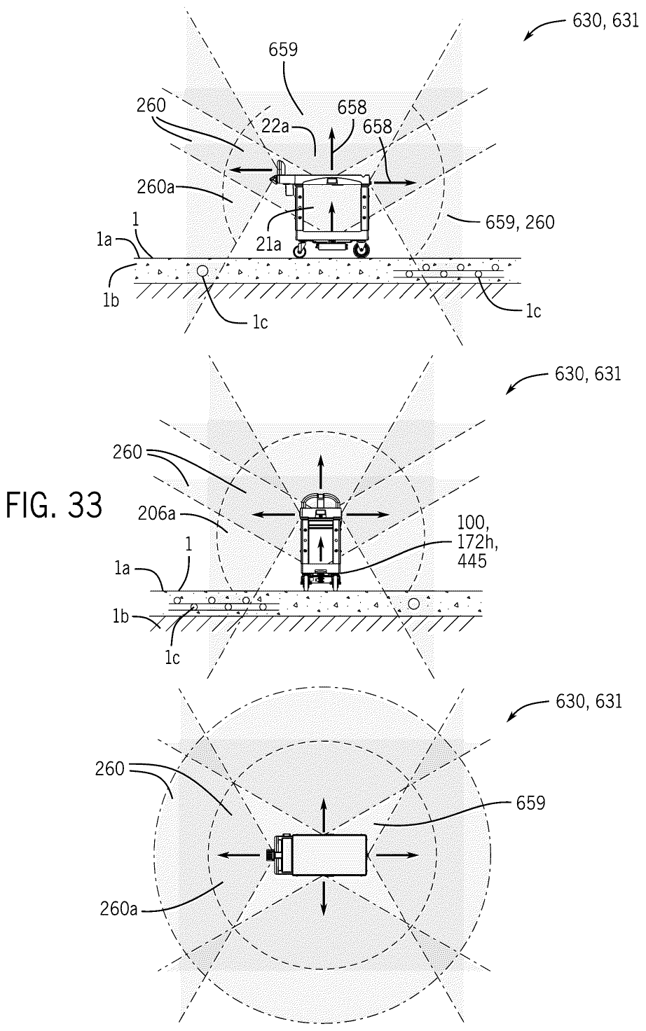

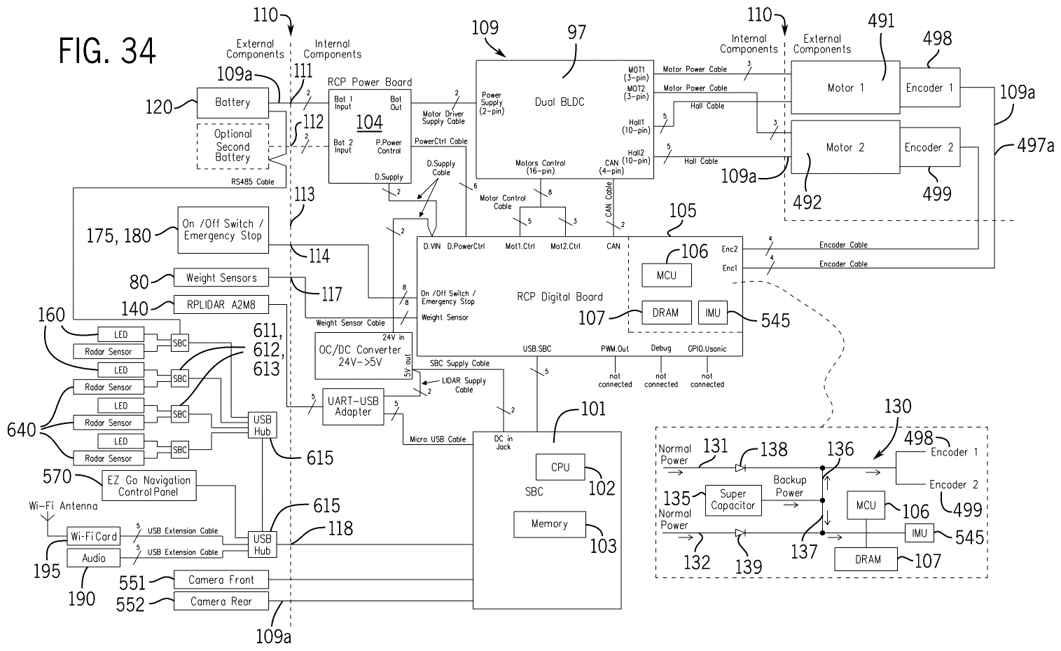

A second embodiment of the robotic cart platform 440, navigation and movement system 442 and autonomous cart 445 are shown in FIGS. 17-30, with an alternate cabling 610 version shown in FIGS. 31-32 and a radar sensor 640 version shown in FIGS. 33-35 as discussed below. The structure of the cart 2 is similar to the first embodiment, and can take the form of either the plastic 20 or metal 30 cart. The robotic cart platform or RCP 440, navigation and movement system 442 and autonomous cart 445 have many of the same components as in the previous embodiment, such as its internal housing components (e.g., circuit boards 101, 104 and 105, processors 102 and 106, memory 103 and 107, circuitry ports 110, backup power circuit 130) and external components (e.g., weight sensors 80, battery 120, LIDAR sensor 140, proximity sensors 150, LED lights 160, ON/OFF switch 175, emergency stop bottoms 180, audio speaker 190, WiFi communication device 195). Still, the second embodiment has various modifications, such as a low-profile housing 451, housing mounting assembly 460, external drive wheel assemblies 490, EZ Go Navigation panel 570 with fifteen keys 171, IMU 545 and front and rear depth cameras 550.

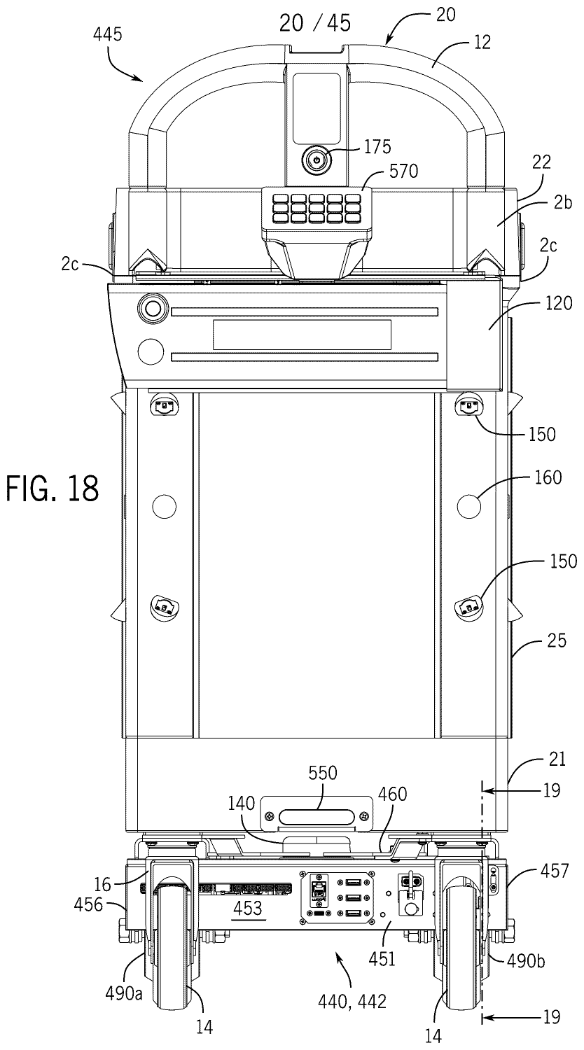

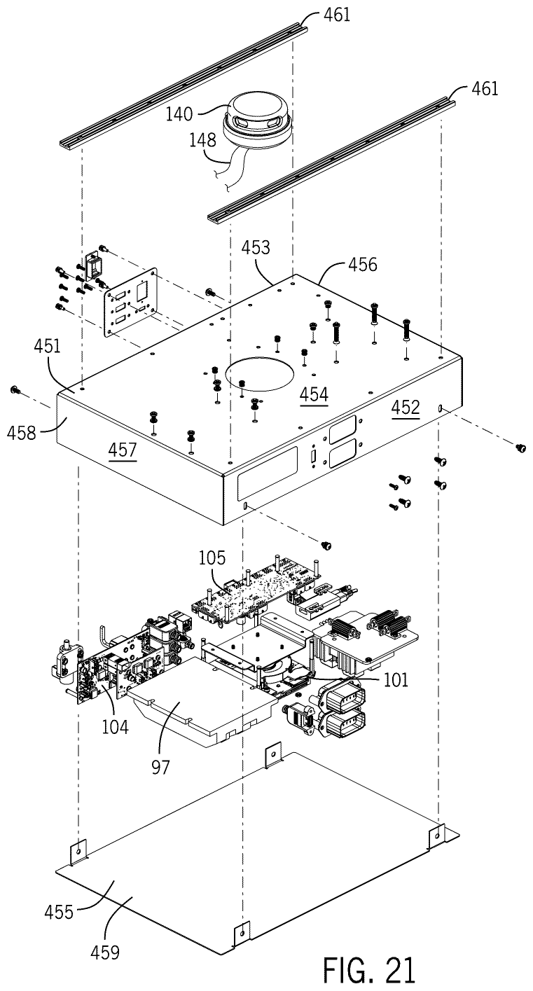

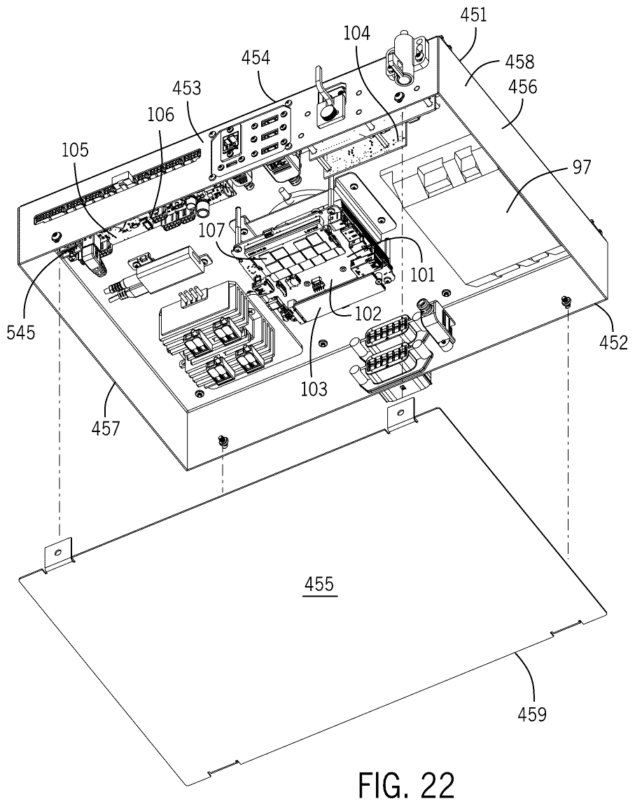

The low-profile housing 451 is robustly designed to maintain its shape during use, and has a generally rectangular box shape construction that is wider than it is tall as seen in FIGS. 21 and 22. The RPC housing 451 has length of about 11 inches, a width of about 17 inches and a height of about 3 inches. The housing 451 fits a wide variety of conventional cart 2 dimensions, and is mounted to the underside of the lower tray 21, 31 as shown in FIGS. 17 and 18. The housing 451 is preferably formed from plate steel, and includes shorter front, rear and right and left side walls 452, 453, 456 and 457 to provide about 2.8 inch (7.1 cm) of clearance between bottom wall 455 and level ground 1a. The low-profile housing 451 construction is possible given the external placement of the drive motors 491 and 492. The top and bottom portions 458 and 459 of the housing 451 are joined together to enclose and protect the RPC electrical circuit 109 and components inside the housing. The LIDAR sensor 140 is mounted to the housing top 454, and the housing 451 includes a LIDAR sensor input/output opening. When securely mounted to the cart 445, the housing 451 is centrally located between the sides 2c and front and rear ends 2a and 2b of the cart 445. The housing sides 456 and 457 are generally parallel to and located inwardly from the cart sides 2c. The front and rear housing walls 452 and 453 are generally parallel to and located inwardly from both the front and rear cart ends 2a and 2b, respectively.

The housing mounting assembly 460 selectively and slidingly receives, positions and secures the housing 451 to the underside of the lower tray 21. The assembly 460 includes two metal slide rails 461 that are bolted, screwed or otherwise rigidly secured to the housing top 454 as best shown in FIG. 21. The side rails 461 are spaced apart and parallel to the housing front and rear ends 452 and 453. Each rail 461 spans the width of the housing or from side 452 to side 457. When secured to the cart 445, the rails 461 are parallel to the front and rear ends 2a and 2b of the cart 45.

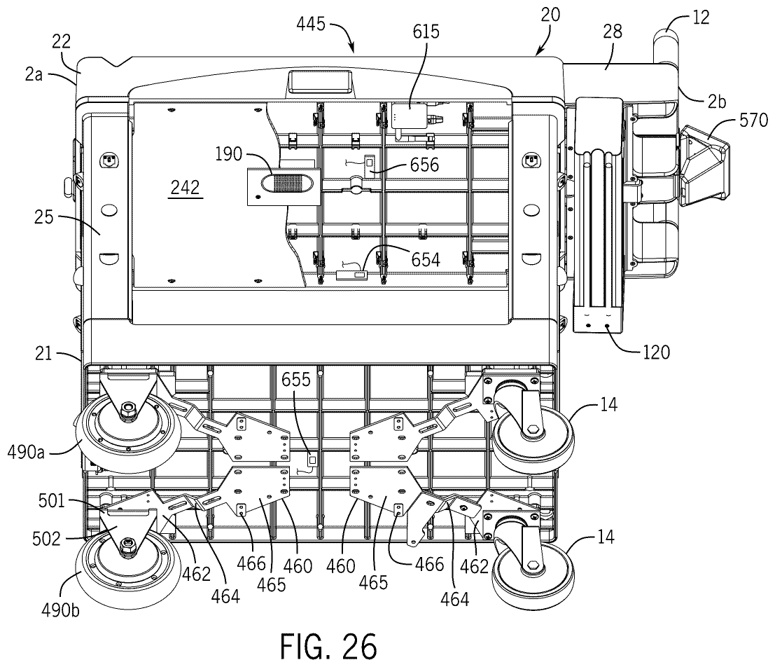

The housing mounting assembly 460 includes four mounting plates 462 rigidly secured to the webbing 23 on the underside of the lower tray 21 as shown in FIG. 26. Each mounting plate 462 is located in one of the four quadrants of the rectangular-shaped lower cart tray 21, and extends from one of the four corners 4 of the cart 445 toward the middle of the lower tray. Each plate 462 has a flat corner section 463, a staggered central section 464 and a flat inner section 465. These sections 463-465 are preferably integrally formed to maintain their shape and the shape of the mounting structure 462. Each flat corner section 463 abuts and is bolted, screwed or otherwise rigidly secured to the webbing 23 proximal the corner 4 of the lower tray 21. The staggered section 464 angles toward the middle of the cart 445, and firmly joins the flat inner and outer sections 463 and 465. The inner end of the staggered middle section 464 drops down a desired amount to provide clearance for the LIDAR sensor 140.

The four flat inner sections 465 are in planar alignment and are generally parallel to and spaced from the underside of the lower cart tray 21. Each inner section 465 is located at the inner portion of its quadrant, so that the sections 465 are positioned at or proximal the middle of the lower tray 21. Each section 465 has a downwardly extending securement bar 466 shaped to selectively and slidingly receive, and firmly hold one of the slide rails 461 secured to the housing 451. The forward slide rail 461 is slidingly held by the two forward 2a housing mounting plate assemblies 460. The rearward slide rail 461 is held by the two rearward 2b housing mounting plates 462. Mounting the RCP housing 451 on rails 461 allows for quicker and easier servicing of the RCP 440. When the external components are disconnected from the RCP housing ports 110, the components and circuitry in the housing 451 are easily removed and swapped out with a replacement RPC housing and its internal components and circuitry.

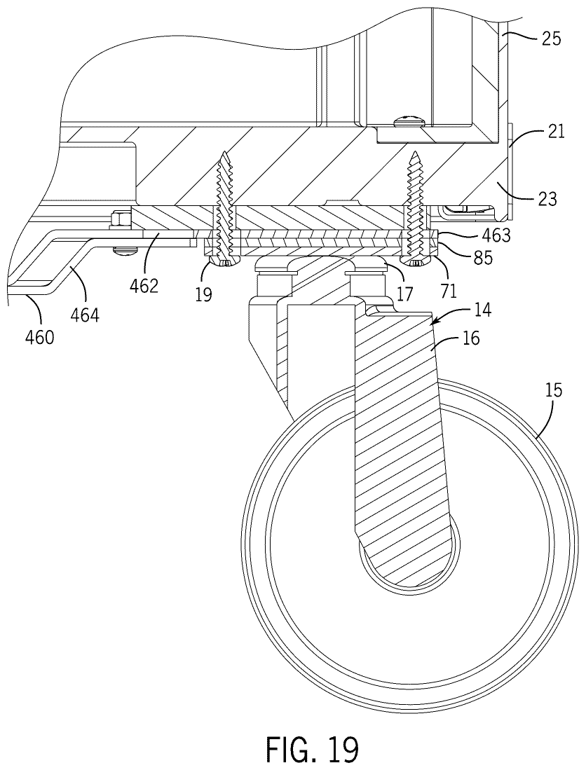

The two conventional caster wheel assemblies 14 mounted at the front 2a of the cart 445 secure the two forward mounting plates 462 to the cart 20 as shown in FIG. 19. The mounting bracket 17 of each caster wheel assembly 14 is in parallel engagement with its respective flat corner mounting section 463. The caster wheel fasteners 18 pass through aligned holes in the mounting plate 17 and its mated corner section 463 to rigidly secure them both to the webbing 23 on the underside of the lower tray 21. A weight sensor plate 71 and its spacer plate 85 are preferably placed between the mounting bracket 17 and the corner section 463. When installed, the upper and lower surfaces of these plates 17, 71, 85 and 463 are in generally flush engaged parallel alignment.

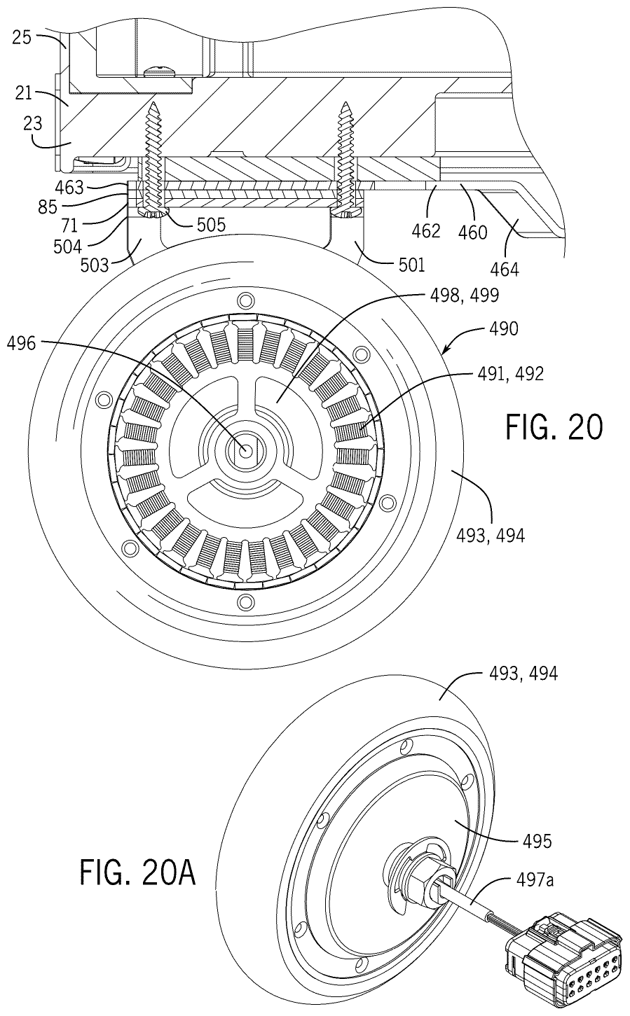

The drive wheel assemblies 490 are mounted external to the housing 451. The right drive wheel assembly 490a is mounted at the front 2a right corner 4 of the cart 445, and the left drive wheel assembly 490b is mounted at the front left corner of the cart. Similar to the first embodiment, the right assembly 490a includes a drive motor 491, drive wheel 493 and encoder 498, and the left assembly 490b includes a drive motor 492, drive wheel 494 and encoder 499 as shown in FIG. 20. Each wheel 493 and 494 includes a hub 495 and a drive shaft or axil 496. Each dive motor 491, 492 has external power and control wires 109a, 497a routed to the circuitry 109 inside the housing 451. (FIG. 20A). The drive motors 491, 492 are electric DC brushless servo hub motors. Each drive wheel assembly 490 provides a rated torque of 6.5 Newton-meters (N-m), maximum torque of 13 N-m, rated voltage of 24V DC, 150 Watts of power, 4 amps of phase current, rated speed of 200 rotations per minute (rpm), maximum speed of 260 rpm and suggested load of 265 pounds (120 kilograms). The drive wheel 493, 494 of each assembly 490 has a diameter of about 6.5 inches (17 cm).

Similar to the first embodiment, each motor 491 and 492 is interfaced to its associated “always-on” encoder 498 and 499. Each encoder 498 and 499 has a rotary disk and an output cable 497a. Each rotary disk is mounted to its respective motor 491 or 492 to optically view the rotational movements of its associated motor drive shaft 496, and thus the rotational movements of its associated wheel 493 or 494. The rotary disk transmits this shaft rotational movement data or information via its output cable 497a to the microcontroller 106 and its short-term memory 107, which is then periodically transmitted to the RCP processer 102 and its long-term memory 103. As with the first embodiment, this shaft rotation or wheel movement data is used by the RCP processor 102 to determine the distance of travel and path of travel taken by the RCP 440 and autonomous cart 445 from its start location or start location coordinates, and to determine the coordinates or coordinated data associated with the current physical location 100 of the RCP 440 and cart 445. The motors 491, 492 are interfaced to the associated dual motor controller 97 located inside the housing 451. The rotational speed and direction (clockwise or counterclockwise) of each output shaft 496 is controlled by the controller 97, which is in electrical communication with motor 491 or 492 and controls the electric power supplied to each motor. The controlled power supply to each motor 491 or 492 via the motor controller 97 controls the speed of drive shaft 496 of each motor, and thus the rotational speed of the drive wheels 493 and 494.

Each drive wheel assembly 490 is rigidly secured to the cart 445 by a drive wheel mount 501. Each drive wheel mount 501 has two opposed downwardly extending legs 502 that straddle the drive wheel 493 or 494. Each leg 502 has an opening 502a at its lower end to receive and firmly secure the drive shaft 496 (FIGS. 17 and 18) while allowing rotation of the drive shaft 496 and its wheel 493 or 494. Each wheel mount 501 has four spaced apart upwardly extending arms 503 that are rigidly secured to the webbing 23 on the underside of the lower tray 21. Mounting the drive wheels 493 and 494 externally from housing 451 allows the drive wheels to rotate more freely than in the first embodiment, which in turn conserves power consumption and increases battery 120 life.

The two drive wheel assemblies 490a and 490b at the front 2a of the cart 445 secure the two forward mounting plates 462 to the cart 20. The wheel mount 501 engages its respective flat corner section 463 as shown in FIG. 20. Wheel mount fasteners 505 pass through aligned holes in its mated corner section 463 to rigidly secure them both to the webbing 23 on the underside of the lower cart tray 21. A weight sensor plate 71 and its spacer plate 85 are preferably placed between the flat upper ends 504 of the arms 503 and the corner section 463. When installed, these flat upper ends 504 and the upper and lower surfaces of plates 71, 85 and 463 are in flush engaged parallel alignment.

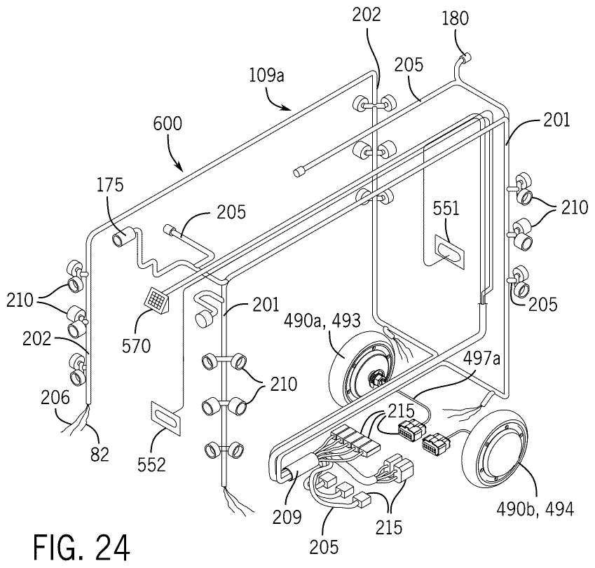

As noted above, the first and second embodiments of the RCPs 40, 440, navigation and control system 42, 442 and autonomous carts 45, 445 have circuit boards 97, 101, 104, 105, processors 102 and 106, memory 103 and 107 and circuitry 109. (See FIGS. 21-23). In the second embodiment, the digital board 105 of the RCP 440 also includes an internal measurement unit (IMU) 545. The IMU 545 obtains three axes (X, Y and Z) of angular rate sensing (i.e., attitude, orientation, position) and three axes (X, Y and Z) of acceleration for the RCP 440 and cart 445. Velocities (i.e., cart movement data) are then calculated utilizing the measured accelerations and angular rates over time. Linear and angular distances traveled are not directly calculated from the IMU information, but are calculated from the previously calculated velocities. Once the linear and angular distances traveled are determined by the IMU 545, the position and orientation 100 of the cart 445 are obtained by summing up those traveled distances. The information (e.g., cart location data and cart movement data) gathered by the IMU 545 is combined with the drive wheel encoder 98, 99 information (e.g., cart location data and cart movement data) in a customized manner. The cabling 600 for the second embodiment is shown in FIG. 24. The circuitry 109 and cabling 600 are essentially the same as the first embodiment, except for the addition of an IMU 545 and some additional external wiring 109a, 497a for the drive wheels motors 491, 492, encoders 498, 499, cameras 550 and EZ Go Navigation 570, and the removal of “Go” button 185.

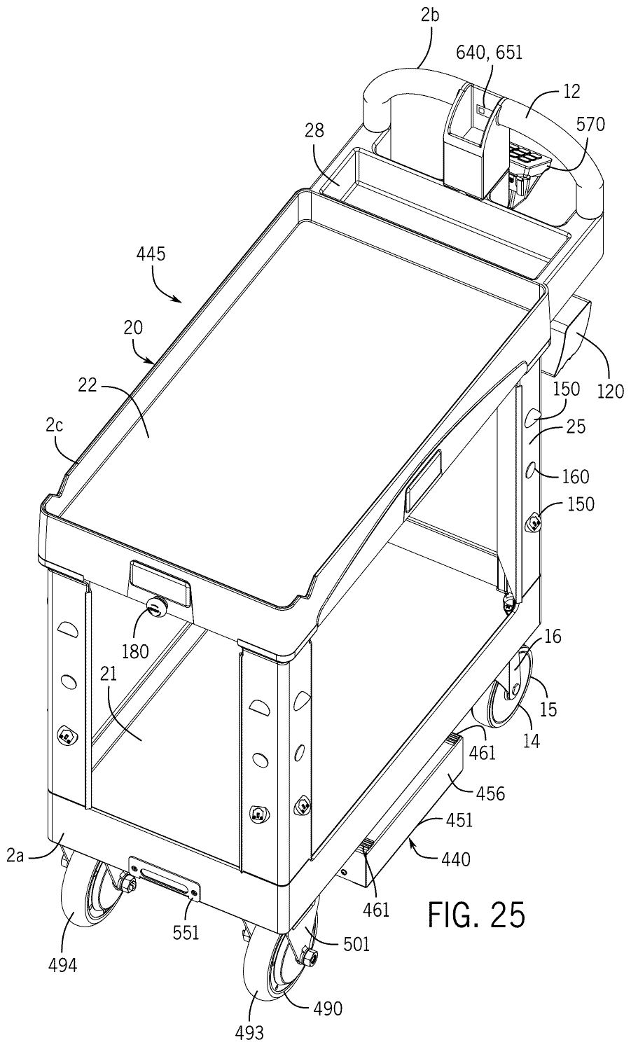

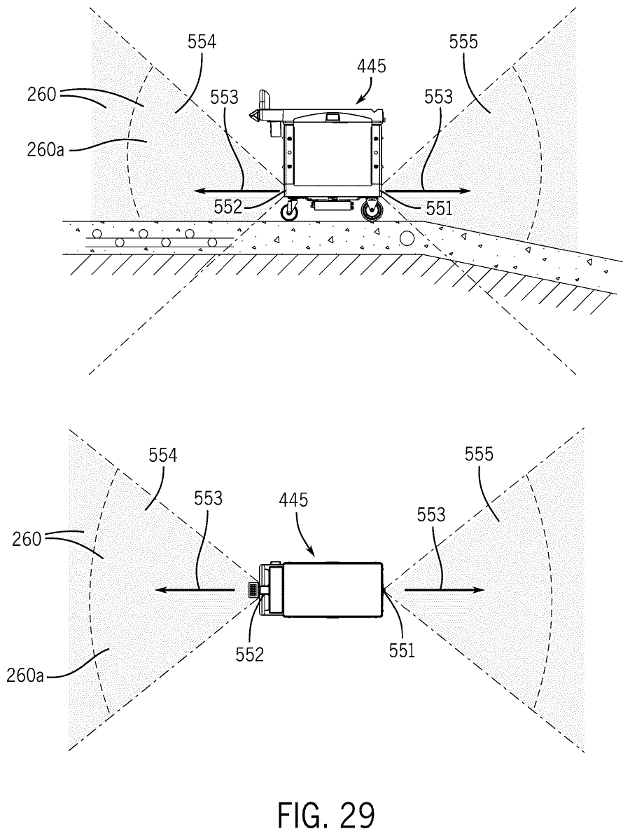

The cart 445 has two conventional high resolution, 3D depth or digital cameras 550 for viewing or sensing the working environment 260 as shown in FIGS. 25-29. It should be noted that the working or global environment 260 includes a local environment 260a around the cart 445, which is a region extending about three meters around the car 445, but this distance can vary. Each digital camera 551 and 552 has its own electronic device (e.g., processor and circuitry) and captures photographs in its own digital memory. The processor of each camera 550 processes image data and retains that image data as digital images in its memory. The cameras 550 then sends or outputs its depth map data (i.e., environmental mapping data and object movement data for temporary objects 262a) and raw images to the RCP processors 102, 106 and memory 103, 107 of RCP 440. A forward-facing camera 551 is mounted to the front 2a of the cart 445 proximal the lower tray 21. The forward camera 551 has an aimed direction 553 that is forwardly facing to provide a forward scanning view or cone 554 as shown in FIG. 29. Similarly, a rearward-facing camera 552 is mounted on the rear 2b of the cart 445 proximal the lower tray 21. This camera 552 has an aimed direction 553 that is rearwardly facing to provide a rearward scanning view or cone 555. The viewing or scanning cones 554 and 555 for the cameras 551 and 552. The aimed direction 553 of both cameras 550 is directly forward and rearward and is planar to the ground surface 1a under the cart 445, which allows the cameras 550 to view objects above the cart 445, and view when the cart 445 is about to travel onto a downwardly sloping ramp, or when the cart is traveling on a floor surface near a drop off, such as by a loading bay or stairs. Similar to the LIDAR sensor 140, the environmental mapping data of the cameras 550 includes both global or working environmental data 260′ and local environment data 260a′.

Each camera 550 has right and left imagers, an IR projector and an RBG module. They are lightweight and suitable for indoor and outdoor use. Each camera 550 has length, depth and height dimensions of 90 mm, 25 mm and 25 mm, respectively. The cameras 550 have a wide field of view (FOV) and global shutter sensor for robotic navigation and object recognition. The global shutter sensors provide great low-light sensitivity to allow cart 445 to navigate spaces with the lights off. The cameras 550 have stereoscopic depth technology, global shutter image sensor technology, an ideal range of one to ten feet, depth FOV of 87°×58°, depth output resolution of 1280×720, depth accuracy of less than 2%, RBG frame resolution of 1920×1080, frame rate of 30 fps, sensor FOV (H×V) of 69°×42° and sensor resolution of 2MP and USB-C 3.1 Gen 1 connectors. The environmental mapping data from the cameras 550 combine with the data from the LIDAR sensor 140 in the RCP processors 102 and 104 to produce a three hundred and sixty degree (360°) map 260′ of the surrounding environment 260. (See FIGS. 10, 29 and 36-37). While the data from the proximity sensors 150 can be combined with this environmental mapping data to form the RCP map 260′, in the present embodiment, the proximity sensors data is used for object avoidance.

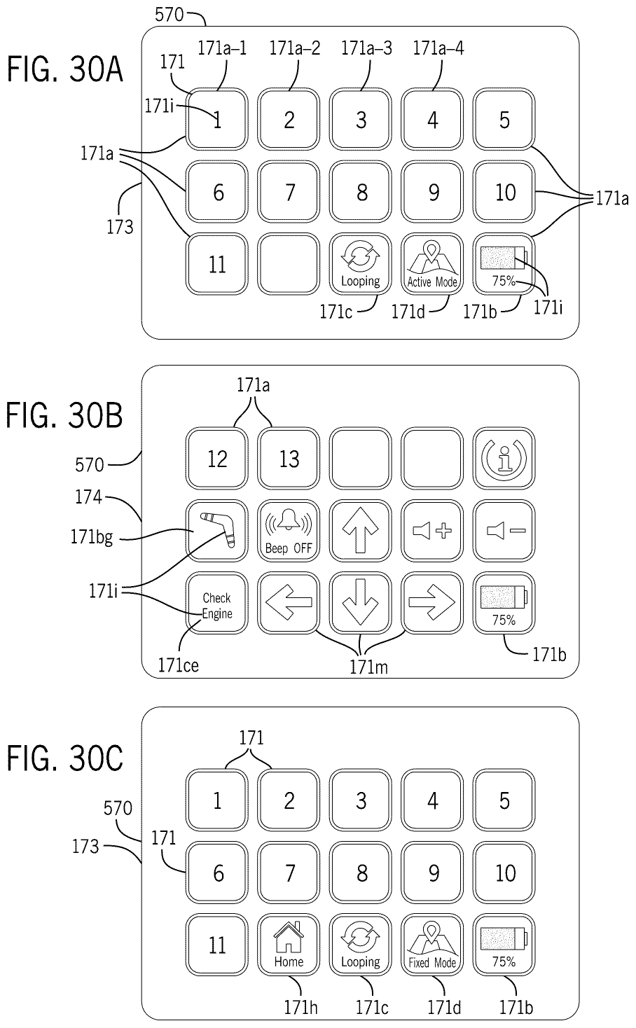

The EZ Go Navigation control panel 570 is shown in FIGS. 18 and 30A-C. The Control panel 570 has fifteen keys 171. Similar to the 6-key panel, each individual key 171 is programmed to display its own individual icon image, gif image and/or text image 171i. Behind each key 171 is an integrated graphical color display for bright clear identification, and its 15-key input device has customizable LCD keys 171 and a microprocessor with nonpermanent rapid access memory, and is capable of displaying custom icons, animated gifs and or text messages. Each key 171 has a surface that is touched or pressed to operate the key, although other activation mechanisms to physically operate the key are possible. Each key 171 also has a tap-to-switch scene to launch various custom programmed capabilities.

The control panel or communication device 570 is secured to the utility tray 28 similar to panel 170, and has a connection that receives a USB cable to provide electric power from the battery as well as send and receive signals, or otherwise communicate with RPC 440, navigation and movement system 442, processors 102, 106 and memory 103, 107. The RCP memory 103 is loaded with sets of icons 173 and 174 to selectively display on the fifteen control keys 171. As with panel 170, one set of icons 173 or 174 is displayed at a time on the keys 171 for panel 570. (FIGS. 30A and 30B). Switching from one set of icons 173 to the other 174 is performed the same as with the 6-key panel 170. Similarly, when a key 171 is pressed when displaying a particular icon image 171i, the control panel 570 sends a recognized instruction signal or command associated with that icon image being displayed by the key 171 to the RCP processor 102, which then uses the navigation and control system 442 to perform the particular navigation and movement operations necessary to complete that command.

The control panel 570 has thirteen destination keys 171a to store destination coordinates 265 (e.g., X, Y coordinates 264-1, 264-2, 264-3, 264-4, etc.) for up to thirteen physical destinations 172. Eleven destination keys 171a are shown in the first set of icons 173 (FIG. 30A) and two are shown in the second set of icons 174. (FIG. 30B). Similar to panel 170, each destination key 171a (e.g., 171a-1, 171a-2, 171a-3, . . . 171a-13) can be set to a specific destination 172 (e.g., 172-1, 172-2, 172-3, . . . 172-13). These keys 171a do not all have to be set to a destination 172. Unset or unused destination keys 171a are considered dormant by the RCP 440 and its cart 445 memory 103. Similar to panel 170 (FIG. 15B), the second icon screen 174 for panel 570 (FIG. 30B), includes a set of arrow or movement icons keys 171m that operate in the same manner as discussed above in for panel 170. These movement keys 171m allow a worker to use the RCP drive motors 91 and 92 to move the cart or vehicle 445 in a self-propelled manner as they walk behind the cart. While the description and figures show a working environment 260 on a single floor or level, it should be understood that the working environment can have multiple levels with the cart 45, 445 traveling up and down ramps or elevators to each level, and the destination coordinates 265 will include X, Y, and Z coordinates.

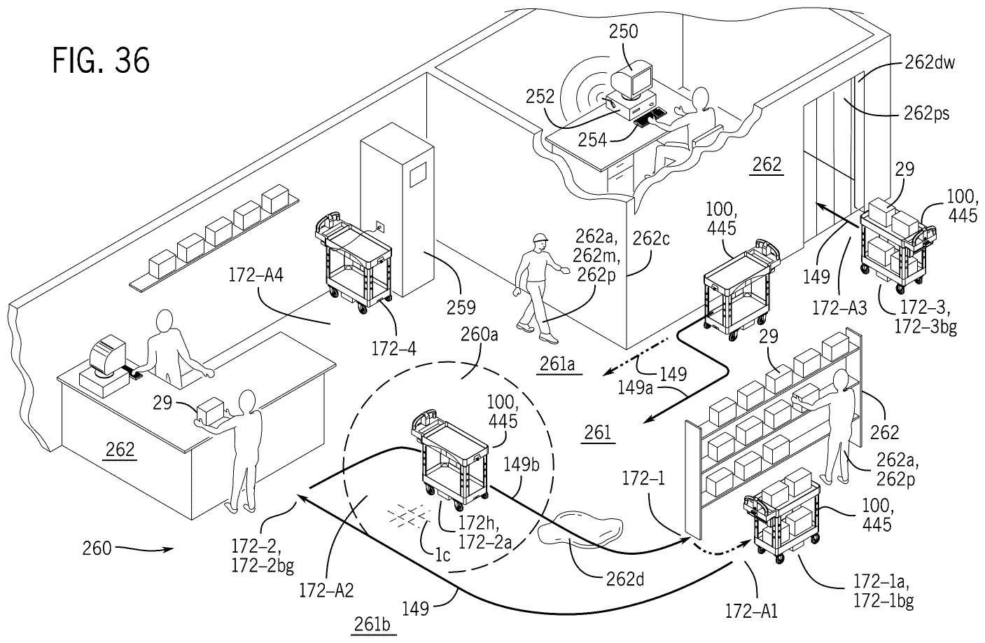

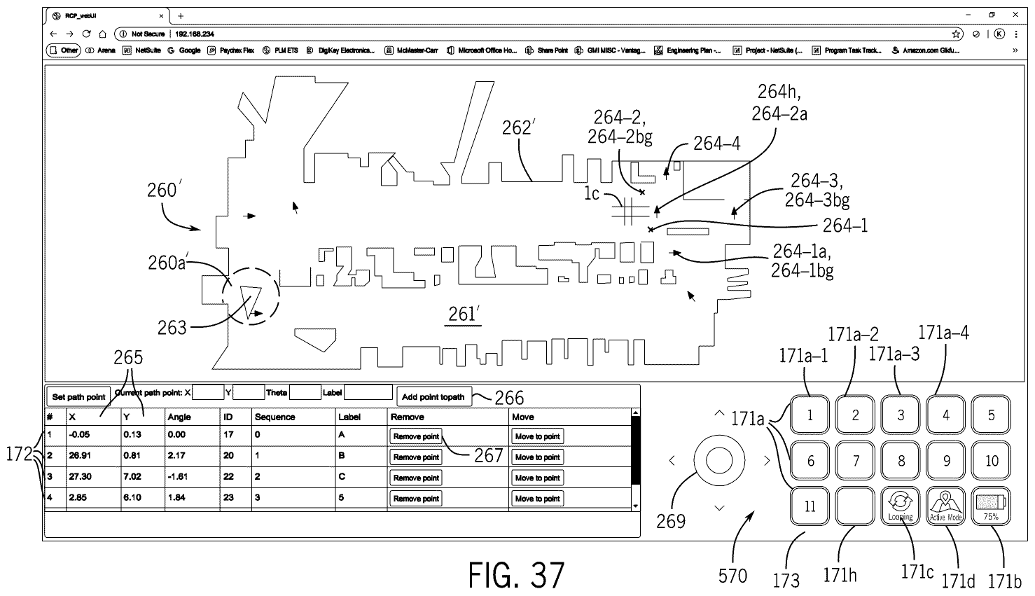

Cart destinations 172 are easily set using the destination keys 171a. When the cart 445 is pushed to a specific location or destination 172 (e.g., location 172 number “2” or 172-2, see FIG. 36) and one of these keys 171a is pushed (e.g., key 171a number “2” or 171a-2 in FIG. 30A) for a designated duration, such as six seconds, that location (e.g., X, Y, Z coordinates for location 172-2) becomes a known destination 264 (e.g., map destination coordinates 264-2, see FIG. 37) by the RCP 440 and autonomous cart 445. Then, when that destination key 171a-2 is pushed again at a later time, the cart 445 autonomously navigates to that designated location 172-2. For example, in FIGS. 36 and 37, destination keys 171a-1, 171a-2 and 171a-3 are set to corresponding destinations 172-1, 172-2, 172-3 and saved or stored as corresponding map destination locations 264-1, 264-2, 264-3 in cart memory 103. When any one of these keys 171a-1, 171a-2 or 171a-3 is pressed again, the cart 445 will determine a route 149 through the open areas 261 of the working environment 260, and navigate and travel to the selected destination 172-1, 172-2 or 172-3. As should be apparent from the above, the term navigate should be understood to mean that the navigation and movement system 42, 442 allows the cart 45, 445 to continuously determine its location 100, 263 in the working and mapped environment 260, 260′ and avoid fixed structures 262 and temporary obstacles 262a as the cart autonomously travels along a route 149 or an adjusted route 149a to a destination 172.

The 15-key panel 570 also has several specialty or function keys, such as a Battery key 171b, Looping key 171c, Set Map key 171d, Home key 171h, Boomerang key 171bg and Check Engine key 171ce. The Battery key 171b displays the battery status (e.g., charge level). The Check Engine key 171ce notifies the worker of any cart running abnormalities, and will flash a code to identify the specific cart operating abnormality detected by the RCP 440, such as code “1060” to indicate that the cart is tilted. Other codes indicate the payload or items 29 exceeds the cart payload capacity, the payload is not properly balanced, the payload extends too far out from the side of the cart, etc. The individual icon images 171i shown in the individual keys 171 and their accompanying text messages or codes can and do change depending on various events and changes in operation. For example, as discussed below, once you have pressed the Save Map key 171d to save the map 260′ to the RCP memory 103, the background of the function keys 171a, 171c, 171h and 171d change from gray to green, and the text of the Save Map key 171d changes from “Active Mode” to “Fixed Mode.” (FIGS. 30A and 30C).

The Looping mode key 171c enables or disables a looping function or mode of the RCP 440 and cart 445. When the looping key 171c is pressed and the background of the looping key 171c turns gray (e.g., is not illuminate), the looping mode is disabled. When looping key 171c is pressed and the background turns green (e.g., is illuminated to appear green), the looping mode is enabled. When the looping mode programming is enabled, the destination keys 171a that are set (e.g., 171a-1, 171a-2, 171a-3, etc.) are illuminated to appear blue. Keys 171a that are not set remain grey. Then, when the user presses or selects a set (blue) destination key 171a (e.g., key 171a-2), the autonomous cart 445 uses its stored mapped location coordinates (e.g., 264-2) for that destination (e.g., 172-2) along with its current map location 263 and its environmental map 260′ to determine or plan a route 149 to navigate and travel to that set and selected destination (e.g., 172-2) as it would normally. During the time the cart 445 is determining its route 149 to a selected destination 172 (e.g., 172-2, 264-2), the cart does not move, and the selected destination key 171a (e.g., 171a-2) displays a rotating circular gif to let the user know it is determining its route. Once the route 149 is determined, the cart 445 will begin to navigate and move along its selected route 149, and the background for that destination key 171a (e.g., 171a-2) blink or flash blue. After reaching that destination 172 (e.g., 172-2, 264-2), the cart 445 waits for a predetermined or specified amount of time while determining its route 149 to the coordinates (e.g., 264-3) for the next sequential destination (e.g., 172-3), and the destination key (171a-3) for that next destination displays the rotating circle gif. The cart 445 uses its current location 100, 263 at or near (e.g., within about one meter of) its current destination (e.g., 172-2, 264-2), its environmental map 260′ and its stored mapped location coordinates 265 (e.g., 264-3) for that next sequential destination (e.g., 172-3) to plan its route 149, and navigate and travel to the next sequential destination (e.g., 172-3). While the cart 445 is traveling to the next destination 172 (e.g., 172-4) the background of the next sequential destination key (e.g., 171a-4) blinks blue. The cart 445 will skip destinations that are not set (e.g., not illuminated blue), and after the last set numerical destination is reached, the cart will go back to the first numerical destination (i.e., location “1” or 172-1). The cart 445 will continue to navigate and travel to each next set destination (e.g., in a set sequence of destinations e.g., 172-1, 172-2, . . . 172-5, 172-6, . . . 172-11), wait the predetermined amount of time, and then proceed to the next sequential set destination in a looping manner until the user either presses any key 171 or moves the cart (e.g., more than one meter while it is waiting at a set destination 172). This Looping mode feature allows the cart 445 to move autonomously from set destination-to-set destination all day long like a city bus would do.

The Save Map key 171d saves the data for the environmental map 260′ (i.e., environmental mapping data) to the RCP memory 103. When the autonomous cart 445 is initially brought to a facility or environment 260 (FIGS. 13 and 36) and is turned on via switch 175, the cart is in its “Active” mode. When the activated cart 445 initially starts off under its own power (e.g., via battery 120 and drive wheel 493, 494), its LIDAR sensor 140 and cameras 550 constantly scan the environment 260 and send environmental map data to its processor 102, 106 to create a map 260′ (FIGS. 14 and 37) of that environment, which is saved in its short-term memory 107. The user then pushes the activated cart 445 throughout the allowed area 260 to specific desired destinations 172, and sets the specific coordinates for those designated locations 264 in the cart memory 103, 107 via destination keys 171a (FIGS. 15A and 30A). Once these steps are done, the cart 45, 445 will use its map 260′ and set destinations 264 to navigate and travel in the allowed area 260 and return to a designated original starting location (e.g., key location “1” or 172-1). The user then presses the Save Map key 171d to save the scanned map 260′ of the allowed area 260 to its long-term memory 103. Once the map 260′ is saved, it is stored in the long-term RCP memory 103 of the RCP 440 so that when the cart 445 is powered off and then back on, the map will still be present in the RCP memory. If the map 260′ is not saved via the Save Map key 171d before the cart 445 is powered off (deactivated) via switch 175, then when the cart is powered back on (activated), the map 260′ will have been discarded.

The Home key 171h is used to localize or orient the cart 445 relative to its map 260′ of the actual environment 260. Localization enables the cart 445 to determine its location (i.e., current location data) 263 in its internal map of the surrounding environment 260′, and thus the ability to recognize its physical location 100 in the actual surrounding environment 260. Once the map 260′ has been saved to the RCP long-term memory 103, the cart 445 can occasionally become mis-localized or disoriented so that the RCP 440 cannot determine or recognize its current location 100, 263. For example, while the cart 445 is powered off with the map 260′ being previously saved, the user can move the cart. Then, when the cart 445 is powered back on (activated), the RCP 440 may not be able localize or orient itself (determine current location 100, 263 of cart 445) on its previously saved map 260′, notwithstanding encoders 498 and 499, IMU 545 and backup power circuit 130. Should this occur, the user positions the cart 445 in a designated “Home” position 172h, 264h (FIGS. 33, 36 and 37), and presses the Home key 171h, which informs the cart 445 that its current location 100 is now at or near its designated Home location 172h, 264h. The RCP 440 then determines the location or X, Y coordinates for the cart 445 at its current location 100, 263 (including rotational orientation) in the environment 260 on its previously saved map 260′. The designated home location 172h, 264h is marked by a marker 1c in the subsurface 1b of the floor 1. The subsurface marker 1c can be a metal stake placed into the floor 1 at the home location 172h, 264h, or a unique rebarring pattern, a buried pipe or some other subsurface 1b anomaly detected by the cart sensors 140, 550 or 640. While only one home position 172h is shown and described, it should be understood that several distinct home positions are possible, provided an additional home key 171h is provided for each additional home position, or provided the map profile 260′ is sufficiently different at each home position 172h, 264h to allow the cart 445 to recognize (differentiate between) the different home positions throughout the work area 260.

As noted above, the RCP 440 uses its weight sensors 80 to determine when an object is placed on or taken off the cart 445. The RCP 440 uses these weight measurements to plan the movements of the cart 445, such as traveling in a looped manner between selected destinations 172. For example, a first worker often places items onto a cart 445 at a first location 172-1, and then sends the cart to a second location 172-2 for the items to be removed by a second worker. The second worker will then return the cart 445 back to where it came from (i.e., the first location 172-1). However, the second worker may not know where the first or starting location 172-1 is located. And, even if the second worker knows where the first or starting location 172 is located, the second worker would have to make an active choice to where to return the cart. The robotic cart platform 440 uses its navigation and movement system 442 and its weight sensors 80 to allow the autonomous cart 445 to function in a boomerang mode to resolve this problem.

The boomerang mode programming operates with or without destination keys 171a set to desired destinations 172. Table 1 below describes an example of the boomerang mode in which boomerang method 580 uses destination keys 171a (e.g., 171a-1, 171a-2, 171a-3, etc.) bound or programed to first, second, third and job activity locations 172 (e.g., 172-1, 172-2, 172-3, etc.). Table 2 below describes an alternate example of the boomerang method 590 where the control panel 570 does not have destination keys 171a, or the destination keys 171a are not programmed to set destinations (e.g., 172-1, 172-2, 172-3, etc.) or are not used to perform the method.

Boomerang method 580 uses two or more set destination keys 171a. (FIG. 30A). The boomerang mode programming for processors 102, 106 is enabled 583 by pressing or touching a boomerang mode key 171bg on the control panel 570. (FIG. 30B). When enabled, the cart 445 starts to record the weight of the item or items 29 placed on or taken off the cart 445 at designated destinations. A first worker adds 584 an item or items 29 to the cart 445 at the start or first job activity location 172 (e.g., 172-1, 264-1) within a first designated area 172-A1. The worker can push or otherwise move the cart to a more convenient location 172-1a, 264-1a within the first designated area 172-A1 for placing the selected item on the cart. (FIGS. 36 and 37). The cart 445 weighs the selected item(s) 29 and stores the corresponding item weight data in its memory 103, 107. The worker then presses 585 a second desired destination key 171a (e.g., 171a-2) to send 586 the cart to a second job activity location 172 (e.g., 172-2, 264-2) within a second designated area 172-A2. The worker can push or otherwise move the cart to a more convenient location 172-2a, 264-2a within the second designated area 172-A2 to facilitate removing the selected item from the cart. At the second job activity location 172 (e.g., 172-2 or 172-A2), a second worker removes 587 item(s) 29 from the cart 445. When the item(s) 29 is removed, the cart 445 will sense the removal of the item(s) by the weight of the cart payload via its weight sensors 80 and processor 102, and determine if the removed item weight data corresponds to the added item weight data. After confirming the added and removed weight data correspond (e.g., are substantially equal) and waiting a set amount of time (e.g. 30 seconds) the cart will automatically determine and navigate 588 along a return path 149b to the previous designated location where the payload weight was increased (e.g., 172-1 or 172-1a). When the cart 445 is in boomerang mode, the worker can also press 589 the looping key 171c to enable the looping mode programming, so that the cart will continue to go back-and-forth in a looped manner between the original boomerang location 172-1bg and set destination 172-2.

TABLE 1
Boomerang Mode - Method Using Set Destination(s) 580

| | |
|---|---|
| 581 | Provide an autonomous cart 445 with a navigation and movement system |
| | 442 having motorized drive wheels 93, 94 or 493, 494, cart processor 102, |
| | 106 and cart memory 103, 107 weight sensors 80, at least two destination |
| | keys 171a and a boomerang mode key 171bg. |
| 581a | Place cart 445 at a location 100 in a working environment 260 and |
| | activate the cart. |
| 581b | Load mapped environment data 260′ in cart memory 103, and localize cart |
| | 445 to its current location 100 in environment 260 via its corresponding |
| | map location 263 in mapped environment. |
| 581c | Set at least two destination keys 171a (e.g., 171a-1 and 171a-2) at first and |
| | second designated destinations 172 (e.g., cart staging location in storage |
| | area172-1, 264-1, and cart staging location in packaging area 172-2, 264- |
| | 2) in mapped environment 260′, and have cart 445 store map destinations |
| | 264-1 and 264-2 in memory 103. |
| 582 | Moving said cart into the first designated area 172-A1 (storage area), and |
| | selecting a selected item from the various items in first designated area. |
| 583 | Press boomerang key 171bg to activate boomerang mode programming. |
| 584 | Cart remains at location where boomerang key 171bg is pressed in storage |
| | area 172-A1 (e.g., storage area), or is moved by user to more convenient |
| | location 172-1a (e.g., other location within storage area). |
| 584a | Place item 29 on cart 445 (e.g., item from storage area), and cart obtains |
| | added item weight data for added item from the weight sensors 80 and |
| | stores item weight data in memory 103 or 107. |
| 584b | RCP 440 sends a programmed signal to audio speaker 190 to play audio |
| | cue to inform the user (e.g., “payload added” or “Eight pounds added”). |
| 585 | Press destination key 171a-2 for second designated destination 172-2. |
| 586 | Have cart 445 use navigation and movement system 442 to determine a |
| | route 149 and navigate and travel along route with item 29 through |
| | environment 260, 260′ from first location 172-1, 172-1a to second |
| | designated destination 172-2, 264-2. |
| 586a | Cart remains at second designated location (e.g., cart staging location 172- |
| | 2 for packaging area), or is moved by user to more convenient location |
| | 172-2a (e.g., other location within packaging area). |
| 587 | Remove selected item 29 from cart 445 at second location 172-2, 172-2a, |
| | and have cart obtain removed item weight data for removed item from the |
| | weight sensors 80, and have cart compare removed item weight data to |
| | determine if substantially equal to added item weight data. |
| 587a | Have cart wait at second location 172-2, 172-2a for predetermined time |
| | period or for selected item to be placed back on cart, or having user press |
| | a key 171bg or having user press down on cart. |
| 587b | RCP 440 sends a programmed signal to audio speaker 190 to play an |
| | audio cue to inform the user (e.g., “payload removed” or “Eight pounds |
| | removed”). |
| 588 | Have cart 445 use navigation and movement system 442 to determine a |
| | return route 149b and navigate and travel along return route from second |
| | location 172-2, 172-2a to first designated location 172-1 (e.g., from where |
| | it came - cart staging location for storage area 172-A1). |
| 589 | Provide autonomous cart 445 with a looping key 171c, and while |
| | boomerang mode programming is enabled, press looping key to enable |
| | looping mode programming to instruct cart to continuously repeat steps |
| | 584-588. |

The alternate boomerang method 590 does not require or use set destination keys 171a bound to set destinations 172 (e.g., 172-1, 172-2, 172-3, etc.). Two examples demonstrate the usefulness of boomerang method 590. The first example is generally depicted in FIG. 36. The cart 445 is brought to a storage location for the cart in a storage area 172-A1 of the warehouse 260. The cart 445 is activated via switch 175 and the boomerang mode programming is enabled by pressing the boomerang key 171bg. An item(s) 29 is then removed from a storage area, and added to the cart, which uses its weight sensors 80 and processor 102 to determine the weight of the item and that the item was added at this storage location, which becomes the first boomerang location (e.g., 172-1bg) saved in the cart memory 103, 107. The cart 445 is then pushed to a packing location or area 172-A2, where the item(s) 29 is removed from the cart, which uses its weight sensors 80 and processor 102 to determine the weight of the removed item at this packaging location, which becomes the second boomerang location (e.g., 172-2bg). Then, the RCP 440 automatically sends the cart 445 for obtaining another item(s) 29 from storage 172-A1, 172-1bg. In the second example, the cart is pushed to and items 29 (e.g., tools and test fixtures) are taken from several storage areas (e.g., 172-1bg and 172-2bg) and placed on the cart 445. The cart 445 is then pushed to a subsequent location where a certain job using the tools and test fixtures is performed (e.g., 172-3bg). Once the job has been completed, the tools and fixtures need to be returned to their proper storage locations (e.g., 172-1bg and 172-2bg). In both of these examples, the worker at the second or later location may not know where to send the cart 445 for more items or where to return the items. When boomerang mode programming is enabled via boomerang key 171bg, the RCP 440 automatically sends the cart 445 for more items from storage, or returns the tools to their storage locations.

Table 2 below describes the alternate boomerang method 590 in which the cart 445 does not have or does not use set destinations 172 (e.g., 172-1, 172-2, 172-3, etc.) stored in its memory 103. Again, the boomerang mode programming for processers 102, 106 is enabled by pressing or touching 593 the boomerang mode key 171bg on the control panel 570. When the boomerang mode 590 is enabled, the cart 445 records the locations 172 to which it goes while the boomerang mode is enabled, and also records the weight of the item(s) 29 added to (i.e., placed on) or taken off the cart 445 at these locations 172 (e.g., first and second boomerang locations). An item 29 is added 594 to the payload of the cart 445 at the start or first boomerang location 172-1bg, and the cart senses the addition of the item in the weight of the cart payload 29 via its weight sensors 80, and stores the second boomerang location (e.g., 264-2bg) and the item weight data corresponding to the second boomerang location. The cart 445 is then pushed 595 to a second boomerang location where the item is removed 596 from the cart. After a set amount of time (e.g. 30 seconds), the cart 445 will automatically return 597 to the first boomerang location (e.g., 172-1bg) where the payload weight was last increased or decreased. When the cart 445 is in boomerang mode, the worker can also press 599a the looping key 171c to enable the looping mode programming, so that the cart will continue to go back-and-forth in a looped manner between the original boomerang location and subsequent locations (e.g., 172-1bg, then 172-2bg, then 172-1bg, then 172-2bg, etc.).

TABLE 2
Boomerang Mode - Method Without Set Destinations 590

| | |
|---|---|
| 591 | Provide an autonomous cart 445 with a navigation and movement system |
| | 442 having motorized drive wheels 93, 94 or 493, 494, cart processor |
| | 102, 106 and memory 103, 107, weight sensors 80 and a boomerang |
| | mode key 171bg. |
| 591a | Place cart 445 at a location 100 in a working environment 260 and |
| | activate cart. |
| 591b | Load a mapped environment 260′ in cart memory 103, and localize cart |
| | 445 to its current location 100 in environment 260 via its corresponding |
| | map location 263 in mapped environment 260′. |
| 592 | Moving said cart into the first designated area 172-A1, and selecting a |
| | selected item from the various items in the first designated area |
| 593 | Press boomerang mode key 171bg to activate boomerang mode. |
| 594 | Add or place the selected item 29 on cart 445 when cart is at a first |
| | activity or boomerang location 172-1bg in environment 260 |
| | corresponding to boomerang location 264-1bg in mapped environment |
| | 260′ |
| 594a | Have cart obtain item weight data from weight sensors 80 after the item |
| | is placed on cart, and have cart store boomerang location 264-1bg and |
| | item weight data corresponding to boomerang location 264-1bg in |
| | memory 103. |
| 594b | RCP 440 sends a programmed signal to audio speaker 190 to play an |
| | audio cue to inform the user (e.g., “payload added” or “Eight pounds |
| | added”). |
| 595 | Push cart 45, 445 to a second activity location 172-2bg in working |
| | environment 260 corresponding to map destination 264-2bg in mapped |
| | environment 260′. |
| 596 | Remove item from cart 445 at second activity location 172-2bg, have cart |
| | obtain removed item weight data for removed item from the weight |
| | sensors 80 after the item are removed from cart, have cart store |
| | boomerang location 264-2bg and item weight data corresponding to the |
| | boomerang location 264-2bg in memory 103, 107. |
| 596a | Have cart use navigation and movement system 442 to instruct cart to |
| | return (from where it came) to boomerang location 172-1bg, 264-1bg |
| 596b | Have cart to wait at second activity location 172-2bg, 264-2bg for |
| | predetermined time period, or for removed item to be placed back on |
| | cart, or having user press a key 171bg, or have user press down on cart. |
| 596c | RCP 440 send a signal to audio speaker 190 to play an audio cue to |
| | inform the user (e.g., “payload removed” or “Eight pounds removed”). |
| 597 | Have cart 445 use navigation and movement system 442 to determine a |
| | route 149 through environment 260, 260′ from second activity location |
| | 172-2bg, 264-2bg to original boomerang location 172-1bg, 264-1bg, and |
| | navigate and travel along that route 149 to original boomerang location. |
| 598 | Place item 29 on cart 445 when cart is at boomerang location 172-1bg, |
| | 264-1bg, have cart obtain item weight data from the weight sensors 80 |
| | after the item is placed on cart, and have cart store item weight data |
| | corresponding to boomerang location 264-1bg in memory 103. |
| 599 | Have cart 445 use navigation and movement system 442 to determine a |
| | route 149 through environment 260, 260′ from boomerang location 172- |
| | 1bg, 264-1bg to second activity location 172-2bg, 264-2bg, and |
| | navigated and travel along that route 149 with item 29 to the second |
| | activity location. |
| 599a | Provide autonomous cart 445 with a looping key 171c, and while |
| | boomerang mode programming is enabled, press looping key to enable |
| | looping mode programming to instruct cart to continuously repeat steps |
| | 594-599. |

While not shown in a table, it should be understood that the boomerang mode programming can include first second and subsequent boomerang locations (e.g., 172-1, 172-2, 172-3, etc., or 172-1bg, 172-2bg, 172-3bg, etc.). At the subsequent or job activity location 172 (e.g., 172-3, 172-4, etc., or 172-3bg, 172-4bg, etc.) when another item(s) 29 is added to or removed from the cart 445, the cart senses the addition or removal of the item(s) in the weight of the cart payload 29 via its weight sensors 80, stores each subsequent location (e.g., 264-1bg, 264-2bg, 264-3bg, etc.) and the item weight data corresponding to each subsequent location. After the cart reaches a final destination location while in boomerang mode, and after waiting a set amount of time (e.g. 30 seconds), the cart 445 will automatically return in reverse order to the subsequent locations, second location and start location (e.g., 172-3bg, then 172-2bg, then 172-1bg) where the payload weight was last increased or decreased. Again, when the cart 445 is in boomerang mode, the worker can press the looping key 171c to enable the looping mode programming, so that the cart will continue to go back-and-forth in a looped manner between the original boomerang location and subsequent locations (e.g., 172-1bg, then 172-2bg, then 172-3bg, then 172-2bg, then 172-1bg, then 172-2bg, etc.).

FIGS. 31 and 32 show an alternate cabling 610 version of the RCP 440 and autonomous cart 445. In the first embodiment, the battery 120, proximity sensors 150, LED lights 160 are directly wired to the ports 110 of the RCP housing 51. In this alternate version, the cabling 610 includes additional external circuitry 109a that includes wiring 497a for the external wheel motors 493, 494 and encoders 498, 499, and the cabling 610 includes four external single board computers (SBCs) 611 and two external universal serial bus (USB) hubs 615. The cabling 610 for each of the four lines 201-204 of proximity sensors 150 and their associated LED lights 160 has an external SBC 611, such as one SBC for each of the four cart posts 25. (FIG. 32). Each SBC 611 (including its associated SBC processor 612 and SBC memory 613) helps control the LED lights 160 and manage or streamline the input signals from the proximity sensors 150 to the main SBC 101 inside the RCP housing 451. Each external SBC 611 converts the communication protocols of the sensors 150 and lights 160 to a USB protocol for its respective line 201, 202, 203 or 204 (e.g., cart post 25).

The external SBCs 611 and USB hubs 615 allow for easier cabling 610 installation, reduce costs by replacing more expensive custom-made cables with USB cabling, and buffers data to reduce the real time processing burden on the internal SBC 101 and digital board 105. The external SBCs 611 and USB hubs 615 also improve manufacturability because the cabling 610 in each line or post 25 is assembled and tested as a sub-assembly, with the final assembly of the cart 445 being performed later. Since the cart posts 25 are the same for the larger sized and smaller sized carts 445, the cabling 610 for each post is manufactured independently of cart size. The external SBCs 611 and USB hubs 615 also improve reliability because should the components in one line or post 25 (i.e., sensors 150, lights 160, SBC 611, or USB cabling 610) fail for any reason, that failure will not cause the components in the other lines or posts to fail. The external SBCs 611 and USB hubs 615 also provide enhanced flexibility in that sensors 150 and lights 160 in one line or cart post 25 are readily changed to other items (e.g., radar sensors 640) without needing to make other changes in the cart 445 provided the software or programming of the RCP 440 is capable of supporting the change.

FIGS. 33-35 show a radar sensor 640 version of the RCP 440 and autonomous cart 445. In this radar sensing version, the proximity sensors 150 are replaced by an array 630 of radar input devices 640. The array 630 of radar input devices 640 is located on the cart 445 and oriented in directions to maximize the total field of view (FOV) 631 around the cart so that the largest amount of the environment 260 is sensed by the array. While the cart 445 is shown in FIGS. 25-28 with both the proximity sensors 150 and radar input devices 640, the radar version need not include proximity sensors. The environmental mapping data from the radar sensors 640 combines with the environmental mapping data from the LIDAR sensor 140 and cameras 550 in the RCP processors 102 and 104 to produce an enhanced three hundred and sixty degree (360°) map 260′ of the surrounding environment 260. (See FIGS. 10, 29, 33 and 36-37). Similar to the LIDAR sensor 140 and cameras 550, the environmental mapping data of the radar sensor 640 includes both global or working environmental data 260′ and local environment data 260a′.

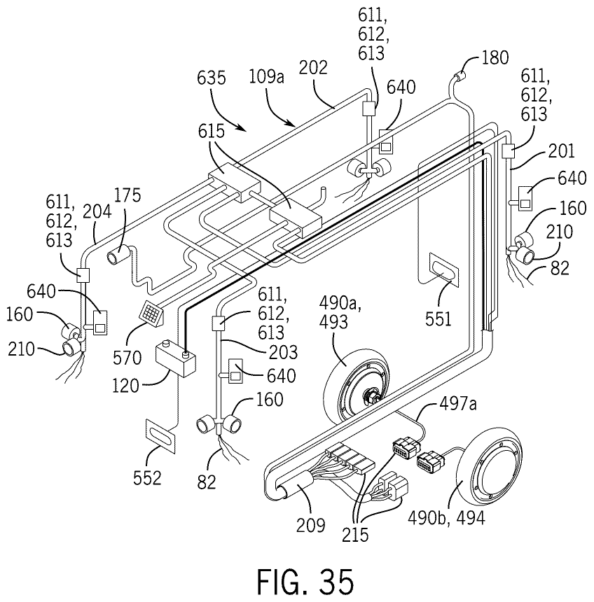

The radar version of the RCP 440 and autonomous cart 445 preferably has several conventional radar sensors or radar input devices 651-656. Each radar sensor or device 651-656 is mounted to point in a specific aimed direction 658 so that its scanning cone 659 faces that specific desired direction as shown in FIG. 33. While FIGS. 25-28 show the radar sensors 651-654 located on the front, rear and opposed sides of the cart, FIG. 35 shows a cable routing 635 with these sensors located in the cart posts 25. Depending on the particular work environment 260, either radar array 630 mounting configuration is possible to provide an optimum total scanning cone FOV 631 for the cart 445.

Each radar sensor 640 transmits radio waves at certain frequencies to penetrate, reflect and refract through and off of material objects (e.g., walls, floor surfaces, curtains, payload items, etc.) and back to that radar sensor. Each device 640 senses the global environment 260 (via working environment data) surrounding the cart 445 including various materials and humans in proximity 260a (local environment data) to the cart. In the present version, each radar input device 640 has a preferred vertical and horizontal FOV of one hundred and twenty degrees (120°). While the present version includes multiple radar sensors 640, each having a FOV facing a particular direction, it should be understood that the broad aspect of the invention would include a single radar input device having a wider FOV such as 360°.

Each radar input device 640 has a preferred radar frequency of 60-64 gigahertz (GHz), to allow the radar to penetrate or see through various materials commonly found in manufacturing, office, restaurant, or other workplace settings, such as plastic, cloth fabric, plaster, drywall wood, metal, concrete, brick, wiring conduit, liquids such as water, humans, etc. Each radar device 640 has a resolution of 3.75 centimeters, and a range of 20 centimeters to a maximum distance of 100 to 400 meters. The radar devices 640 sense or pick up moving items 262a, 262m natively so that sensing and determining the speed of a walking or running person 262p or a fast or slow moving forklift is highly detectable. While the LIDAR sensor 140 and cameras 550 gather and send data to the processors 102 and 106 for calculating the velocity of moving people and objects 262a, because the radar sensors 640 send velocity or moving object data regarding moving objects 262m (e.g., walking person, other moving carts 445, etc.) to the processors natively, the processors require less processing time to detect moving objects 262m and moving people 262p and the navigation and control system 442 and cart 445 are able to detect and respond to moving objects and people more quickly.

Each radar sensor 640 is mounted to a specific location on the cart 445 and is oriented to sense a desired FOV direction and region (e.g., volume) of the sensing environment 260. Each device 640 gathers a stream of radar input data from the environment 260 in its FOV region. The RCP computing device (e.g., programmed processors 102, 106) processes the stream of radar input data from the devices 640 to characterize voxels (i.e., cubic portions of space) by material type, material thickness, distance from the radar input device, stationary or moving relative to the radar input device, and angle of movement when the material is moving in relation to the cart 445. From this characterized data or radar sensor data (e.g., working environment data, local environment data, moving object data) further calculations are done by the computing device 102, 106 to create a three-dimensional map 260′ of the surrounding environment 260. (FIGS. 36 and 37). Some of the voxels in the map 260′ are open and do not contain any objects or materials, and other voxels are occupied with objects or materials.

The radar sensors 651-654 directed towards the ground 1 sense changes in elevation and the material composition of the surface 1a and ground or subsurface 1b beneath the cart 445. The RCP 440 uses the surface 1a composition beneath the cart 445 to aid in traction control for the cart 445. One or more downwardly directed radar sensors 651-654 determine the flooring 1 material type and possibly if its surface 1a has a coating (e.g., epoxy, oil, water, etc.). The RCP 440 uses flooring type and coating data to slightly adjusts how the cart 445 accelerates or decelerates. The radar sensor data also includes the composition of the ground surface 1a (ground surface data) and subsurface 1b (subsurface data) to provide landmarks and distinctive characteristics 1c (e.g., metal bolts driven into concrete flooring, embedded pipes, embedded metal rebaring grid patters, etc.) to obtain current location data by which the cart 445 localizes and navigates, and aid in the orientation and localization of the cart 445 with respect to the environment 260. (See FIG. 33).

When the cart 445 is pushed or autonomously driven over the ground or floor surface 1a, the environmental mapping data from the radar sensors 640 (and preferably the LIDAR sensor 140 and cameras 550) is used by the programmed processors 102, 106 to create an internal map 260′ of the surrounding environment 260. The environmental map 260′ includes working environment data from radar sensors 651-654 regarding the composition of the surface 1a, subsurface materials 1b and subsurface items, patterns or anomalies 1c. (see FIGS. 33 and 36). Thus, rebaring, conduit, pipes, tunnels, and other subsurface items, patterns or anomalies 1c′ are identified on the map 260′ and the cart uses them to obtain current location data. (FIG. 37). Liquids, paper and other types of debris 262d on floor surfaces 1a are also detected by the radar input devices 651-654 to allow for traction control or avoidance.

Moving autonomously requires the RCP 440 and cart 445 to be localized 100, 263 to navigate the environment 260, 260′. Both localization 100, 263 and navigation are aided by sensing fixed structures 262 or obstacles 262a in the environment 260 from which the RCP 440 will triangulate the real-time physical and mapped location 100, 263 (current location data) of the cart 445. This is easily achieved when the cart 445 is in open areas 261 near (in sensor range) 261a of fixed obstacles 262 that its line-of sight or visual sensors 140, 150 or 550 can detect. When the cart 445 is in open areas 261 void of (out of visual sensor range) 261b fixed obstacles 262, the RCP 440 uses the downwardly aimed radar sensors 651-654 to sense ground surface 1a and subsurface 1b composition (e.g., surface and subsurface data), including any subsurface patterns, structural anomalies or markers (e.g., rebaring, pipes, metal markers, etc.) 1c. The varying nature of the ground surface 1a (including grooves, surface markers, undulation patterns in or on the surface), subsurface 1b composition and subsurface patterns or structural anomalies 1c are recorded in the RCP long term memory 103 to provide a map 260′ from which the RCP 440 of the cart 445 will obtain current location data to localize 100, 263 and then navigate to a desired destinations 172, 264.

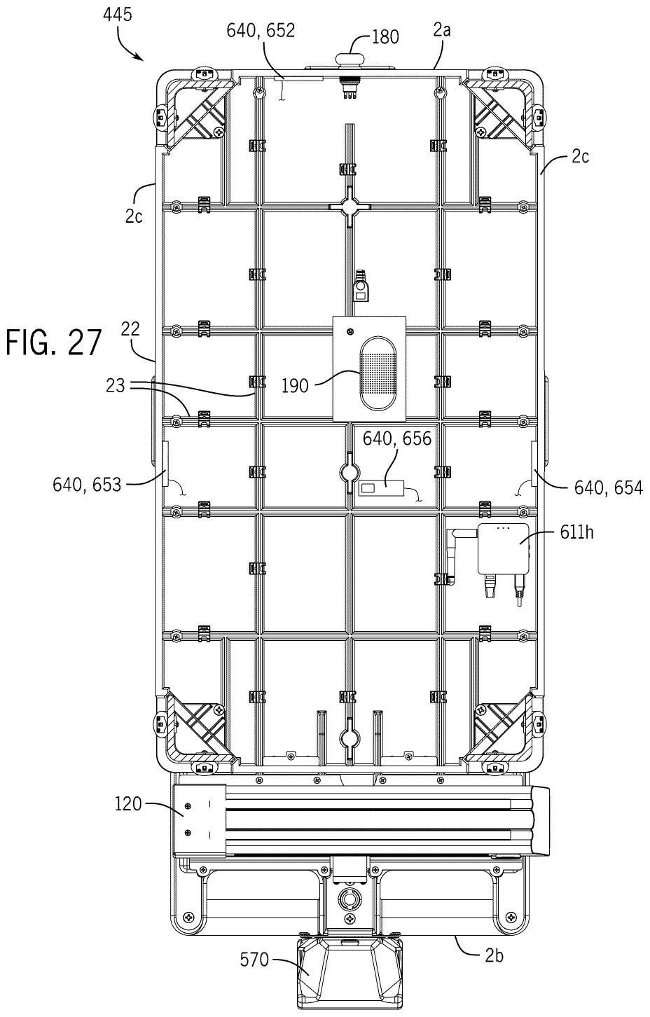

In addition to sensing the surrounding environment 260 of the cart 445, two radar sensors 655 and 656 are orientated towards the shelving or trays 21, 22 that support the payload items 29, as well as towards the payload areas or regions 21a and 22a above the trays where the payload items are placed. (FIGS. 27, 28 and 33). These radar devices 655 and 656 scan the shelving and payload areas, and send material type and dimension information (i.e., radar sensor item data) to the RCP 440 so it can determine the type of material and thickness of the payload items 29. This material and thickness information is used by the RCP 440 processor 102 to calculate the mass, weight and center of gravity of the payload 29 along with the position of the payload items on the shelving 21, 22 of the cart 445. The RCP 440 uses the center of gravity and payload 29 position information to better determine its navigation movements to avoid unwanted shifting of the payload 29 or tipping of the cart 445. The RCP 440 also records this radar voxel information in its long or short term memory 103, 107 or communicates this information via other systems (e.g., SBC 101. SRCP 250, etc.) or to the user via its control panel keys 171, audio speakers 190. wifi 195, etc.). The RCP 440 also uses the radar voxel information from these radar input devices 655 and 656 to perform calculations that count the number of payload objects 29 as they are placed onto or removed from the cart 445.

The radar sensors 655 and 656 located under the upper and lower trays 21 or 22 sense the entire payload 29, and when any portion of the payload extends beyond the lip or perimeter 7 of the tray. By viewing the payload 29, the RCP 440 determines if the payload extends beyond the perimeter 7 of the tray 21 or 22, and if the payload will collide with stationary or moving obstacles 262, 262a, 262m, 262p (e.g., walls, shelving, furniture, doorways, other carts, people, etc) as the cart 445 autonomously moves. The radar input devices 651-654 are aimed outward and upward from the outer edges or perimeter 7 of the tray or supporting platform 22, so that they sense the areas of the payload 29 extending outwardly and upwardly from the tray. When moving autonomously, the RCP 440 considers not only the dimensions of the cart 445, but also the portions of the payload 29 hanging outwardly from or extending upwardly from the cart to ensure neither collide with any obstacles 262, 262a, 262m, 262p.

The RCP 440 detects dynamic obstacles 262a, 262m, 262p (e.g., moving forklifts, moving people, other moving carts, etc.), and calculates their distance, direction, velocity, and acceleration (distance, direction, velocity and acceleration data). The radar devices 640 of the RCP 440 are capable of gathering Doppler radar information or moving object data to calculate these measurements. The RCP processor 102, 106 calculates the intersection of dynamic obstacles 262a, 262m, 262p in relation to the navigation path 149 of the cart 445. When the RCP 440 uses the radar moving object data to calculate that a projected intersection or collision will occur along its navigation path 149, the RCP 440 takes measures to avoid that collision, such as by altering the navigation path 149a of the cart 445, altering the speed of the cart, stopping the cart for a predetermined time, or applying a cart braking force by energizing the hub wheel motors 491, 492 to hold the drive wheel 493, 494 stationary.

The radar devices 640 sense materials and objects behind other materials and objects. This allows the RCP 440 to sense both static 262 and dynamic 262a, 262m, 262p obstacles that are otherwise optically hidden from the cart 445 (i.e., not sensed by its line-of-sight sensors). For example, when the cart 445 travels by or around a corner 262c or through or past a doorway 262dw, as shown in FIG. 36, the fixed obscuring structures 262 (e.g., wall(s) forming corner 262c or doorway 262dw, or other shelving, furniture, etc.) optically or visually obscure or otherwise obstruct the view of the cart for adjacent open areas 261 on the other side of the fixed structure by its line-of-sight sensors (e.g., LIDAR sensor 140, proximity sensors 150, depth cameras 550, etc.). These fixed structures (e.g., walls), significantly reduces the time and distance for the cart 445 to sense and avoid collisions with moving objects or people 262m, 262p. Yet, the radar devices 640 sense through the optical obstructions 262, 262a (e.g., walls forming corners or straddling doorways, people by corners or in doorways, etc.) to gather moving object data that includes obscured adjacent moving object data to allow additional time and distance for the cart 445 to avoid collisions with moving objects 262m, 262p by altering the navigation path 149a or speed of the cart.

The radar sensors 640 also allow the cart 445 to go through or over certain obstacles along the navigation path 149 of the cart. For example, the radar sensors 640 can detect a thin flexible lightweight material, such as thin one-eighth inch (⅛″) transparent plastic strips 262ps hanging in a doorway 262dw (FIG. 36). These thin flexible lightweight materials are used for ventilation, dust or noise control, or to divide two areas of a room for privacy control, but are not intended to prevent a person or cart from passing through them. The user can program or set the RCP processor 102 and memory 103 to allow the navigation and movement system 442 to plan a route 149 passing through the thin flexible materials (e.g., strips 262ps hanging in a doorway 262dw, curtain or sheet of plastic or cloth fabric, etc.) and allow the cart 445 to travel through them. This requires the programming of the RCP processor 102, 106 or the user to selectively set the VOX resolution of at least one radar sensor 640 to less than about 3.75 cm. The user can also program or set the RCP processor 102 and memory 103 to allow the cart 445 to drive over a liquid or debris 262d on a floor surface 1a, such as a spilled water or paper. By determining the material composition and thickness of various obstacles 262, 262a, 262d, 262ps, the RCP 440 can determine (e.g., calculate via radar sensor data and preselected memory settings) when the user wants the cart 445 to avoid a certain type of obstacle 262, 262a, (e.g., wall, moving person or other moving cart, etc.) go through a certain type of obstacle 262ps (e.g., plastic hanging strips, cloth curtain, etc.), or go over a certain type of obstacle 262d laying on the floor surface 1a (e.g., debris, paper, liquid, etc.). From its internal map 260′ of the environment 260 stored in the RCP 440 memory 103, the processor 102, 106 of the RCP 440 calculate or otherwise determines a planned route 149 for the cart 445 and navigates this route, and when necessary an alter route 149a, via its sensors 140, 150, 550, 640 to avoid fixed and temporary obstructions 262, 262a and reach a desired destination 172.

The RCP 440 classifies human and human body part 262p (via human body part data for faces, hands, fingers, etc.) as being different from non-human objects (via non-human body part data for objects such as walls, furniture, shelving, etc). The positioning and motion of human body parts are then interpreted as direct input (human body part positioning and motion data) to the cart 445 from a human. The RCP 440 can also be programmed to identify and respond to the shape or movement of certain non-human objects (non-human object shape and movement data). The RCP 440 is programmed or set to use human body input data (e.g., hand input data, finger input data, etc.) to control the cart 445 or to input a series of data to the cart. For example, the RCP 440 is programmable to direct the cart 445 to identify and move or otherwise respond to a person waving his or her hand, holding up a hand to stop the cart from moving, or entering a number by a person holding up a finger or fingers.

Another aspect of the RCP 440 is that one or more radar device 651 is placed in the handle 12 of the cart 445 and orientated towards the natural hand positions by a user when gripping the handle to detect when a person has gripped the handle. When the RCP 440 of an autonomously moving cart 445 determines a person 262p is gripping its handle 12, the RCP aborts any autonomous motion such as movement of the cart along a navigation path 149. Furthermore, the RCP 440 uses the radar devices 651 to detect the placement of the hand, fingers and thumb on the handle 12 to allow for additional data input. For example, when a human hand grips the handle 12, the placement of the thumb near the handle is interpreted to control the speed and direction of a drive wheel 93, 94. Extending the thumb forward, towards the front 2a of the cart 445, instructs the cart 445 to move forward by having drive wheels 93, 94,493, 494 rotate in a forward or clockwise rotation. Extending the thumb rearward away from cart (toward human) instructs the cart 445 to move backward by reversing the rotation (counterclockwise) of the drive wheels. The RCP 440 is programmed to determine how far away the thumb is from a center point (i.e., axis of grip area of handle), and interprets a greater distance from this center point as an instruction to increase the speed of the drive wheels 93, 94, 493, 494.

The RCP 440 also allows a user to control the cart 445 via human data input without direct contact by the human with the cart, which reduces the opportunity for electrostatic discharge (ESD) events to occur. When the cart 445 travels, electrical charge will build up on the cart. When the level of this charge becomes sufficiently high, an ESD can occur. When an ESD occurs, it can result in disruption of the electrical operation of the RCP 440 and cart 445, which can result in permanent damage to the cart, and provide an unwanted shock to the human.

Radar input devices 640 are installed behind or inside of cart 445 components, such as its shelving 21, 22, riser posts 25, or handles 12. The frequency, power output and receiver strength of the radar input device 640 are selected based on the cart component material residing between the environment 260 and the radar input device. For example, many components of conventional carts 20 are made of high-density polyethylene (HDPE) plastic, and 60 GHz radar passes through HDPE plastic with minimal signal loss and minimal degradation in signal quality. The radar input devices 640 are installed behind or inside these HDPE components without affecting the sensing abilities of the radar input devices. Furthermore, secondary installation operations to the conventional cart 20 (e.g., cutting or modifying the cart) are not needed, which maintains the intended aesthetics of the cart.

When a radar input device 640 is mounted to the cart 445 near any material that covers the radar input device, the distance between the device and material is important. The ideal distance is one half of the wavelength of the operating frequency for the radar device 640. For example, for a 60 GHz radar input device 640, the wavelength is approximately 5 millimeters. Thus, one half of this wavelength is 2.5 millimeters. The radar input device 640 are located 2.5 millimeters away from the covering material of the cart 445. The shape of the covering material is also selected to minimize the reflection and refraction of the radar signal. When performing calculations utilizing the radar input device 640 data, these characteristics are considered.

### Autonomous Advertising Cart

When autonomous carts travel through open areas 261 of a warehouse, plant, office, building, store, conference center or other work environment 260, their task is transporting products, tools, documents or other types of payloads 29. (FIGS. 13 and 36). While doing so, they offer the ability to communicate with people 262p, animals and other equipment and machines or software operating in the working environment, such as warehouse management system (WMS) software or enterprise resource planning (ERP) software. Thus, autonomous carts can provide additional value beyond that of transporting payloads 29.

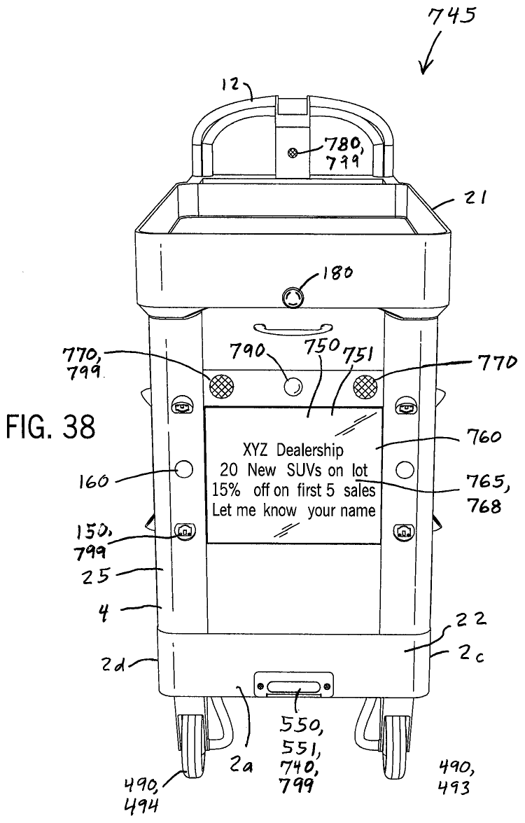

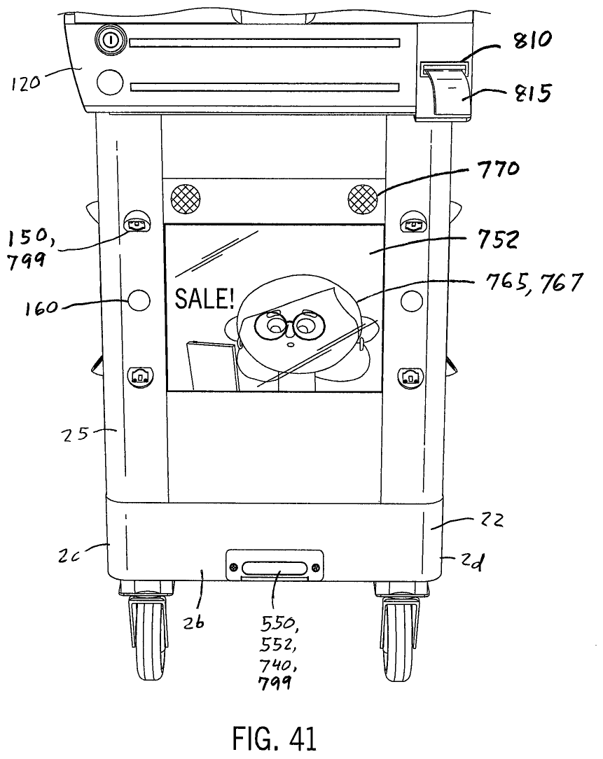

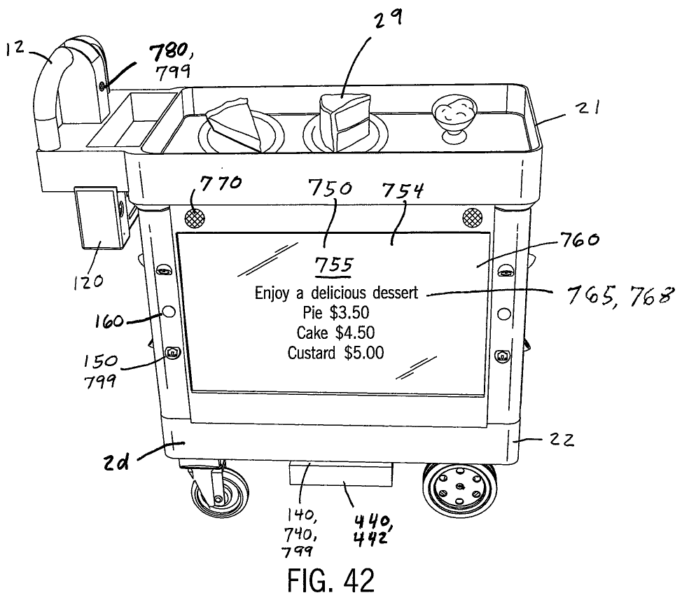

An autonomous advertising cart 745 is shown in FIGS. 38-42. The autonomous advertising cart 745 has the RCP 440 and its navigation and movement system 442 along with one or more conventional electronic display panels 750 to communicate with people 262p, animals and other equipment and machines. Similar to autonomous carts 45 and 445, the advertising cart 745 includes weight sensor assemblies 70 for all wheels, front drive wheel assemblies 490 with motors 491, 492 and drive wheels 493, 494, circuit boards 101, 104, 105 with processors 102, 107, memory 103, 107 circuitry 109 and ports 110 for electrically connecting external components, battery 120, backup power circuit 130, array of proximity sensors 150 or radar sensors 640, LED lights 160 control panel 170, 570 with six or fifteen keys 171, an ON/OFF switch 175, emergency stop button 180, audio speakers 190, WiFi communication device 195, cable array 200, 600, 610, IMU 545 and one or more environmental mapping devices 740, such as one or both of LIDAR scanner 140 and depth cameras 550, so that the cart 745 can generate and store a map 260′ of the working environment 260 and navigate through that environment while avoiding fixed and temporary obstacles 262, 262a.

The advertising cart 745 has four panels 750. One panel 751, 752, 753 or 754 is preferably mounted on each side 2a-d of the cart 745. Each panel 750 has a front or outer surface 755, as well as a rear or inner surface. Each panel 750 also has top, bottom and side ends 756, 757 and a conventional electronic screen 760 that forms at least a portion of its front surface 755. Each panel 751-754 is located between the upper and lower trays 21, 22. The panel sides 757 are preferably secured to two cart risers 25, respectively. The panel top end 756a is below the upper tray 21, and the panel bottom end 756b is above the lower tray 22. The panel sides 757 are even with or within the corners 4 of the cart 745. The panels 750 are secured to the cart via screws, clips or other suitable types of fasteners that are preferably located at or near the panel ends 756, 757. Each panel 750 is substantially vertically oriented, or perpendicular to the upper and lower trays 21, 22. The panels 750 and their screens 760 form the outer margins of the autonomous cart 745 so that a person 262p in the “line-of-sight” of the cart 745 can see or view the images 765 displayed on the outer surface of the screen or screens 760 facing that person. Although one panel 750 is shown mounted to each cart side 2a-d, it should be understood that multiple panels can be mounted to each side, or some cart sides can have no panel.

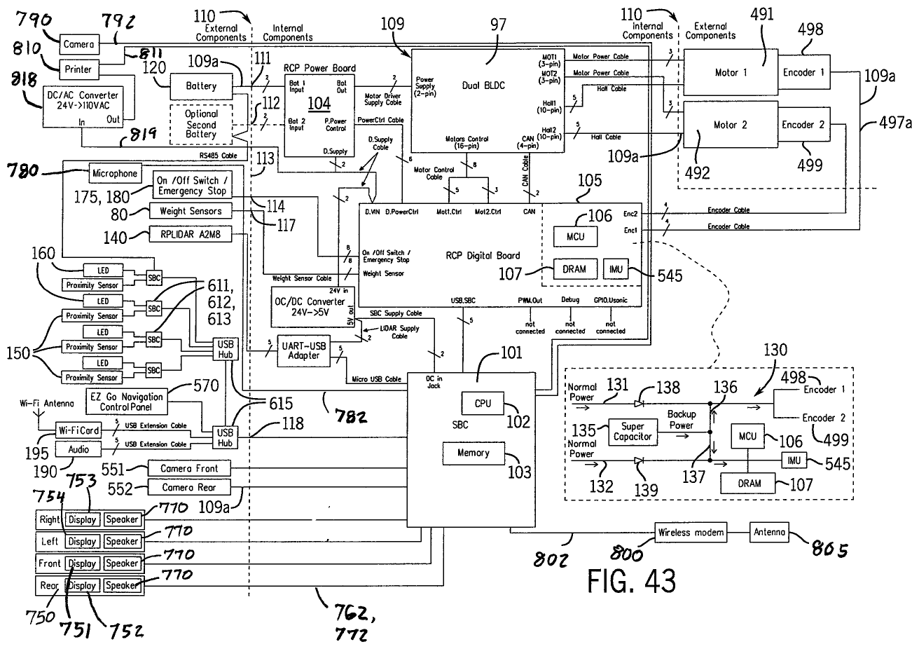

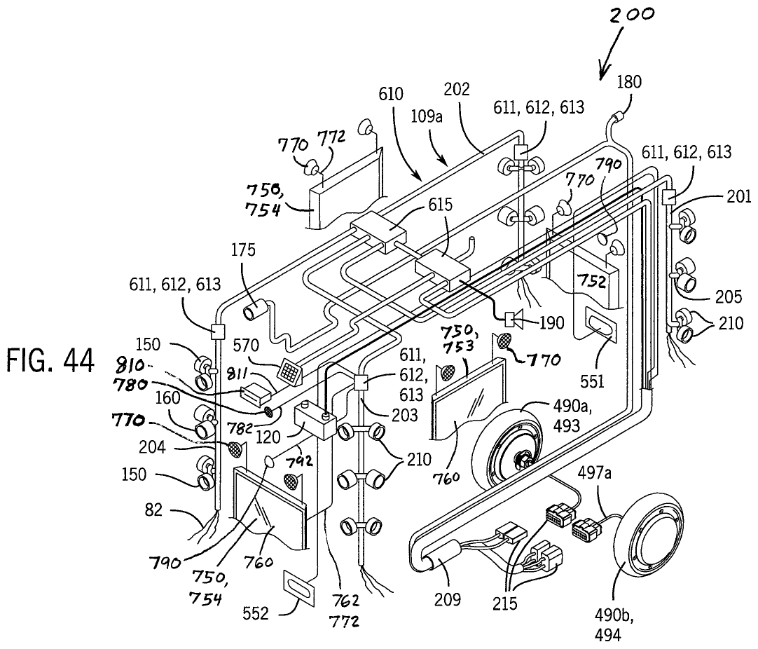

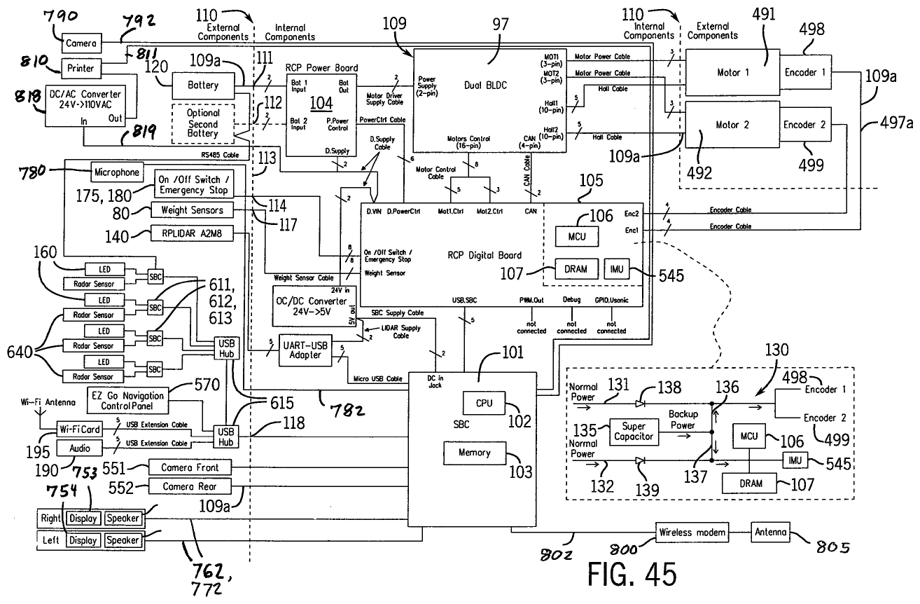

As shown in FIGS. 43 and 44, the screen 760 of each panel 750 is wired 762 to and in electrical communication with the RCP 442 and its processors 101, 102 and 105, 106. The video communications 765 are stored in the long-term or RAM memory 103, 107 of the RCP system 42, 742, which is programed to selectively send one of the visual communications 765 as a data signal to one or more of the display panels 751-754. Each panel 750 then use the visual data signal to generate or otherwise visually display the visual communication 765 on its screen 760. Each visual image 765 includes one or more pictures 766, one or more videos 767 and/or one or more text messages 768, or a combination of them.

The viewing area of the screens 760 is as large as possible, vertically oriented and positioned at a height of about one to two and a half feet above the floor to allow the picture 766, video 767 and/or text 768 of the visual advertising communication 765 to be clearly viewable (e.g., discernably observable) from a significant distance by the consumers 262p, preferably five to thirty feet for most teenagers and adults walking around in the building. That is, people with average vision will be able to identify the displayed images (e.g., face of a baby drinking from a baby bottle, face of woman holding a cell phone, product carried by cart, manufacturer logo, as well as read text included in the image, etc.). For the advertising cart 745 shown (39×17×33 inches), the viewable area of the screens 760 for the side panels 753, 754 is about 2 to 4 square feet. The viewable area of the screens 760 for the front and rear panels 751, 752 is about 1 to 2 square feet. The screens 760 are preferably conventional light emitting diode (LED) or liquid crystal display (LCD) screen, such as for a conventional television, but other more expensive screens are suitable when inadvertent damage, vandalism and theft are not a concern, such as Edge-lit LED, Direct-lit LED, plasma, QLED or OLED screens.

Display panels 750 preferably require efficient battery power consumption when in use, such as low power LED panels or similar displays that do not consume significant power. Conventional displays 750 are commonly powered by line voltage (i.e. 120V). Thus, to use common displays, a DC to AC invertor (similar to inverter 818, discussed below) is required since the cart 475 runs off of a battery 120 producing DC voltage. The internal computers 101, 102 and 105, 106 electrically communicate with the displays 750 and speakers 770 via output ports 110. (FIG. 43). The output ports 110 are preferably High Definition Multimedia Interface (HDMI) output ports. These HDMI ports 110 are joined to HDMI cabling 200, 762 to enable electric communication with the displays 750 and speakers 760. (FIG. 44). It should be understood that projectors and translucent display screens (not shown) can be used in place of the electronic display panels 750. The projectors in the cart 745 project the advertising images 765 onto the translucent screens held on one or more sides of the cart.

Each conventional electronic display panels 750 includes one or more speakers 770, or additional speakers 770 are added to provide audio communications 775 in conjunction with the visual communications 765. The audio communications 775 are stored in the memory 103, 107 of the RCP system 42, 742, which is programed to selectively send one of the audio communications 775 as an audio signal to the speakers 770. The speakers 770 then use the audio signal to generate, broadcast or otherwise sound the audio communication 775. The audio communications 775 include human voices, music and/or various other sound recordings, such as a beeping sound similar that of a forklift when backing up. As noted below, the wireless connection 195 allows the RCP system 42, 442 of the advertising cart 745 to receive visual and audio communications 765, 775 sent in real-time by an external source, (e.g., external computer 250, FIGS. 13 and 36) to the display panels 750 and speakers 770. For example, visual and audio communications 765, 775 provide pertinent information about the payload 29 being transported by the cart 745, such as what the payload is, the on-board quantity of each item, the location to where the cart and its payload are heading, the price or prices for each item on the cart, and where the payload items can be found elsewhere in the building 260. Although the displays 750 and speakers 770 are shown as separate components, it should be understood that the displays can include internal speakers to provide a combined audio-visual device 750, 770.

Even when the autonomous advertising cart 745 is not transporting a payload 29, the cart is adapted to provide visual and audio communications 765, 775 to people 262p in the building 260. For example, as the cart 745 is programed to move around in a facility 260 to alert employees about upcoming events, or provide advertising pertaining to a product or service at that store or another third-party store. In this way, the autonomous advertising cart 745 functions as a mobile billboard that navigates through the store 260, and these mobile cart billboard services are offered for sale to the other third-party manufacturers, retailers or service providers. The visual and audio recordings 765, 775 communicated by the displays 750 and speakers 770 are preloaded into the memory 103 or 107 of the cart 745 by either direct connection to the RCP 40, 440 of the cart 745, or via the wireless connection 195.

Microphones 780 and cameras 790 are added to the cart 745 to interact with people 262p near the cart (e.g., employees, customers, conference attendees, audience to a show, play or concert, etc.). One or more microphones 780 and one or more camera 790 receive information contained in audio and visual communications of the people, and the audio and verbal data corresponding to these responsive communications 785, 795 are record in the cart memory 103, 107. It should be understood that the customer observation cameras 790 can aid in mapping, navigation and obstacle avoidance to compliment cameras 550 so that cameras 790 serve a dual purpose. Similarly, the navigation and movement cameras 550 can be used to gather information about the customers 262p near the cart to compliment the customer observation cameras 790.

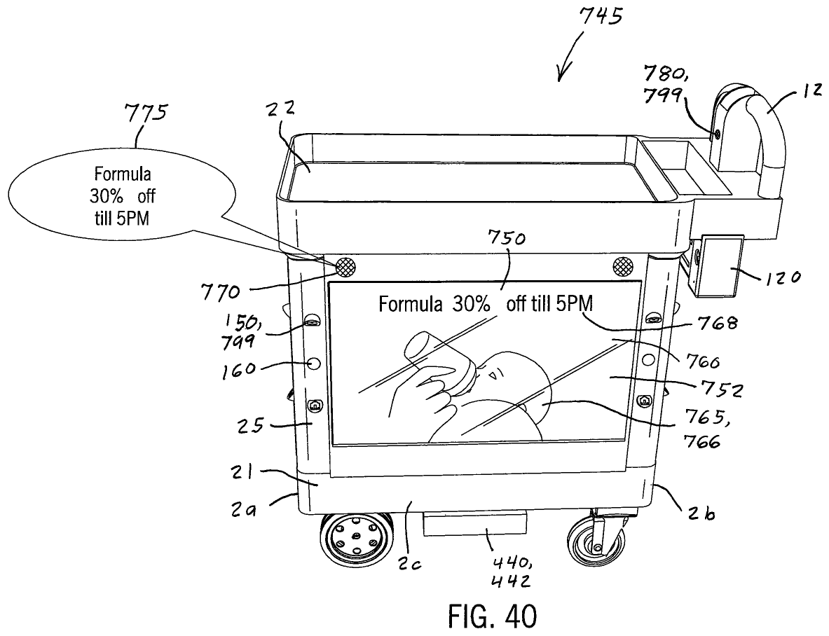

The autonomous advertising cart 745 has additional programmed enhancements. For example, the cart 745 periodically records (i.e., stores in its memory 103, 107) cart statistics data, such as how long the cart has been running, how far it has traveled, how many trips it has taken. Additional statistics data is also recorded to enhance the advertising experience. For example, when each video image 765 or other audio communication 775 is generated (i.e., displayed on screen 760, broadcast by speaker 770), the time, date, location of the cart 745, orientation of the cart, the obstacles 262, 262a, 262m, 262p sensed around the cart, and the weight of the payload 29 currently on the cart is recorded into a database (i.e., stored in memory 103, 107). This database is then made available to advertisers for use in understanding the effectiveness of the conveyed communications 765, 775. The RCP system 42, 442 of the cart 745 is also programmed to generate specific communications 765, 775 at specified times and locations, along with how the cart should be orientated and whether the cart should be stationary or moving. For example, if the cart 745 is in the baby products aisle of a store, the RCP system 42, 442 is programmed to play baby formula communications 765, 775. (FIG. 40).

The RCP system 42, 442 of the cart 745 is programmed to dynamically react to changes in the environment 260 regarding the communications 765, 775 it generates. For example, if the cart 745 is stationary in an aisle 261 of a store 260 and it does not detect any dynamic obstacles 262m after a set time period (i.e., nobody 262p is currently in that aisle), then the RCP system 42, 442 is programmed to enter a low-power consumption state in which the display panels 750 are turned off to conserve the stored electric power in the battery 120. Then, upon detecting a dynamic obstacle nearby 262p (via LIDAR scanner 140, proximity sensors 150 or radar sensors 260), the RCP system 42, 442 is programed to activate the display panels 750 and generates communications 765, 775 toward that dynamic obstacle which just entered the aisle. The RCP system 42, 442 is further programmed to vary its behavior depending upon the time of day and the frequency of dynamic obstacles 262m, 262p being sensed. For example, at peak shopping times when there are many people 262p in the aisles, the RCP system 42, 442 senses the number of dynamic obstacles 262p and takes action. The RCP system 42, 442 is programmed to move the cart 745 out of the way to clear the aisle or will play specific communications 765, 775 intended for these specifics times and conditions.

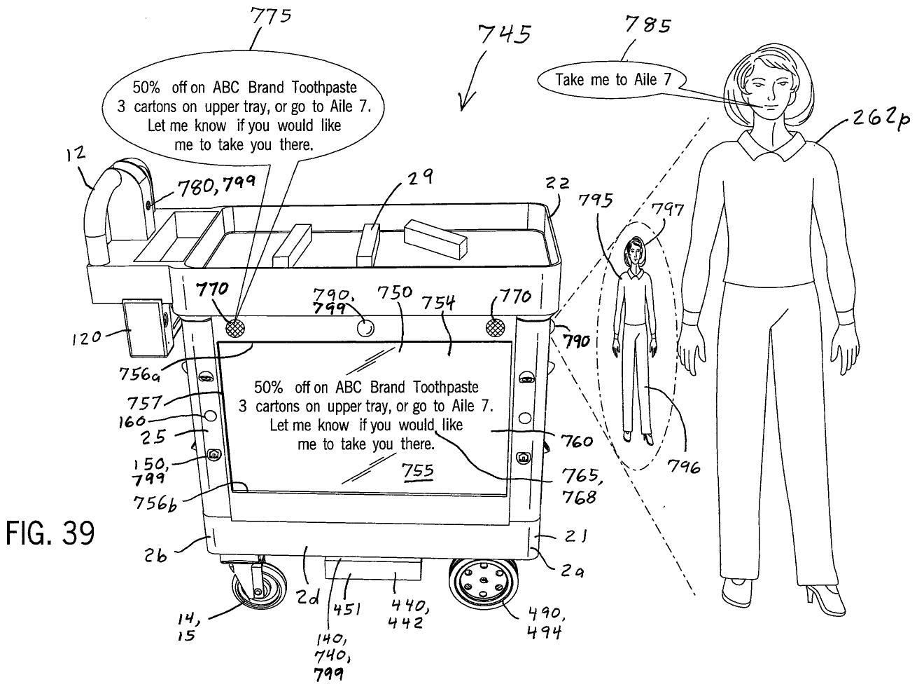

The microphones 780 and cameras 790 allow the cart 745 to observe and record data (i.e., store in memory 103, 107) communicated to the cart by people 262p near the cart and by the surrounding environment 260 near the cart. The cart RCP system 42, 442 is programmed to respond when spoken to by a person 262p near the cart, such as by receiving verbal location data 785 (FIG. 39), or such as by dynamically changing the communications 765, 775 the RPC system generates, or such as how loud or bright to generate the visual advertisement or audio message, or to not generate any advertisements. The microphone 780 also listens to real-time sounds 785 occurring in the surrounding environment so that the cart 745 can take appropriate action, such as moving away from a forklift (not shown) producing a beeping warning when it backs up.

As shown in FIGS. 43 and 44. the microphone 780 and cameras 790 for observing customers or employee 262p are in electrical communication with the single board computer (SBC) 101 inside the RCP 40, 440. The microphone or microphones 780 are wired 782 or otherwise directly connected to the SBC 101 via a conventional 3.5 mm audio cable (782), but can also be connected via a conventional USB cable. The cameras 790 are directly connected to the SBC 101 via conventional USB cabling (792). Although a single microphone 780 is shown located on the cart handle 12, it should be understood that the advertising cart 745 and its cabling 200 can include multiple microphones secured or otherwise located at various locations on the cart or inside the RCP 40, 440. Similarly, although two additional cameras 790 are shown on the front 2a and rear 2b of the cart 745, it should be understood that only one additional camera or more than two cameras can be secured or otherwise located at various locations on the cart.

The RCP system 42, 442 is programmed to analyze obstacles 262a in the map 260′ to determine when people 262p are present near the cart 745. On-board data gathering devices 799 (e.g., LIDAR scanner 140, proximity sensors 150, depth cameras 550, radar sensors 640, microphones 780, customer observation cameras 790, etc.) gather data about the location of dynamic obstacles 262m, such as a person or people 262p, if the person is standing, walking or in a wheelchair are used by the RCP system 42, 442 and recorded to its memory 103, 107. The RCP system 42, 442 is programmed to generate specific communications 755, 765 depending upon the presence of people 262p, how many people, and what is sensed via the on-board data gathering devices 799 (e.g., devices 140, 150, 640, 550, 780, 790, etc.) about those people in relation to other obstacles 262′, 262a′ in its on-board map 260′ of the working environment 260. For example, when a person 262p is standing near the cart 745, the visual image or visual image data 795 of his or her legs 796 will show up as two oval shaped obstacles with a known shape, size and distance between the ovals. Furthermore, the orientation of the legs or ovals (the stance 796 of the visual image or visual data 795 of the person 262p) is detected so that the RCP system 42, 442 can determine how that person is oriented with respect to the cart 745, and thus the display panels 750. One or more of the cameras 550, 790 is preferably an RGB camera that transmits an RGB video stream to the RCP system 442 to improve the accuracy of the RCP system in detecting the presence of a person 262p. The RCP system 442 is programed to analyze the information included or conveyed by the visual images 795 or verbal data 785 it observes to determine when the person 262p is looking at one of the displays 750 and what facial expressions 797 that person is presenting. Demographic data regarding the customer (e.g., age, gender, family status, cultural background and occupation) is also obtained from the RGB video stream about the people 262p. To address privacy concerns, the analysis is done at the RGB camera 550, 780 and only forwarded on to the RCP system 42, 442 of the cart 745 if that information does not violate any privacy of the person. Similarly, this privacy applies to non-humans and other objects that are within range of the RGB cameras 550, 780.

The WiFi and its antenna 195 and the wireless modem 800 provide different functionality. The wireless modem 800 is in wired 802 electrical communication with the RCP system 442 of the cart 745. (FIG. 43). The modem 800 is in wired 802 electrical communication with the RCP system 442 and its processors 101, 102 and 105, 106. The modem 800 has an antenna 805 to allow the RCP system 442 to wireless connect to and communicate with a laptop (not shown) so that an authorized person can selectively update the software, programming and data stored in its memory 103, 107 of the cart 745 and make some configuration changes. Although the modem 800 is shown inside the housing of the SRP 440, it should be noted that the modem can be located outside the housing of the RCP. In this regard, the antenna of both the WiFi 195 and modem 800 are preferably located outside the RCP 40, 400 for better transmission and reception.

As noted above, the WiFi 195 allow the RCP system 442 to communicatingly connect to an external WiFi network (i.e., building WiFi network or a personal computer 250 of an authorized person such as a facility manager, FIGS. 13 and 36). For example, WiFi 195 provides a communication path that allows the RCP system 442 to electronically connect to and communicate with the facility enterprise resource planning (ERP) or warehouse management system (WMS) software. The EPR or WMS software communicates with the RCP system 442 and its on-board computers 101, 102 and 105, 106 and memory 103, 107 to control the cart 745 and obtain information about the work environment 260 and the customers 262p (i.e., customer data, location data, payload data, etc.) The facility owner or manager uses the off-board computer 250 or cell phone to inquire and receive information stored in the memory 103, 107 of the RCP system 442. For example, the ERP or WMS software is programmed to command the cart 745 to move to a certain 172 location in the store, building or warehouse 260, and then display a visual communication 765 on its display 750 (and provide an audio cue 775) for the employee using the cart or customer 262p to pick a desired product (e.g., ABC toothpaste product) from a shelf 262 and place it on the cart tray 22. Once the cart and RCP system 442 receives visual data from one of its cameras 550, 790 indicating that the person 262p placed product on the cart and/or a cart microphone 780 receives voice data from the person (e.g., person states: “Item picked”), and/or the cart weight sensors 70 sense the appropriate weight change for that particular product 29, the cart 745 automatically goes to the packaging area 172-A2 or check out station of the working environment 260, or the ERP software then sends a command to the cart 745 to navigate and move to the checkout or packaging area 172-A2 so that the product 29 can be sold to the customer or packaged up for shipment.

The advertising cart 745 is equipped with a standard printer 810 to print coupons 815 for customers 262p. The RPC system 442 communicates with the printer via a USB connection 811. The battery 120 supplies power to the printer 810 via a USB connection 819, preferably via an external DC to AC inverter 818, as shown in FIG. 43. The inverter 818 is powered by the internal 24V supply wire 819 of the RPC 40 and provides standard 110 VAC power via a normal wall outlet connector (not shown). The printer 810 uses the 110 VAC power, communicates either wirelessly (Wi-Fi) or via a wired USB connection 811. Being that the inverter 818 provides standard wall out 110 VAC, this then allows for many other common devices to be powered. Although a standard printer 810 is shown, it should be understood that a low power printer can be used without the DC to AC inverter 818.

While the invention has been described with reference to preferred embodiments, it will be understood by those skilled in the art that various changes may be made and equivalents may be substituted without departing from the broader aspects of the invention.

We claim:

1. An autonomous advertising cart that displays an advertisement to a person while the cart travels through a working environment with open areas and fixed structures, said autonomous advertising cart comprising:
a cart structure having at least one cart side, a drive wheel, a navigation and movement system including a drive motor to selectively rotate said drive wheel, a programmed processor with a processor memory and circuitry electrically and communicatingly connecting said processor, memory and motor, said processor sending movement instructions to said drive motor sufficient to propel said cart structure along straight and curved paths of travel, and said processor memory is adapted to receive visual advertisement data sufficient to display a visual advertising communication;
an environment mapping device to obtain working environment data sufficient to locate the open areas and fixed structures, said mapping device being mounted on said cart structure and in electrical communication with said circuitry, said processor being adapted to determine current location data when said cart structure is at a current location in the working environment using said working environment data;
a display panel having a screen in electrical communication with said circuitry, said display panel being mounted to said cart side, said processor selectively sending advertisement data to said screen to display a visual advertising communication;
a power source mounted to said cart structure, said power source being in electric power supplying communication with said circuitry, said mapping device and said display panel; and,
wherein said navigation and movement system uses said working environment data and said current location data to plan a route and movement instructions for said cart to autonomously travel through the open areas of the working environment while said processor sends said visual communication data to said display panel to display said visual adverting communication on said screen for viewing by the person in the work environment.

2. The autonomous advertising cart of claim 1 and wherein said cart structure is adapted to carry an item, and said visual advertising communication provides information about the item as said cart autonomously travels through the work environment with the item.

3. The autonomous advertising cart of claim 1, and wherein the working environment has at least first and second areas, said processor memory has at least first and second visual advertising data for first and second visual advertising communication, and said processor selectively sends said first visual advertising data to said display panel to display said first visual advertising communication on said screen when said cart is in said first area, and said processor selectively sends said second visual advertising data to said display panel to display said second visual advertising communication on said screen when said cart is in said second area.

4. The autonomous advertising cart of claim 1, and wherein the working environment has at least first and second areas, said processor memory has at least first and second visual advertising data for first and second visual advertising communication, and said processor selectively said first visual advertising data to said display panel to display said first visual advertising communication on said screen at a first predetermined time, and said processor selectively sends said second visual advertising data to said display panel to display said second visual advertising communication on said screen at a second predetermined time.

5. The autonomous advertising cart of claim 1, and further comprising an advertising speaker, and said memory includes audio advertising data for playing an audio advertising communication, said processor simultaneously sending said audio advertising data to said advertising speaker and said visual advertising data to said display screen, and said speaker playing said audio advertising communication simultaneously with said display screen displaying said visual advertising communication.

6. The autonomous advertising cart of claim 1, and said environmental mapping device is one of either a depth camera and a LIDAR scanner, and said cart structure includes a rotatable and turnable wheel spaced from said drive wheel.

7. The autonomous advertising cart of claim 1, and wherein said visual advertising communication contains one or more of a textual image, a picture image and a video image, said display panel forms an outer margin of the autonomous cart structure, and said screen is viewable when said display panel is facing the person and said cart is in the “line-of-sight” of the person.

8. The autonomous advertising cart of claim 7, and wherein said display panel is mounted to said cart side in a substantially vertical orientation, said screen has a viewable area of at least one square foot, and said visual advertising communication displayed on said screen is discernably observable by the person at least as close to said cart structure as about 2 to 5 feet and at least as far away from said cart structure as about 10 to 30 feet.

9. The autonomous advertising cart of claim 2, and wherein said cart structure has upper and lower trays, four cart sides and four display panels, each of said cart sides having one of said panels, each of said display panels being located below upper tray and above lower tray, and said trays are adapted to carry one or more items.

10. The autonomous advertising cart of claim 1, and further comprising a microphone mounted to said cart structure and in electrical communication with said circuitry, said microphone obtains verbal information data from the person, and said verbal information data from the person is saved in said memory.

11. The autonomous advertising cart of claim 10, and wherein said verbal information data is verbal location data identifying a particular location in the working environment, and said processor is programmed to use said location data to autonomously move said cart to said particular location.

12. The autonomous advertising cart of claim 1, and further comprising a customer observation camera mounted to said cart structure and in electrical communication with said circuitry, and said customer observation camera obtains visual image data from the person, and said visual image data of the person is saved in said memory.

13. The autonomous advertising cart of claim 12, and wherein said visual image data is body position data, and said processor is programmed to use said body position data to autonomously move said cart into a desired position relative the person.

14. The autonomous advertising cart of claim 13, and wherein said body position data includes one of either facial image data and leg image data.

15. The autonomous advertising cart of claim 14, and wherein said facial image data is obtained when the person is facing said visual advertising communication, and said facial image data includes facial expression data.

16. The autonomous advertising cart of claim 1, and wherein said processor records advertisement statistics data in said memory, said advertisement statistic data including date data, time of day data and cart location data obtained by said processor when said visual advertising communication is displayed on said screen.

17. The autonomous advertising cart of claim 1, and wherein said processor is programed to turn off said display panel when said processor does not detect movement after a set time period, and to said processor is programmed to turn on said display panel when said processor detects movement.

18. The autonomous advertising cart of claim 1, and wherein said cart structure includes a wireless modem in electrical communication with said processor, and said processor is programmed to use said modem to wirelessly connect to and communicate with a laptop of an authorized person to allow the authorized person to selectively update said processor programming and data stored in its said memory.

19. The autonomous advertising cart of claim 1, and wherein said cart structure includes a wireless modem in electrical communication with said processor, and the working environment has one of either a building WiFi network and a personal computer of an authorized user, and said processor is programmed to use said modem to wirelessly connect to and communicate with one of either said building WiFi network and said personal computer

20. The autonomous advertising cart of claim 19, and wherein said building WiFi network is one of either facility enterprise resource planning (ERP) software and warehouse management system (WMS) software.

21. The autonomous advertising cart of claim 1, and wherein said cart structure includes a printer in electrical communication with said circuitry, and said processor is programmed to selectively instruct said printer to print a document, such as a coupon, label, information sheet, instructions and receipt.

22. The autonomous advertising cart of claim 1, and wherein said cart structure has one of either a wireless modem and WiFi, and said processor receives said real-time visual advertising data sufficient to display real-time visual advertising communications sent in real-time by an external source, and said processor is programmed to send said real-time visual advertising data to said display panels to display said real-time visual advertising communications on said screen of said display panel.

23. The autonomous advertising cart of claim 1, and wherein electric power from said power source is supplied to said display panels via a DC to AC inverter, said circuitry and said display panel are in electrical communication via HDMI wiring, said circuitry and said microphone are in electrical communication via one of either a conventional 3.5 mm audio cable and a USB cable, and said customer observation camera is an RGB camera that transmits an RGB video stream to said processor.

24. The autonomous utility cart of claim 1, and wherein said cart structure includes on-board data gathering devices to obtain dynamic obstacle location data about dynamic obstacles in the working environment, each of said on-board data gathering devices being in electrical communication with said circuitry, and said processor is programmed to use said dynamic obstacle location data to compile people location-time data corresponding to when people are located near said cart, said people location-time data including high people frequency area-time data and low people frequency area-time data, said processor recording said people location-time data in said memory, and said processor is programmed to use said people location-time data to navigate said autonomous cart through the work environment by one of either navigating into and navigating out of a predetermined area based on said high people frequency area-time data and said low people frequency area-time data.

25. The autonomous utility cart of claim 2, and wherein said cart structure includes a weight sensor and the item has a predetermined item weight, and said processor uses said weight sensor to determine weight change data, said processor using said weight change data to determine one of either when the item is placed on said cart structure and when the item is removed from said cart structure, said processor saving said weight change data to said memory.

26. The autonomous utility cart of claim 25, and wherein said cart structure includes a speaker, and said processor uses said weight change data to have said speaker play a weight change communication when the item is removed from said cart structure, and said autonomous cart navigates and moves to a predetermined location in the working environment when the item is placed on said cart structure.
